(19) United States
(12) Patent Application Publication
(10) Pub. No.: US 2026/0111965 A1
(43) Pub. Date: Apr. 23, 2026

(54) METHOD AND SYSTEM FOR DETERMINING AND MANAGING INVESTOR SHARES IN COLLABORATIVE PROJECTS

(71) Applicant: MOHAMMAD EHSANI, TEHRAN (IR)

(72) Inventor: MOHAMMAD EHSANI, TEHRAN (IR)

(21) Appl. No.: 19/428,157

(22) Filed: Dec. 20, 2025

Related U.S. Application Data
(63) Continuation-in-part of application No. PCT/IB2024/057278, filed on Jul. 27, 2024.

(51) Int. Cl. G06Q 40/06; G06Q 20/40; G06Q 40/04

(52) U.S. Cl. CPC G06Q 40/068; G06Q 20/403; G06Q 40/04

(57) ABSTRACT

In accordance with some embodiments herein, a method is provided. The method includes determining deposit information associated with a plurality of deposits associated with a first project, wherein the deposit information is indicative of deposit amounts of the plurality of deposits, investors associated with the plurality of deposits, and times of the plurality of deposits. The method includes determining expenditure information associated with a plurality of expenditures associated with the first project, wherein the expenditure information is indicative of expenditure amounts of the plurality of expenditures and times of the plurality of expenditures. The method includes determining inflation indexes associated with periods of time within a window of time beginning at a starting time associated with the first project. The method includes determining inflation-corrected shares associated with the investors based upon the deposit information, the expenditure information, and the inflation indexes.

### RELATED APPLICATION

This application claims priority to and is a continuation-in-part of International Application Number PCT/IB2024/057278, filed on Jul. 27, 2024, entitled “CONTRIBUTION PERCENTAGE CALCULATING METHOD IN INVESTMENT WITH THE CAPABILITY OF DYNAMIC ANALYSIS OF INVESTMENT ELEMENTS”, which is incorporated by reference herein in its entirety.

### TECHNICAL FIELD

The present disclosure relates generally to financial management systems, and more particularly to computer-implemented methods and systems for dynamically computing inflation-adjusted and time-sensitive investor shares in a collaborative project fund.

### BACKGROUND

Collaborative investment projects frequently involve multiple investors making deposits at different times and in varying amounts. Conventional financial management systems generally calculate investor shares without considering time-based differences, project expenditures, or inflation effects on deposited funds. These systems often lack real-time recalculation capabilities and do not support automated handling of share transfers, withdrawals, interest allocation, or priority-based rights. As a result, profit distribution and account management may be inaccurate or inequitable. There is therefore a need for improved computer-implemented methods that dynamically determine inflation-corrected shares and manage investor accounts throughout the lifecycle of a shared investment project.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a flow chart of a method for determining and managing investor shares, in accordance with some embodiments.

FIGS. 2A-2C illustrate systems for determining and managing investor shares, in accordance with some embodiments.

FIG. 3 illustrates a data structure indicative of deposit amounts of a plurality of deposits, investors, and times, in accordance with some embodiments.

FIG. 4 illustrates a data structure indicative of expenditure amounts of a plurality of expenditures and times of the plurality of expenditures, in accordance with some embodiments.

FIG. 5 illustrates a data structure indicative of a plurality of inflation indexes, times of the plurality of inflation indexes, prices of the plurality of inflation indexes and a plurality of compound daily growth rates, in accordance with some embodiments.

FIG. 6 illustrates a representation of an inflation matrix, in accordance with some embodiments.

FIG. 7 illustrates a first representation of a first inflation matrix, in accordance with some embodiments.

FIG. 8 illustrates a data structure indicating shares and updated shares of a plurality of elements in a first project at different times in the first project, in accordance with some embodiments.

FIG. 9 illustrates a data structure indicating shares of investors in a plurality of elements at times of a plurality of expenditures in a first project, in accordance with some embodiments.

FIG. 10 illustrates a data structure indicating a plurality of investor shares in a first project based upon having a plurality of respective share in a plurality of elements at a completion time of a first project, in accordance with some embodiments.

FIG. 11 illustrates a data structure indicating a plurality of priority right shares associated with a plurality of elements of a first project at a completion time of a first project, in accordance with some embodiments.

FIG. 12 illustrates a data structure indicating investor shares before and after transferring shares between existing investors or new investors of a first project, in accordance with some embodiments.

FIG. 13 illustrates a representation indicating investments, inflations on investments and profits associated with a first project at a completion time of the first project, in accordance with some embodiments.

FIG. 14 illustrates a representation indicating investments, inflations on investments and profits associated with investors at completion time in a first project, in accordance with some embodiments.

FIG. 15A illustrates a first client device displaying a project selection interface of an investor interface, in accordance with some embodiments.

FIG. 15B illustrates a first client device displaying a project information interface, in accordance with some embodiments.

FIG. 15C illustrates a first client device displaying a profile interface associated with a user, in accordance with some embodiments.

FIG. 15D illustrates a first client device displaying an investment interface at a first time of a first project, in accordance with some embodiments.

FIG. 15E illustrates a first client device displaying an interface associated with fund information details at a first time of a first project, in accordance with some embodiments.

FIG. 16A illustrates a first client device displaying an investment interface at a second time of a first project, in accordance with some embodiments.

FIG. 16B illustrates a first client device displaying an interface associated with fund information details at a second time of a first project, in accordance with some embodiments.

FIG. 16C illustrates a first client device displaying an interface associated with a first element information details at a second time of a first project, in accordance with some embodiments.

FIGS. 17A-17B illustrate a first client device displaying an investment interface at a third time of a first project, in accordance with some embodiments.

FIG. 17C illustrates a first client device displaying an interface associated with a fund information details at a third time of a first project, in accordance with some embodiments.

FIG. 17D illustrates a first client device displaying an interface associated with a second element information details at a third time of a first project, in accordance with some embodiments.

FIGS. 18A-18B illustrate a first client device displaying an investment interface at a fourth time of a first project, in accordance with some embodiments.

FIG. 18C illustrates a first client device 1500 displaying an interface associated with fund information details at a fourth time of a first project, in accordance with some embodiments.

FIG. 18D illustrates a first client device displaying a market submenu, in accordance with some embodiments.

FIG. 18E illustrate a first client device displaying updated values in an investment interface at a fourth time after selling an ownership share from a user to another user in a first project, in accordance with some embodiments.

FIGS. 19A-19B illustrate a first client device displaying an investment interface at a fifth time of a first project, in accordance with some embodiments.

FIG. 19C illustrates a first client device displaying an interface associated with fund information details at a fifth time of a first project, in accordance with some embodiments.

FIG. 19D illustrates a first client device displaying an interface associated with a third element expenditure details at a fifth time of a first project, in accordance with some embodiments.

FIGS. 20A-20B illustrate a first client device displaying an investment interface at a sixth time in a first project, in accordance with some embodiments.

FIG. 21 illustrates an exemplary computer-readable medium comprising processor-executable instructions, wherein the processor executable instructions may be configured to embody one or more of the provisions set forth herein.

FIG. 22 illustrates an exemplary computing environment in which one or more of the provisions set forth herein may be implemented.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative.

Various sectors, including financial services, data analytics, and investment management, are increasingly adopting emerging technologies to enhance accuracy, security, and efficiency in managing and processing investment-related information. Developing secure and efficient systems for control and analysis of investment data can lead to improved performance, reduced operational risk, and greater reliability in investment management.

Collaborative investment projects such as crowdfunding, cooperative construction, or joint venture funding often involve multiple investors contributing funds at different times and in different amounts. Traditional systems for managing such investments typically calculate investor shares based solely on the total contribution amount, without accounting for the timing of deposits, inflation over time, or interest accrued on idle project funds. Such methods can result in inequitable profit distribution, as early investors' capital remains in the project fund longer and is more exposed to inflationary erosion or opportunity cost. Moreover, current financial management systems fail to dynamically update each investor's share in real time as new deposits and expenditures occur. Accordingly, there exists a need for an improved system and method that dynamically determines inflation-corrected shares, priority rights, and bank interest allocations for investors, based on the temporal and economic characteristics of each contribution.

In conventional investment management systems, the calculation and distribution of shared project profits among multiple investors have relied on manual processes or static software tools that lack real-time adaptability and automated fairness adjustments. Existing systems are typically unable to account dynamically for variables such as inflation changes, time-based investment differences, or project progression metrics. Moreover, they do not provide an integrated computational mechanism that continuously recalculates each participant's proportional share as new investors join or existing investors withdraw. These limitations often lead to inaccurate or delayed profit allocations and create transparency and trust issues among stakeholders.

The methods and/or systems provided in the present disclosure overcome these deficiencies by introducing a technically implemented system and algorithmic framework that performs real-time, automated, and auditable profit distribution calculations through specialized data structures, continuous tracking modules, and dynamic weighting mechanisms. This approach represents a specific improvement in the operation of computer-based financial management systems, rather than a mere abstract idea or mathematical formula.

The present disclosure relates to systems and methods for fair calculation of shared project profits and distribution of corresponding returns among multiple investors participating in the shared project. Through precise computational algorithms and automated data processing, the disclosed systems and methods in the present disclosure enable accurate tracking of each investor's contributions, real-time valuation of investment amounts, and equitable adjustment for factors such as inflation, payment timing, bank interest, priority right and project progress. The systems and methods may comprise an ability for investors to enter or exit a project at any stage, while preserving proportional rights and interests of all participants. By providing continuous calculation and record-keeping functionality, the disclosed systems and methods ensure transparent allocation of funds, safeguard investor rights, and maintain overall project integrity.

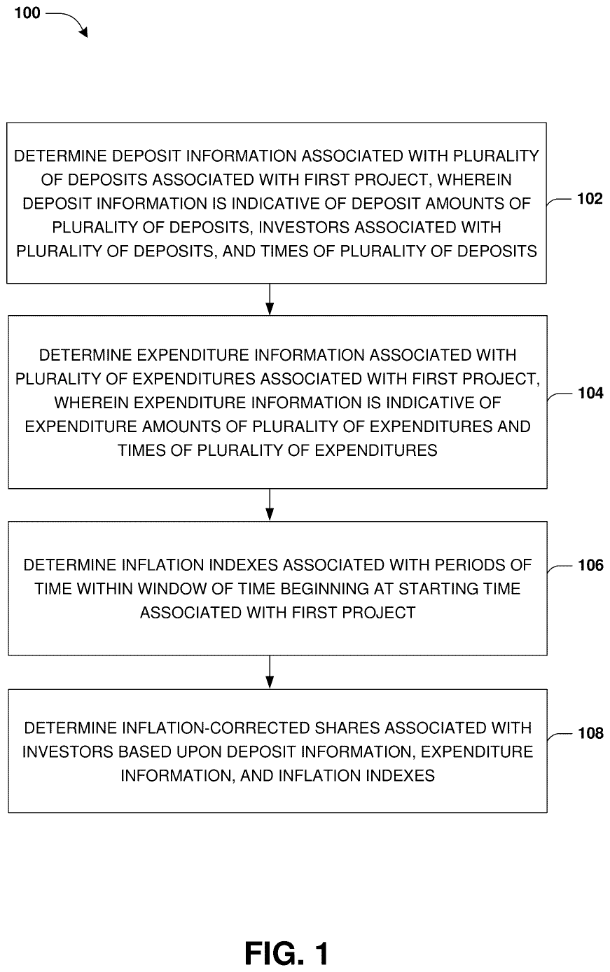

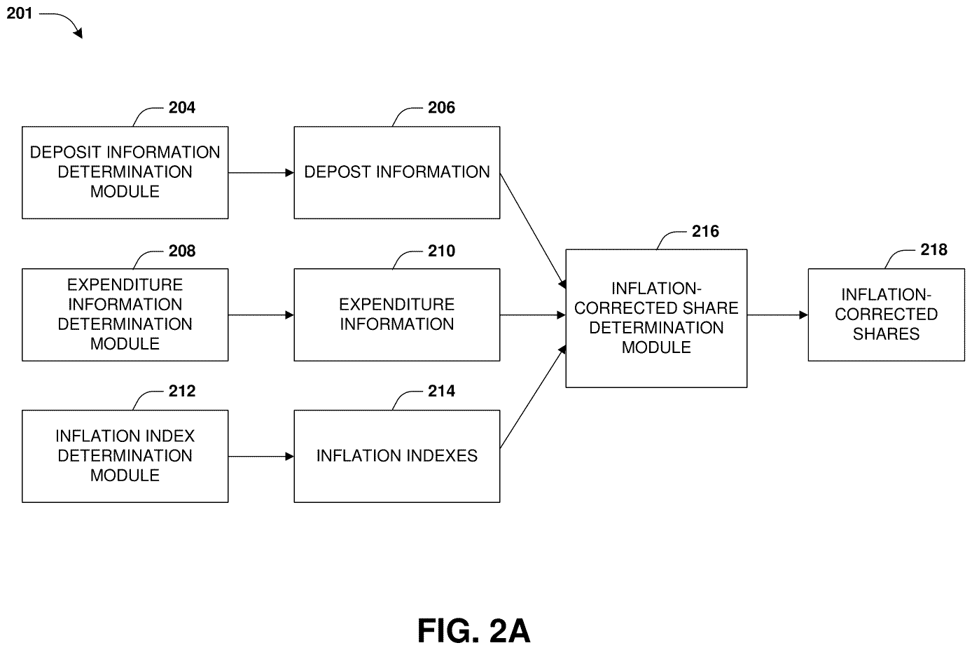

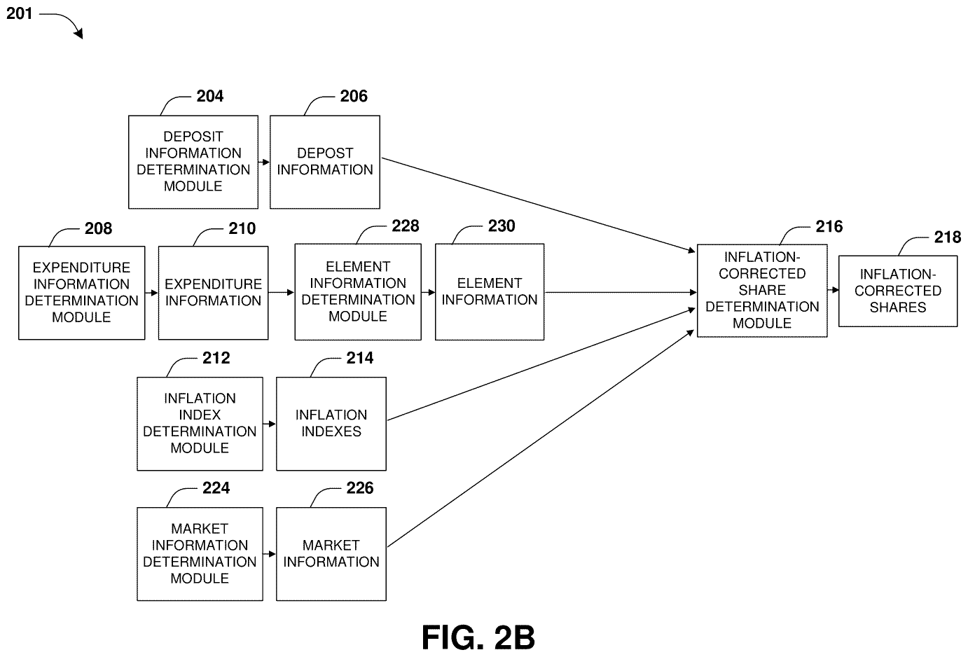

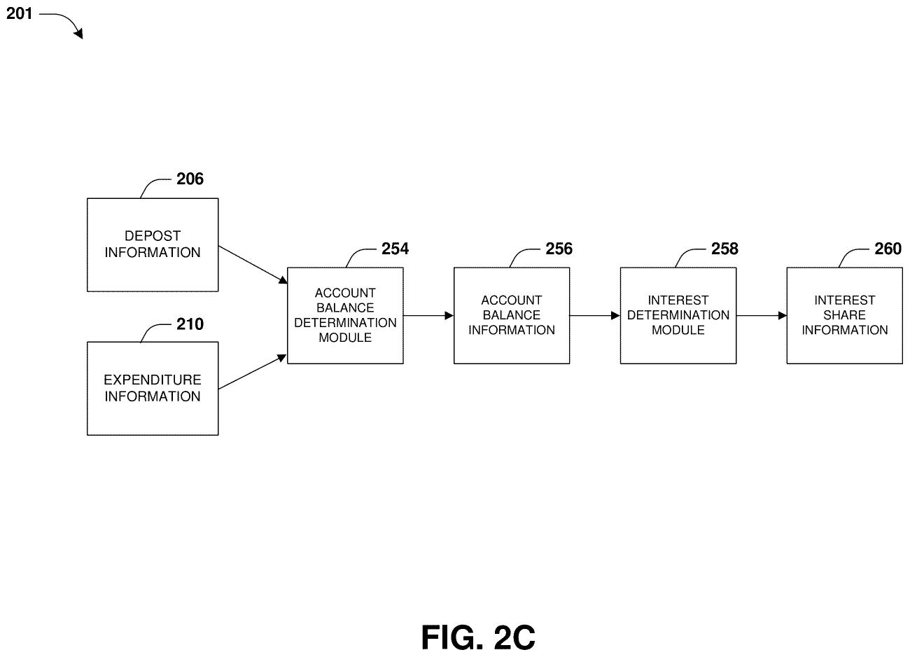

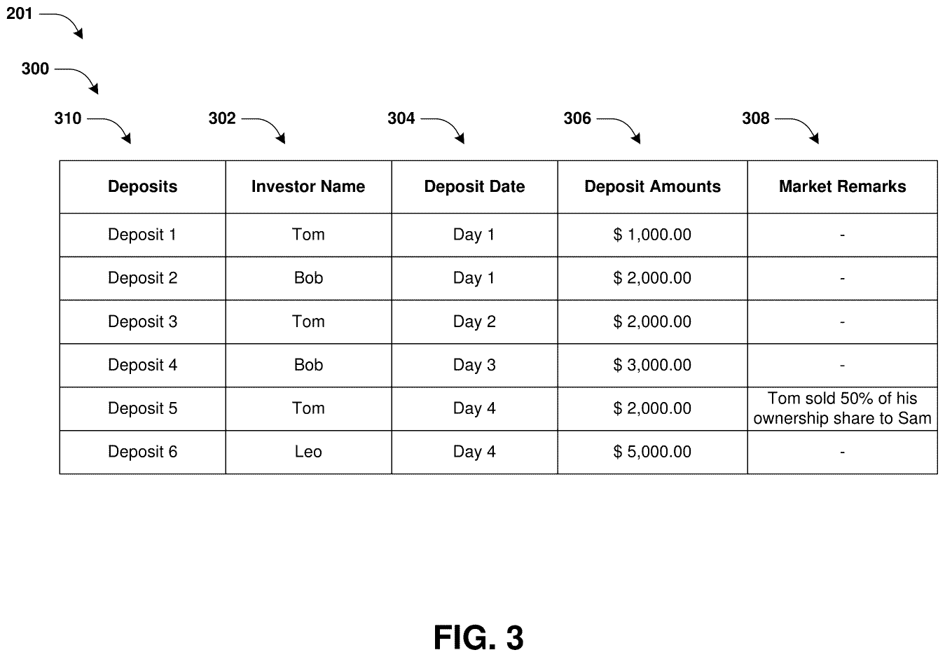

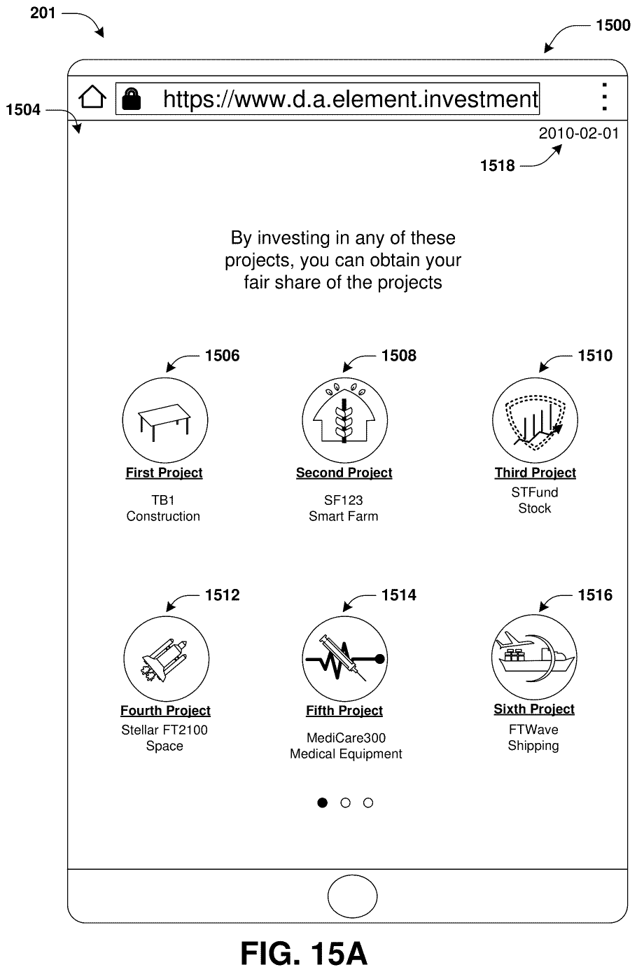

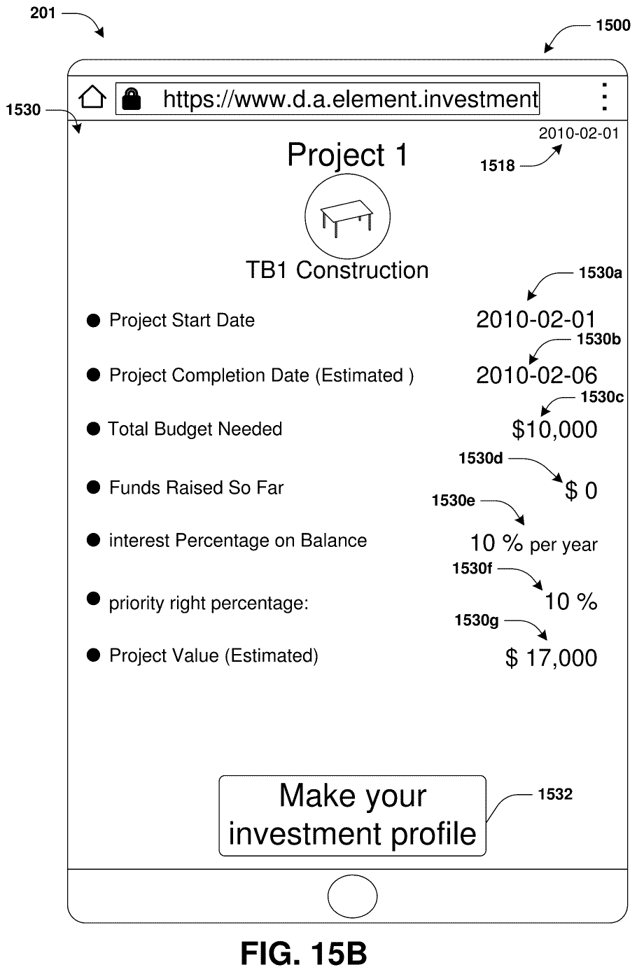

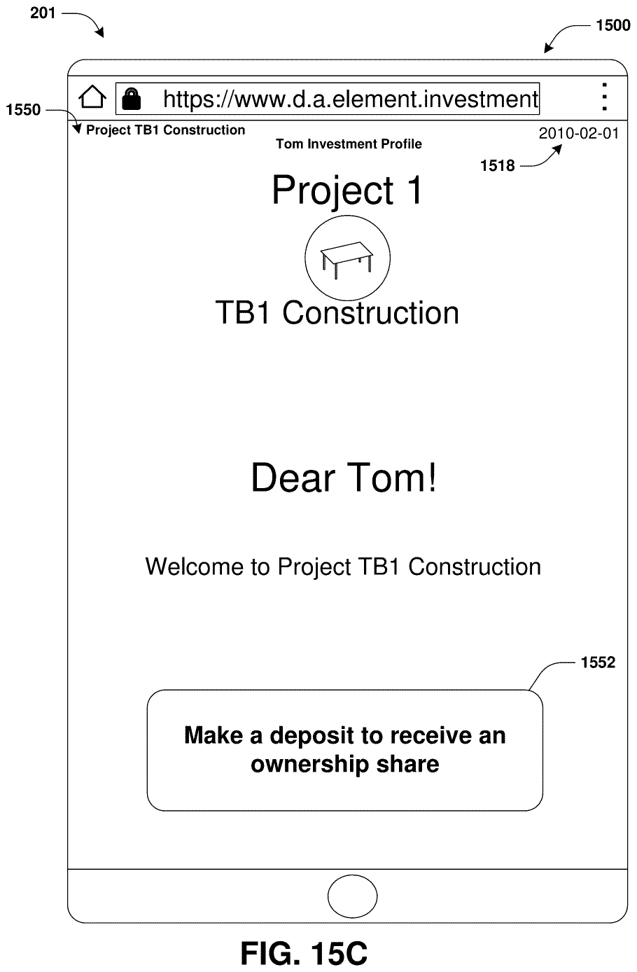

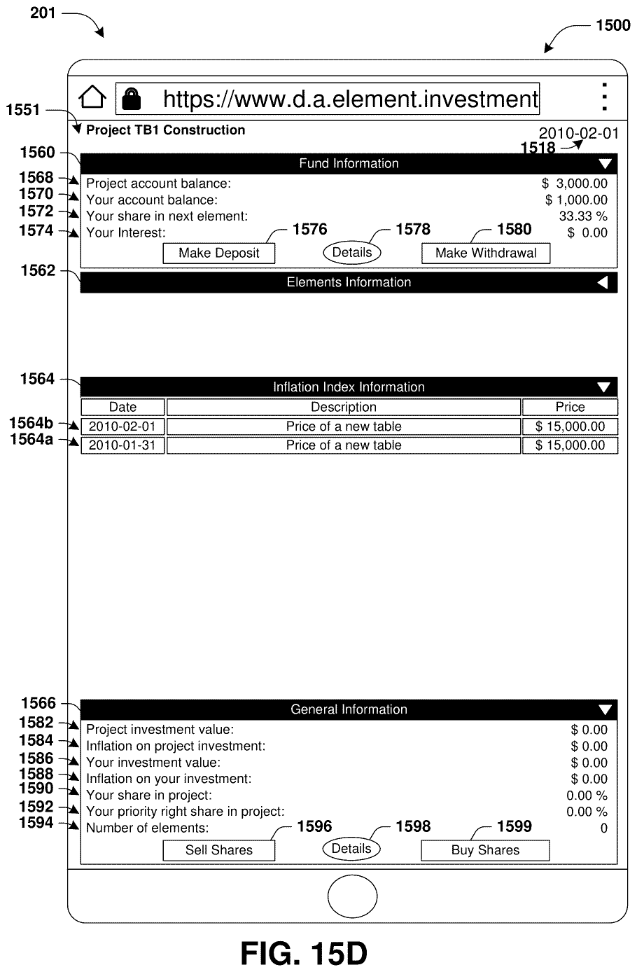

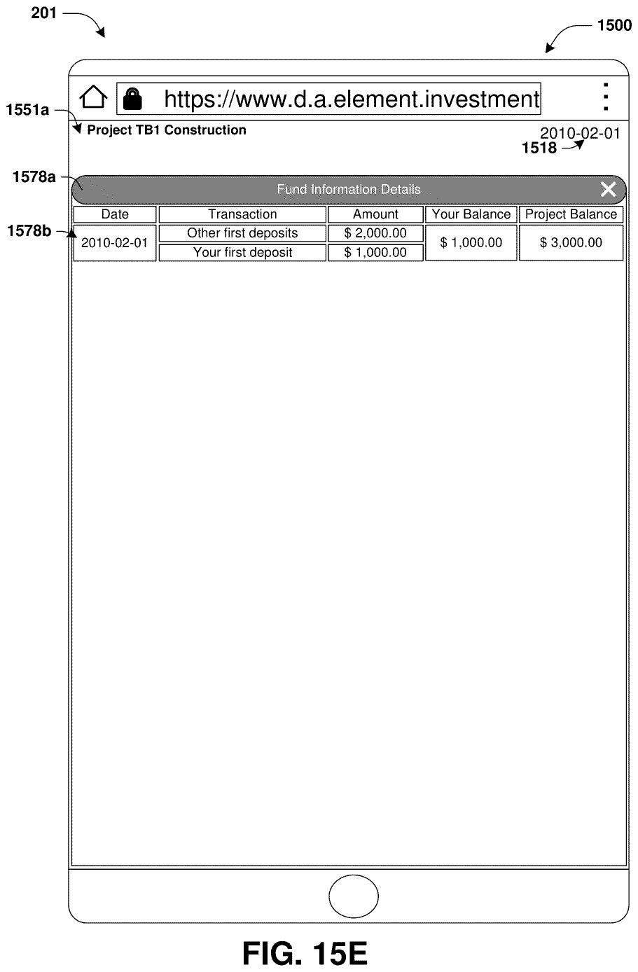

An embodiment of determining and managing investment shares in projects is illustrated by an example method 100 of FIG. 1, and is further described in conjunction with system 201 of FIGS. 2A-20B. At 102 of FIG. 1, deposit information 206 (shown in FIG. 2A) associated with a plurality of deposits 310 (e.g., Deposit 1, Deposit 2, Deposit 3, Deposit 4, Deposit 5, and/or Deposit 6 shown in FIG. 3) associated with a project (e.g., a first project) may be determined. The first project may be TB1 construction project (shown with in FIG. 15A) which may involve building a table, wherein final product of the TB1 construction project may be the table. The deposit information 206 may be indicative of deposit amounts 306 (e.g., a first deposit amount of $1,000.00 associated with the Deposit 1, a second deposit amount of $2,000.00 associated with the Deposit 2, a third deposit amount of $2,000.00 associated with the Deposit 3, a fourth deposit amount of $3,000.00 associated with the Deposit 4, a fifth deposit amount of $2,000.00 associated with the Deposit 5, and/or a sixth deposit amount of $5,000.00 associated with the Deposit 6 that are shown in FIG. 3) of the plurality of deposits 310, investors 302 (e.g., a first investor named “Tom”, a second investor named “Bob”, a third investor named “Leo”, and etc.) associated with the plurality of deposits 310, and/or times 304 (e.g., deposit times, deposit dates, etc.) of the plurality of deposits 310. In some examples, the times 304 may be indicative of the deposit times (a first deposit time, a second deposit time, a third deposit time, and/or a fourth deposit time shown in FIG. 3, for example) of the project. In an example, the times 304 may be indicative of deposit days (a first deposit day, a second deposit day, a third deposit day, a fourth deposit day, and/or etc.) of the first project. As shown in FIG. 3, (i) the Deposit 1 may be made, by the first investor named “Tom”, on the first deposit day (e.g., Day 1 of the first project, a first day of the first project), (ii) the Deposit 2 may be made, by the second investor named “Bob”, on the first deposit day (e.g., the Day 1 of the first project), (iii) the Deposit 3 may be made, by the first investor named “Tom”, on the second deposit day (e.g., Day 2 of the first project, a second day of the first project), (iv) the Deposit 4 may be made, by the second investor named “Bob”, on the third deposit day (e.g., Day 3 of the first project, a third day of the first project), (v) the Deposit 5 may be made, by the first investor named “Tom”, on the fourth deposit day (e.g., Day 4 of the first project, a fourth day of the first project), and (vi) the Deposit 6 may be made, by the third investor named “Leo”, on the fourth deposit day (e.g., the Day 4 of the first project). FIG. 2A illustrates determination of the deposit information 206, in accordance with some embodiments. In some examples, the deposit information 206 may be determined using a deposit information determination module 204. FIG. 3 illustrates a data structure 300 indicative of the deposit amounts 306 of the plurality of deposits 310, the investors 302, and/or the times 304, in accordance with some embodiments. In some examples, the deposit information 206 comprises the data structure 300.

In some examples, the data structure 300 may comprise a market data structure. In some examples, the market data structure may be indicative of market remarks 308 associated with the investors 302. In some examples, the market remarks 308 may be indicative of transferring ownership shares between the investors 302 at different times of the project. In some examples, the ownership shares of the investors 302 may comprise inflation-corrected shares and/or priority right shares associated with the investors 302. For example, while the first project is in progress, and/or at any time (e.g., on the Day 4 of the first project, on 4 Feb. 2010) of the first project, the first investor (e.g., Tom) may transfer (e.g., sell) a portion of his ownership share (e.g., 50%) in the first project to another existing investor or a new investor (e.g., a fourth investor named “Sam”). Accordingly, the ownership share of the first investor may be reduced by half and a new ownership share of the new investor (e.g., the fourth investor named “Sam”) may be equal to an updated ownership share of the first investor. In some examples, market information 226 (shown in FIG. 2B) associated with the market remarks 308 (shown in FIG. 3) associated with the first project may be determined. In some examples, the market information 226 may be determined using a market information determination module 224 (shown in FIG. 2B). FIG. 2B illustrates determination of the market information 226, in accordance with some embodiments. In some examples, the market information 226 comprises the market data structure and/or the data structure 300.

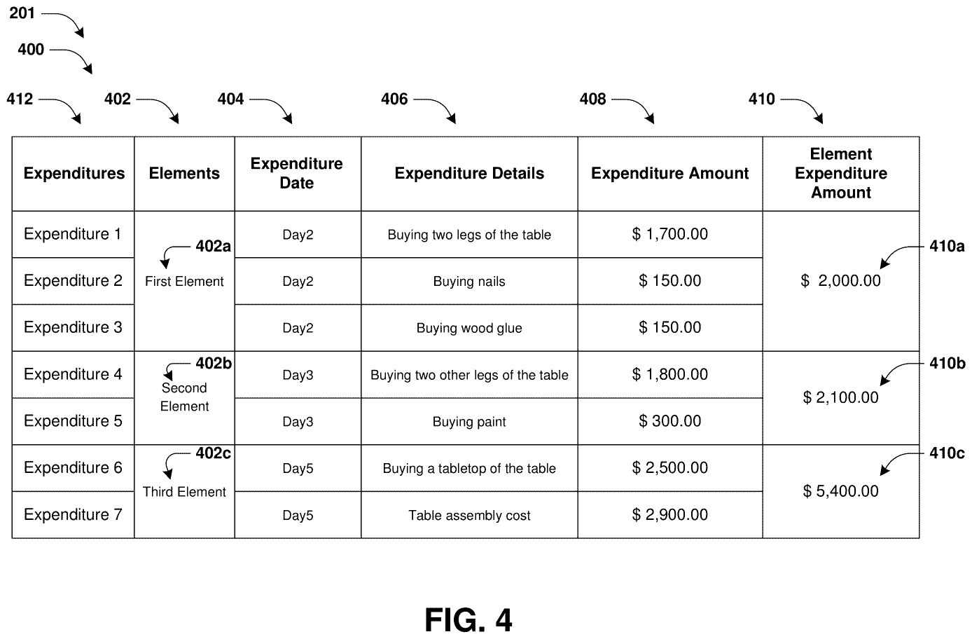

At 104 of FIG. 1, expenditure information 210 (shown in FIG. 2A) associated with a plurality of expenditures 412 (e.g., Expenditure 1, Expenditure 2, Expenditure 3, Expenditure 4, Expenditure 5, Expenditure 6, and/or Expenditure 7 shown in FIG. 4) associated with the project (e.g., the first project) may be determined. The expenditure information 210 may be indicative of expenditure amounts 408 (e.g., a first expenditure amount of $1,700.00 associated with the Expenditure 1, a second expenditure amount of $150.00 associated with the Expenditure 2, a third expenditure amount of $150.00 associated with the Expenditure 3, a fourth expenditure amount of $1,800.00 associated with the Expenditure 4, a fifth expenditure amount of $300.00 associated with the Expenditure 5, a sixth expenditure amount of $2,500.00 associated with the Expenditure 6, and/or a seventh expenditure amount of $2,900.00 associated with the Expenditure 7 shown in FIG. 4) of the plurality of expenditures 412 and times 404 (e.g., expenditure times, expenditure dates, etc.) of the plurality of expenditures 412. In some examples, the times 404 may be indicative of the expenditure times (e.g., a firth expenditure time, a second expenditure time, and/or a third expenditure time shown if FIG. 4, for example). In an example, the times 404 may be indicative of expenditure days (a first expenditure day, a second deposit day, and/or a third expenditure day) of the first project. As shown in FIG. 4, (i) the Expenditure 1 may be made, by one or more project managers of the project, on the first expenditure day (e.g., the Day 2 of the first project), (ii) the Expenditure 2 may be made, in the first project, on the first expenditure day (e.g., the Day 2 of the first project), (iii) the Expenditure 3 may be made, by the one or more project managers, on the first expenditure day (e.g., the Day 2 of the first project), (iv) the Expenditure 4 may be made, by the one or more project managers, on the second expenditure day (e.g., the Day 3 of the first project), (v) the Expenditure 5 may be made, by the one or more project managers, on the second expenditure day (e.g., Day 3 of the first project), (vi) the Expenditure 6 may be made, by the one or more project managers, on the third expenditure day (e.g., Day 5 of the first project, a fifth day of the first project), and/or (vii) the Expenditure 7 may be made, by the one or more project managers, on the third expenditure day (e.g., the Day 5 of the first project). FIG. 2A illustrates determination of the expenditure information 210, in accordance with some embodiments. In some examples, the expenditure information 210 may be determined using an expenditure information determination module 208. FIG. 4 illustrates a data structure 400 indicative of the expenditure amounts 408 of the plurality of expenditures 412 and/or the times 404 of the plurality of expenditures 412, in accordance with some embodiments. In some examples, the expenditure information 210 comprises the data structure 400.

In some examples, a first project data structure, associated with the first project may be generated (e.g., determined). In some examples, the first project data structure may comprise one, some and/or all information of the data structure 400. The first project data structure may comprise a plurality of profiles (e.g., a plurality of elements 402) associated with a periods of time (e.g., the times 404 of the plurality of expenditures 412) during a window of time beginning at a starting time (e.g., on the Day 1, on the first day, 1 Feb. 2010) associated with the first project to current time (e.g., current day, completion day) of the first project. In some examples, the starting time associated with the first project may be a time/day of initial deposit in the first project. In some examples, the starting time associated with the first project may be a user-entered day. In some examples, the plurality of profiles may comprise a first profile (e.g., a first element 402a) associated with a first period of time (e.g., the Day 2 of the first project). In some examples, the plurality of profiles may comprise a second profile (e.g., a second element 402b) associated with a second period of time (e.g., the Day 3 of the first project). In some examples, the plurality of profiles may comprise a third profile (e.g., a third element 402c) associated with a third period of time (e.g., the Day 5 of the first project). In some examples, the first profile may comprise first expenditure(s) (e.g., the Expenditure 1, the Expenditure 2 and/or the Expenditure 3) associated with the first period of time (e.g., the Day 2 of the first project). In some examples, the second profile may comprise second expenditure(s) (e.g., the Expenditure 4, and/or the Expenditure 5) associated with the second period of time (e.g., the Day 3 of the first project). In some examples, the third profile may comprise third expenditure(s) (e.g., the expenditure 6, and/or the expenditure 7) associated with the third period of time (e.g., the Day 5 of the first project). In some examples, the first period of time, the second period of time and/or the third period of time may correspond to a period of about a year, a season, a month, a week, a day and/or an hour. In some examples, the first period of time, the second period of time and/or the third period of time may correspond to a period of about 24 hours.

In some examples, the first profile may comprise a first share of the investors 302 associated with the first period of time. In some examples, the second profile may comprise a second share of the investors 302 associated with the second period of time. In some examples, the third profile may comprise a third share of the investors 302 associated with the third period of time.

In some examples, each investor of the investors 302 may be able to transfer at least a portion of an ownership share in a profile (e.g., an element) of the plurality of profiles (e.g., the plurality of elements 402) to another existing investor or a new investor.

In some examples, one or more motivational buying messages may be provided and/or sent to one or more devices (e.g., one or more user equipment, one or more cellphones, one or more tablets, one or more computers, etc.) associated with one or more users (who wants to invest in the first project, for example), wherein the one or more motivational buying messages may be indicative of introducing the plurality of elements 402.

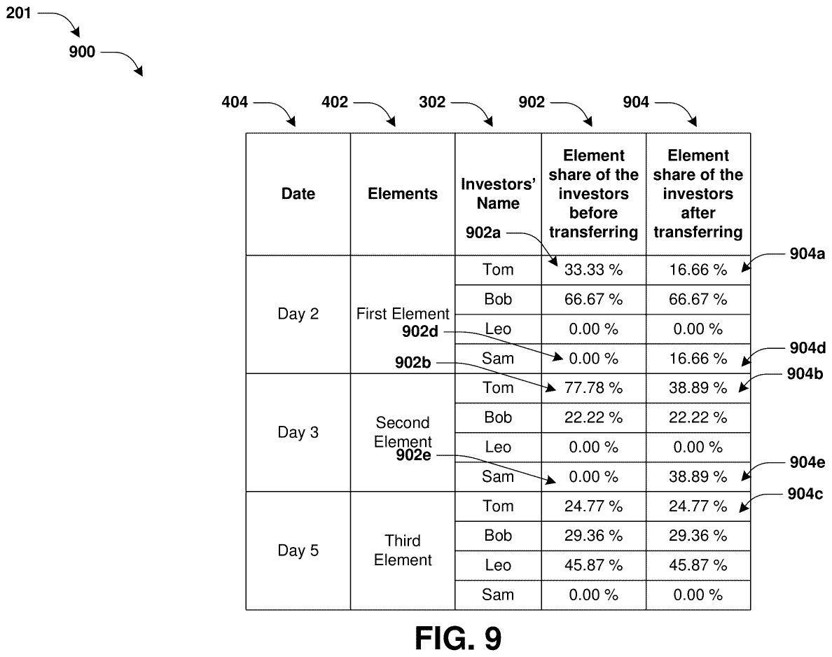

In some examples, the investors 302 may have one or more element share(s) in the plurality of elements 402 associated with the periods of time. In some examples, each element share of the one or more element shares associated with each investor of the investors 302 may be indicative of share of each investor in each element. For example, the second investor (e.g., Bob) may have (i) a first element share of about 66.67% in the first element 402a on the Day 2 of the first project, (ii) a second element share of about 22.22% in the second element 402b on the Day 3 of the first project, and (iii) a third element share of about 29.36% in the third element 402c on the Day 5 of the first project (shown in FIG. 9).

In some examples, element information 230 (shown in FIG. 2B) associated with the plurality of profiles (e.g., the plurality of elements 402 that are shown in FIG. 4) associated with the project (e.g., the first project) may be determined. In some examples, the element information 230 may be determined using an element information determination module 228 (shown in FIG. 2B). FIG. 2B illustrates determination of the element information 230, in accordance with some embodiments. In some examples, the expenditure information 210 may be input information of the element information determination module 228. In some examples, the element information 230 may be output information of the element information determination module 228. In some examples, the element information 230 may comprise an element data structure comprising the plurality of elements 402 and/or the plurality of element expenditure amounts 410. In some examples, the element information 230 comprises the element data structure and/or the data structure 400.

In some examples, the data structure 400 may comprise a plurality of expenditure details 406 for one, some, and/or all of the plurality of expenditures 412. In some examples, the data structure 400 may comprise the plurality of elements 402 (e.g., a first element 402a, a second element 402b, a third element 402c, etc.), wherein each element of the plurality of elements 402 may be indicative of one or more expenditures of the plurality of expenditures 412 made at a same time. For example, the first element 402a may comprise (i) the Expenditure 1 with the first expenditure amount (e.g., $1,700.00), (ii) the Expenditure 2 with the second expenditure amount (e.g., $150.00) and/or (iii) the Expenditure 3 with the third expenditure amount (e.g., $150.00), wherein the Expenditure 1, the Expenditure 2 and the Expenditure 3 are made (e.g., incurred) on the Day 2 (e.g., the second day, 2 Feb. 2010) of the first project. The second element 402b may comprise the Expenditure 4 with the fourth expenditure amount (e.g., $1,800.00) and/or the Expenditure 5 with the fifth expenditure amount (e.g., $300.00), wherein the Expenditure 4 and the Expenditure 5 are made (e.g., incurred) on the Day 3 (e.g., the third day, 3 Feb. 2010) of the first project. The third element 402c may comprise the Expenditure 6 with the sixth expenditure amount (e.g., $2,500.00) and/or the Expenditure 7 with the seventh expenditure amount (e.g., $2,900.00), wherein the Expenditure 6 and the Expenditure 7 are made (e.g., incurred) on the Day 5 (e.g., the fifth day, 5 Feb. 2010) of the first project. In some examples, the data structure 400 may comprise a plurality of element expenditure amounts 410 associated with the plurality of elements 402. As shown in FIG. 4, the plurality of element expenditure amounts 410 comprises (i) a first element expenditure amount 410a (e.g., $2,000.00) associated with the first element 402a, (ii) a second element expenditure amount 410b (e.g., $2,100.00) associated with the second element 402b, and (iii) a third element expenditure amount 410c (e.g., $5,400.00) associated with the third element 402c.

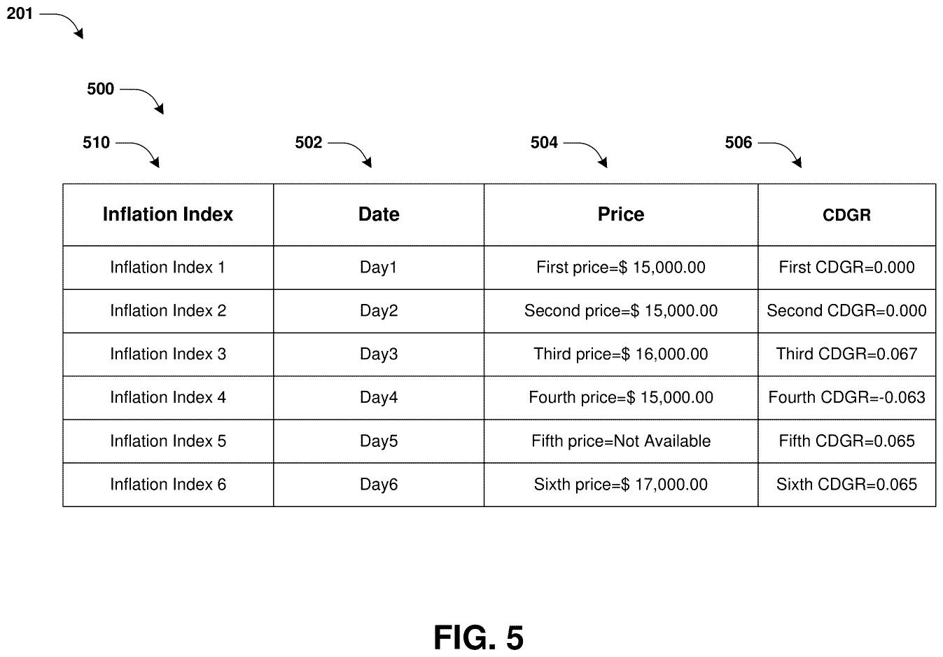

At 106 of FIG. 1, inflation indexes 214 (shown in FIG. 2A) associated with the periods of time within the window of time beginning at the starting time (e.g., the time/day of the initial deposit, or a user-entered day) may be determined. FIG. 2A illustrates determination of the inflation indexes 214, in accordance with some embodiments. In some examples, the inflation indexes 214 may be determined using an inflation index determination module 212. FIG. 5 illustrates a data structure 500 indicative of a plurality of inflation indexes 510, times 502 (e.g., dates, the Day 1, the Day 2, the Day 3, the Day 4, the Day 5, and/or Day 6 of the first project) of the plurality of inflation indexes 510 and/or prices 504 (e.g., values) associated with the final product (e.g., the table) of the first project during the times 502, in accordance with some embodiments. In some examples, the times 502 may correspond to number of days (e.g., 6 days from the Day 1 to the Day 6) of the first project. As shown in FIG. 5, the Day 1 is the initial date (e.g., a start date) and the Day 6 is the final date (e.g., a completion date, the completion day, a sixth day) of the first project. In some examples, the inflation indexes 214 comprise the data structure 500. In some examples, the data structure 500 may comprise a plurality of compound growth rates (e.g., a plurality of compound daily growth rates (CDGRs) 506, a plurality of hourly growth rates, a plurality of weekly growth rates, a plurality of monthly growth rates, etc.) for one, some, and/or all of the plurality of inflation indexes 510. In some examples, the plurality of compound growth rates may be determined (e.g., calculated) using a plurality of compound growth rate formulas. In some examples, the inflation index determination module 212 may comprise a CDGR determination module (not shown). In some examples, the CDGR determination module may determine (e.g., generate) the plurality of CDGRs 506 from the initial day (e.g., the Day 1) of the first project to current day (e.g., the Day 2, the Day 3, the Day 4, the Day 5, the Day 6) of the first project. The plurality of CDGRs 506 may be determined based upon changes in the prices 504 associate with the plurality of inflation indexes 510 over times 502 of the first project. In some examples, investors in a project may agree on a price of an item (e.g., price of the table in the first project) as an inflation index. In some examples, the inflation index may represent price of a single item (e.g., the table) and/or price of multiple items (e.g., a portfolio of goods, legs of the table, nails, wood glue, paint, table top of the table, etc.) utilized in the project (e.g., the first project). In some examples, when utilizing the multiple items, impact of each item of the multiple items and/or the portfolio of goods may be determined based upon price (e.g., value) of each item in the project to select a more accurate inflation index and/or to update inflation-index corrected shares of the investors 302 in the project (e.g., the first project). In some examples, the inflation index may be a consumer price index (CPI). In some examples, the plurality of inflation indexes 510 may be price of other items such as price of a new apartment, price of gold, exchange rate and/or an inflation index associated with central bank.

In an example, the CDGR determination module may utilize a CDGR formula to determine the plurality of CDGRs 506 associated with the first project. For example, the plurality of CDGRs 506 (which is a type of compound growth rates and is determined daily, for example) associated with the first project may be determined using the CDGR formula as below.

$$CDGR = {( \frac{{V}_{final}}{{V}_{begin}} )}^{\frac{1}{t}} - 1$$

wherein, CDGR represents compound daily growth rate, V_{final} represents final value (e.g., price of inflation index in current day) of the first project, V_{begin} represents beginning value (e.g., price of inflation index in previous day) of the first project, and t represents time interval in day(s).

In some examples, the prices 504 (e.g., values) of the plurality of inflation indexes 510 associated with the first project may be price of the final product of the first project (e.g., price of the table in the TB1 construction project) and/or price of one or more components (e.g., legs of the table, nails, wood glue, paint, table top of the table, etc.) of the final product of the first project during the periods of time within the window of time beginning at the starting time (e.g., on the Day 1) of the first project. For example, as shown in FIG. 5, the prices 504 comprise (i) a first price (e.g., $15,000.00) for the table on the Day 1 of the first project (the first price is associated with the inflation index 1, for example), (ii) a second price (e.g., $15,000.00) for the table on the Day 2 of the first project (the second price is associated with the inflation index 2, for example), (iii) a third price (e.g., $16,000.00) for the table on the Day 3 of the first project (the third price is associated with the inflation index 3, for example), (iv) a fourth price (e.g., $15,000.00) for the table on the Day 4 of the first project (the fourth price is associated with the inflation index 4, for example), (v) a fifth price (e.g., a not available price) for the table on the Day 5 of the first project (it is assumed that, the fifth price associated with the inflation index 5 is not available and/or is not inserted in the data structure 500), and (vi) a sixth price (e.g., $17,000.00) for the table on the Day 6 of the first project (the sixth price is associated with the inflation index 6, for example).

In an example, a price for the table on a day (e.g., on 31 Jan. 2010) before the Day 1 of the first project is assumed to be equal to the first price (e.g., $15,000.00) for the table on the Day 1 of the first project. Accordingly, given that V_{final} for the first CDGR equals the first price (e.g., $15,000.00), V_{begin} for the first CDGR equals the price (e.g., $15,000.00) for the table associated with the day before the Day 1 of the first project and t equals 1 (time interval is daily, for example), according to the CDGR formula, the first CDGR equals zero, as below:

$$First CDGR = {( \frac{{V}_{final} = \$15 , 0.}{{V}_{begin} = \$15 , 0.} )}^{\frac{1}{t = 1}} - 1 = {1}^{1} - 1 = 0$$

Similarly, using the CDGR formula, the second CDGR, the third CDGR and the fourth CDGR may be determined, as below:

$$Second CDGR = {( \frac{{V}_{final} = \$15 , 0.}{{V}_{begin} = \$15 , 0.} )}^{\frac{1}{t = 1}} - 1 = {1}^{1} - 1 = 0$$

$$Third CDGR = {( \frac{{V}_{final} = \$16 , 0.}{{V}_{begin} = \$15 , 0.} )}^{\frac{1}{t = 1}} - 1 = 0.067$$

$$Fourth CDGR = {( \frac{{V}_{final} = \$15 , 0.}{{V}_{begin} = \$16 , 0.} )}^{\frac{1}{t = 1}} - 1 = - 0.063$$

In some examples, when one or more prices (the fifth price of the inflation index 4 associated with the Day 5 of the first project, for example) of the prices 504 are not be available, one or more CDGRs associated with the one or more prices, may be determined via interpolating and/or extrapolating other CDGRs (e.g., other determined CDGRs). For example, the fifth CDGR associated with the inflation index 5 is determined based upon determining the sixth CDGR associated with the inflation index 6. The Sixth CDGR is determined using the CDGR formula as below:

$$Sixth CDGR = {( \frac{{V}_{final} = \$17 , 0.}{{V}_{begin} = \$15 , 0.} )}^{\frac{1}{t = 2}} - 1 = \sqrt{1.13333} - 1 \approx 0.065$$

wherein, V_{final} represents final value (e.g., price of inflation index on the Day 6) of the first project, V_{begin} represents beginning value (e.g., price of inflation index on the Day 4) of the first project, t represents time interval in days (e.g., two days from the Day 4 to the Day 6). As shown in FIG. 5, based upon the interpolating and/or the extrapolating, value of the fifth CDGR (e.g., 0.065) may be equal to value of the sixth CDGR.

In some examples, the CDGR determination module may manually and/or automatically receive inputs (e.g., V_{final}, V_{begin}, t) of the CDGR formula. The inputs may manually be entered by a user and/or may automatically be retrieved from a website. Using the CDGR formula, the CDGR determination module may determine the plurality of CDGRs 506 over times 502 of the first project and may record the plurality of CDGRS 506 in a database to use in determining (i) inflation of investment associated with the investors 302 in the plurality of elements 402, (ii) inflation of the plurality of elements 402 in the first project and/or (iii) inflation of investment associated with the investors 302 in the first project. In some examples, output of the CDGR determination module may be the plurality of CDGRs and times 502 associated with the plurality of CDGRs.

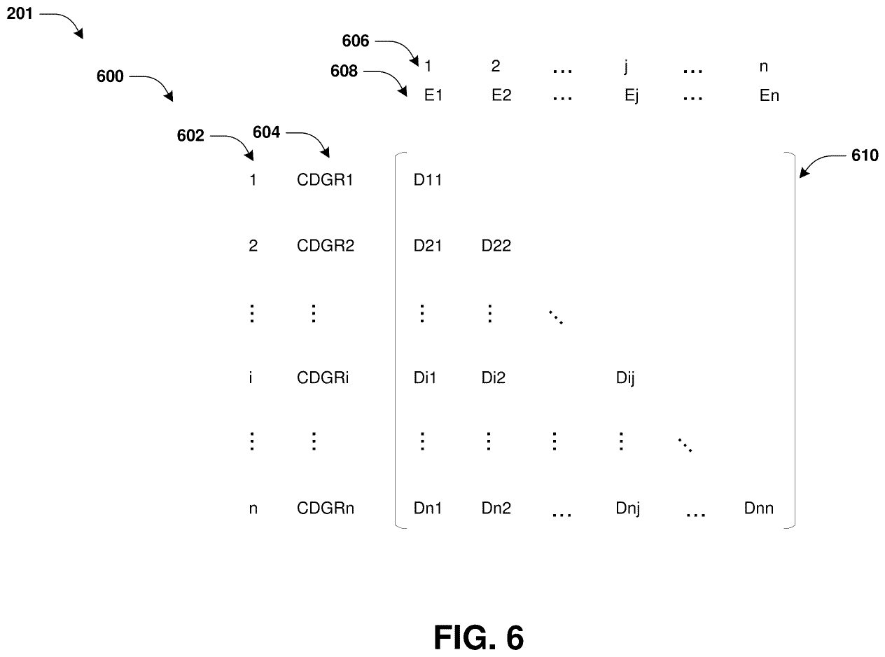

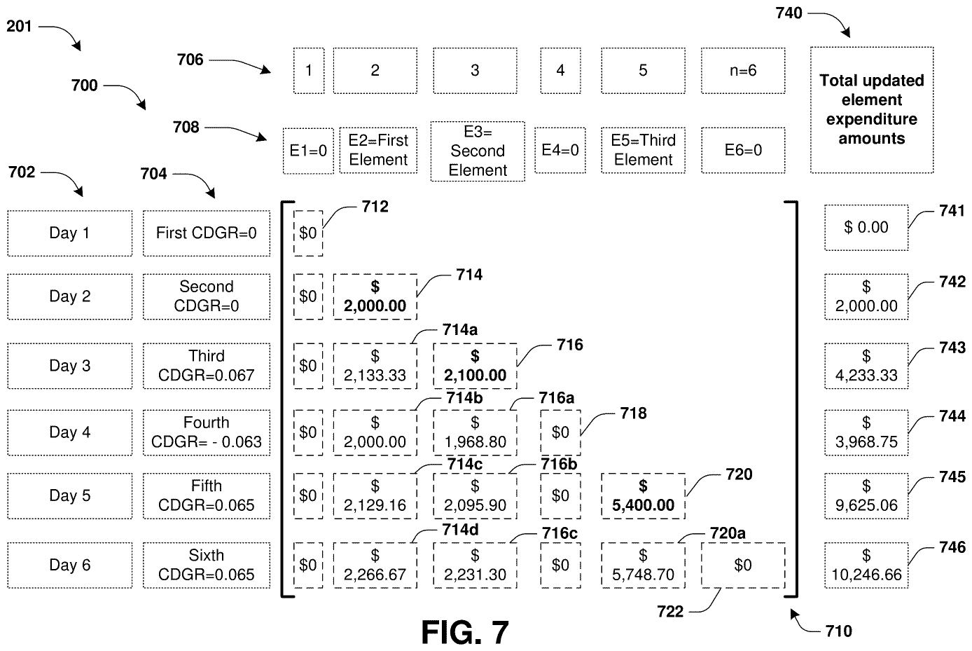

At 108 of FIG. 1, inflation-corrected shares 218 (shown in FIG. 2A) associated with the investors 302, may be determined based upon determining (i) the deposit information 206, (ii) the expenditure information 210 and/or (iii) the inflation indexes 214. FIG. 2A illustrates determination of the inflation-corrected shares 218, in accordance with some embodiments. In some examples, the inflation-corrected shares 218 may be determined using an inflation-corrected share determination module 216. In some examples, the inflation-corrected share determination module 216 may utilize (e.g., use) an inflation matrix 610 (shown in FIG. 6) to determine a plurality of inflations associated with the plurality of element expenditure amounts 410 during progress of the first project. In an example, the inflation-corrected share determination module 216 may utilize (e.g., use) the inflation matrix 610 to determine a first inflation matrix 710 (shown in FIG. 7) for the first project.

In some examples, the inflation-corrected shares 218 may be determined based upon determining (i) the deposit information 206, (ii) the expenditure information 210, (iii) the inflation indexes 214, (iv) the element information 230, and or the market information 226 (as shown in FIG. 2B). FIG. 2B illustrates determination of the inflation-corrected shares 218, in accordance with some embodiments. In some examples, the inflation-corrected shares 218 may be determined using the inflation-corrected share determination module 216. In some examples, the inflation-corrected share determination module 216 may utilize (e.g., use) the inflation matrix 610 (shown in FIG. 6) to determine the plurality of inflations associated with the plurality of element expenditure amounts 410 during progress of the first project.

FIG. 6 illustrates a representation 600 of the inflation matrix 610, a plurality of rows 602 (e.g., rows 1-n), a plurality of columns 606 (e.g., columns 1-n), a plurality of elements 608 (e.g., E1-En) and/or a plurality of CDGRs 604 (e.g., CDGRs 1-n), in accordance with some embodiments. In some examples, the inflation matrix 610 may be a real-time inflation matrix and/or may determine the plurality of inflations associated with a plurality of element expenditure amounts (e.g., the plurality of element expenditure amounts 410 in the first project) in different times in a project. The inflation matrix 610 may be a lower triangular matrix with a rank of n×n, wherein n corresponds to number of days in the project from starting time of a project to current day of the project. In some examples, values of elements (e.g., the plurality of element expenditure amounts 410) in the project, may be placed on main diagonal of the inflation matrix 610 and the inflation matrix 610 may update the values of the elements during the progress of the project. As shown in FIG. 6, the main diagonal of the inflation matrix 610 comprises a first main array D11 (e.g. an element expenditure amount of Element 1 on a first day of the project), a second main array D22 (e.g. an element expenditure amount of element 2 on a second day of the project), an ith main array Dij (e.g. an element expenditure amount of element i on day i of the project), an nth main array Dnn (e.g. an element expenditure amount of element n on day n of the project), wherein i represents a row (e.g., a day of the project) of the inflation matrix 610 and j represents a column (e.g., a day of the project) of the inflation matrix 610. In some examples, the main diagonal of the inflation matrix 610 may comprise main diagonal arrays, wherein the main diagonal arrays may be equal to values of elements as below:

$$D 11 = Value of E 1 , D 22 = Value of E 2 , … , Dnn = Value of En$$

In some examples, the inflation matrix 610 may comprise arrays below the main arrays (e.g., the main diagonal arrays) which are inflation corrected arrays during progress of the project. For example, an array D21 may be an inflation corrected array of the first main array D11 in the second day of the project. An array Di1 may be an inflation corrected array of the first main array D11 in the ith day of the project and an array Dn1 may be an inflation corrected array of the first main array D11 in the nth day (e.g., current day, final day, last day, etc.) of the project. Inflation corrected arrays of the inflation matrix 610 may be determined via using an inflation formula as below:

$${D}_{( i + 1 , j )} = {{D}_{ij}}^{*} {CDGR}_{i + 1} + {D}_{ij}$$

wherein i represents day i of the project (e.g. a first row of the inflation matrix 610), i+1 represents day i+1 of the project (e.g., a second row of the inflation matrix 610 below the first row), j represents a column of the inflation matrix 610 (e.g., a column associated with an element j of a plurality of elements associated with expenditures of the project), CDGRᵢ₊₁ illustrates a CDGR of day i+1, Dᵢⱼ illustrates a first value of expenditures of the element j on day i, and D_{(i+1, j)} illustrates a second value (e.g., a value affected by one-day inflation from ith day to (i+1)th day) of expenditures of the element j on day i+1. The inflation formula illustrates how the first value of the expenditures of the element i changes in one day and be converted to the second value of the expenditures of the element i based upon the CDGRᵢ₊₁ and/or inflation indexes associated with the CDGRᵢ₊₁. For example, the array D21 of the inflation matrix 610 may be an inflation corrected array of the main array D11 in the second day of the project, wherein the array D21 may be determined using the inflation formula as below:

$$D 21 = D {11}^{*} {CDGR}_{2} + D 11$$

FIG. 7 illustrates a first representation 700 of the first inflation matrix 710, a first plurality of rows 702 (e.g., rows 1-6), a first plurality of columns 706 (e.g., columns 1-6), a first plurality of elements 708 (e.g., the plurality of elements 402 of the first project), a plurality of total updated element expenditure amounts 740 and/or a first plurality of CDGRs 704 (e.g., the plurality of CDGRs 506 of the first project) associated with the first project, in accordance with some embodiments. In some examples, the first inflation matrix 710 may be a first real-time inflation matrix and/or may determine a first plurality of inflations associated with the plurality of element expenditure amounts 410 in the first project. In some examples, the first plurality of rows 702 may be indicative of days of the first project from the initial day (e.g., the Day 1) of the first project to current day (e.g., the Day 2, the Day 3, the Day 4, the Day 5, the Day 6, etc.) of the first project. For example, the first plurality of rows 702 comprise six days wherein the six days shows days of the first project from the initial day to the completion day (e.g., the final day, the Day 6) of the first project. As shown in FIG. 7, the first project starts on the Day 1 and is completed on the Day 6. The first plurality of elements 708 may comprise an Element 1 (e.g., an E1), an Element 2 (e.g., an E2), an Element 3 (e.g., an E3), an Element 4 (e.g., an E4), an Element 5 (e.g., an E5) and/or an Element 6 (e.g., an E6). The main diagonal of the inflation matrix 710 may comprise the first main array D11 (which equals an expenditure amount 712 on the Day 1 of the first project, for example), the second main array D22 (which equals an expenditure amount 714 on the Day 2 of the first project), a third main array D33 (which equals an expenditure amount 716 on the Day 3 of the first project), a fourth main array D44 (which equals an expenditure amount 718 on the Day 4 of the first project), a fifth main array D55 (which equals an expenditure amount 720 on the Day 5 of the first project) and/or a sixth main array D66 (which equals an expenditure amount 722 on the Day 6 of the first project). In some examples, when there are no expenditures in one or more days of a project, value of main arrays of the inflation matrix 610 and/or the inflation matrix 710 in the one or more days of the project may be zero. For example, since there are no expenditures on the Day 1, the Day 4 and/or the Day 6 of the first project, the expenditure amounts 712, 718 and/or 722 are zero. The expenditure amount 712 is amount of the Element 1 and is zero. The expenditure amount 718 is amount of the Element 4 and is zero. The expenditure amount 722 is amount of the Element 6 and is zero. The expenditure amount 714 is amount of the Element 2 which is the first element of the first project and is $2,000.00. The expenditure amount 716 is amount of the Element 3 which is the second element of the first project and is $2,100.00. The expenditure amount 720 is amount of the Element 5 which is the third element of the first project and is $5,400.00. In some examples, the expenditure amounts 712, 714, 716, 718, 720 and 722 may respectively be associated with amounts of the E1, the E2, the E3, the E4, the E5 and the E6. In some examples, the amounts of the E1, the E2, the E3, the E4, the E5 and the E6 may respectively be associated with and/or equal to the first main array D11, the second main array D22, the third main array D33, the fourth main array D44, the fifth main array D55 and the sixth main array D66. In FIG. 7, a second column (e.g., a column associated with the first element) of the first inflation matrix 710 may comprise (i) a first inflation corrected array 714a (e.g., array D32) which may correspond to value of the expenditure amount 714 on the Day 3 (e.g., one day after the Day 2), (ii) a second inflation corrected array 714b (e.g., array D42) which may correspond to value of the expenditure amount 714 on the Day 4 (e.g., one day after the Day 3), (iii) a third inflation corrected array 714c (e.g., array D52) which may correspond to value of the expenditure amount 714 on the Day 5 (e.g., one day after the Day 4) and (iv) a fourth inflation corrected array 714d (e.g., array D62) which may correspond to value of the expenditure amount 714 on the Day 6 (e.g., one day after the Day 5, the final day of the first project). A third column (e.g., a column associated with the second element) of the first inflation matrix 710 may comprise (i) a fifth inflation corrected array 716a (e.g., array D43) which may correspond to value of the expenditure amount 716 on the Day 4, (ii) a sixth inflation corrected array 716b (e.g., array D53) which may correspond to value of the expenditure amount 716 on the Day 5 and (iii) a seventh inflation corrected array 716c (e.g., array D63) which may correspond to value of the expenditure amount 716 on the Day 6. A fifth column (e.g., a column associated with the third element) of the first inflation matrix 710 may comprise an eighth inflation corrected array 720a (e.g., array D65) which may correspond to value of the expenditure amount 720 on the Day 6. Inflation corrected arrays in the first column, the fourth column and/or the sixth column of the first inflation matrix 710 may be associated with the expenditure amounts 712, 718 and/or 722. In some examples, the expenditure amounts 712, 718 and/or 722 may be zero. Alternatively and/or additionally, the Inflation corrected arrays in the first column, the fourth column and/or the sixth column may be zero.

In some examples, the plurality of total updated element expenditure amounts 740 may comprise one or more total updated element expenditure amounts, wherein each total updated element expenditure amount may be associated with one or more elements in one day of the first project. In some examples, the plurality of total updated element expenditure amounts 740 may comprise a first total updated element expenditure amount 741 associated with the Day 1, a second total updated element expenditure amount 742 associated with the Day 2, a third total updated element expenditure amount 743 associated with the Day 3, a fourth total updated element expenditure amount 744 associated with the Day 4, a fifth total updated element expenditure amount 745 associated with the Day 5, and/or a sixth total updated element expenditure amount 746 associated with the Day 6. In some examples, the first inflation matrix 710 may determine real-time inflations on the plurality of elements 402 in the first project.

In some examples, the first total updated element expenditure amount 741 may be sum of array(s) (e.g., D11) in the first row of the first inflation matrix 710. In some examples, the first total updated element expenditure amount 741 (e.g., $0) may be sum of array(s) (e.g., expenditure amount 712) in the first row of the first inflation matrix 710 (e.g., the Day 1 of the first project). Value of the first total updated element expenditure amount 741 indicates that no expenditure may be made on the Day 1 of the first project. In some examples, the second total updated element expenditure amount 742 may be sum of array(s) (e.g., D21 and D22) in the second row of the first inflation matrix 710. In some examples, the second total updated element expenditure amount 742 (e.g., $2,000.00) may be sum of array(s) (e.g., expenditure amount 714) on the Day 2 of the first project. Value of the second total updated element expenditure amount 742 indicates that a first expenditure(s) (e.g., $2,000.00) is made on the Day 2 of the first project; however, since the first expenditure(s) occurs on the Day 2, no inflation adjustment is applied to the first expenditure(s). In some examples, the third total updated element expenditure amount 743 may be sum of array(s) (e.g., D31, D32 and D33) in the third row of the first inflation matrix 710. In some examples, the third total updated element expenditure amount 743 (e.g., $4,233.33) may be sum of array(s) (e.g., expenditure amount 716 and the first inflation corrected array 714a) on the Day 3 of the first project. Value of the third total updated element expenditure amount 743 indicates that a second expenditure(s) ($2,100.00) is made on the Day 3 of the first project; however, since (i) the second expenditure(s) occurs on the Day 3, no inflation adjustment is applied to the second expenditure(s), and (ii) the first expenditure(s) occurs on the Day 2, a one-day inflation adjustment is applied to the first expenditure(s) on the Day 3. In some examples, the fourth total updated element expenditure amount 744 may be sum of array(s) (e.g., D41, D42, D43 and D44) in the fourth row of the first inflation matrix 710. In some examples, the fourth total updated element expenditure amount 744 (e.g., $3,968.75) may be sum of array(s) (e.g., expenditure amount 718, the second inflation corrected array 714b and the fifth inflation corrected array 716a) on the Day 4 of the first project. Value of the fourth total updated element expenditure amount 744 indicates that no expenditure(s) is made on the Day 4 of the first project; however, since (i) the second expenditure(s) occurs on the Day 3, a one-day inflation adjustment is applied to the second expenditure(s) on the Day 4, and (ii) the first expenditure(s) occurs on the Day 2, a two-days inflation adjustment is applied to the first expenditure(s) on the Day 4. In some examples, the fifth total updated element expenditure amount 745 may be sum of array(s) (e.g., D51, D52, D53, D54 and D55) in the fifth row of the first inflation matrix 710. In some examples, the fifth total updated element expenditure amount 745 (e.g., $9,625.06) may be sum of array(s) (e.g., expenditure amount 720, the third inflation corrected array 714c and the sixth inflation corrected array 716b) on the Day 5 of the first project. Value of the fifth total updated element expenditure amount 745 indicates that a third expenditure(s) ($5,400.00) is made on the Day 5 of the first project; however, since (i) the third expenditure(s) occurs on the Day 5, no inflation adjustment is applied to the third expenditure(s) on the Day 5, (ii) the second expenditure(s) occurs on the Day 3, a two-days inflation adjustment is applied to the second expenditure(s) on the Day 5, and (iii) the first expenditure(s) occurs on the Day 2, a three-days inflation adjustment is applied to the first expenditure(s) on the Day 5. In some examples, the sixth total updated element expenditure amount 746 may be sum of array(s) (e.g., D61, D62, D63, D64, D65 and D66) in the sixth row of the first inflation matrix 710. In some examples, the sixth total updated element expenditure amount 746 (e.g., $10,246.66) may be sum of array(s) (e.g., expenditure amount 722, the fourth inflation corrected array 714d, the seventh inflation corrected array 716c and the eighth inflation corrected array 720a) on the Day 6 of the first project (e.g., the final day of the first project). Value of the sixth total updated element expenditure amount 746 indicates that no expenditure(s) is made on the Day 6 of the first project; however, since (i) the third expenditure(s) occurs on the Day 5, a one-day inflation adjustment is applied to the third expenditure(s) on the Day 6, (ii) the second expenditure(s) occurs on the Day 3, a three-days inflation adjustment is applied to the second expenditure(s) on the Day 6, and (iii) the first expenditure(s) occurs on the Day 2, a four-days inflation adjustment is applied to the first expenditure(s) on the Day 6.

In some examples, bottom array of each column of the first inflation matrix 710 may be indicative of updated value of corresponding element of the inflation matrix 710 in the final day of the first project. In an example, bottom arrays of columns in the first inflation matrix 710 (on the Day 6 of the first project, for example) are determined as below:

$$Dn , 1 = D 6 , 1 = E ’ 1 = \$0 \text{.00} ;$$

$$Dn , 2 = D 6 , 2 = E ’ 2 = \$2 , 266.67 ;$$

$$Dn , 3 = D 6 , 3 = E ’ 3 = \$2 , 231.3 ;$$

$$Dn , 4 = D 6 , 4 = E ’ 4 = \$0 \text{.00} ;$$

$$Dn , 5 = D 6 , 5 = E ’ 5 = \$5 , 748.7 ;$$

$$Dn , 6 = D 6 , 6 = E ’ 6 = \$0 \text{.00}$$

Wherein (i) Dn,1, D6,1 and/or E′1 are indicative of inflation corrected value of the D11 and/or the E1 on the Day 6 of the first project, (ii) Dn,2, D6,2 and/or E′2 (e.g., the fourth inflation corrected array 714d) are indicative of inflation corrected value of the D22 and/or the E2 (e.g., the first element) on the Day 6 of the first project, (iii) Dn,3, D6,3 and/or E′3 (the seventh inflation corrected array 716c) are indicative of inflation corrected value of the D33 and/or the E3 (e.g., the second element) on the Day 6 of the first project, (iv) Dn,4, D6,4 and/or E′4 are indicative of inflation corrected value of the D44 and/or the E4 on the Day 6 of the first project, (v) Dn,5, D6,5 and/or E′5 (the eighth inflation corrected array 720a) are indicative of inflation corrected value of the D55 and/or the E5 (e.g., the third element) on the Day 6 of the first project, and (vi) Dn,6, D6,6 and/or E′6 are indicative of inflation corrected value of D66 and/or E6 on the Day 6 of the first project. In some examples, output of the first inflation matrix 710 may be a data structure indicating (i) dates from the start day of the first project to current day (e.g., the final day) of the first project and (ii) updated amounts (e.g., inflation corrected amounts) of the plurality of elements 402 associated with the first project. In some examples, after determining the updated amounts of the plurality of elements 402, project share of each element in the first project may be determined.

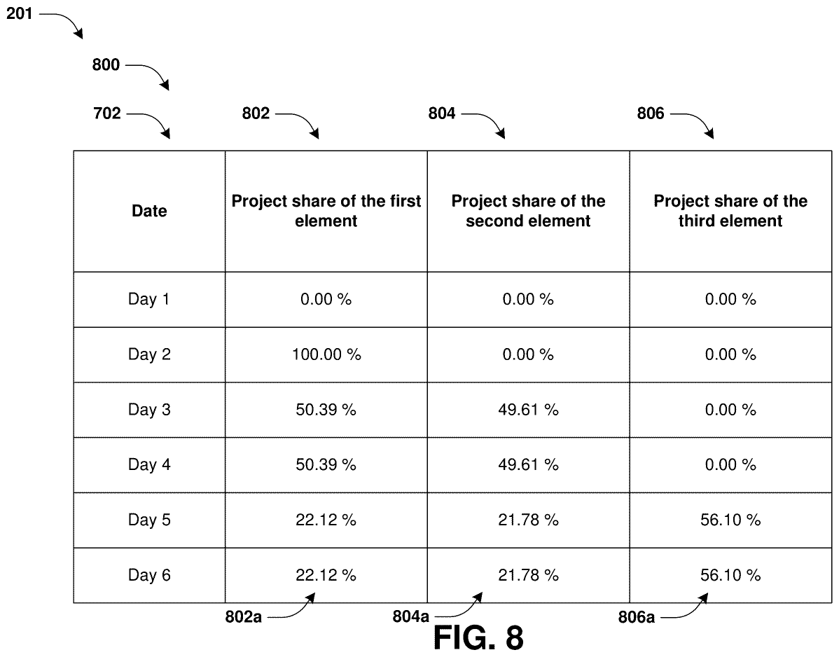

FIG. 8 illustrates a data structure 800 indicating project shares and/or updated project shares of the plurality of elements 402 in the first project at times 702 of the first project, in accordance with some embodiments. The project shares of the plurality of elements may comprise first project shares 802 of the first element in the first project, second project shares 804 of the second element in the first project and/or third project shares 806 of the third element in the first project. In some examples, the inflation-corrected share determination module 216 may determine project share of each element in the first project by dividing updated value of each element by total updated value of all elements in the first project. For example, a project share of the first element on the Day 6 in the first project may be determined by dividing the fourth inflation corrected array 714d (e.g., $2,266.67 which is shown in FIG. 7) by the sixth total updated element expenditure amount 746 (e.g., $10,246.66 which is shown in FIG. 7), wherein the project share of the first element in the first project on the Day 6 may be about 22.12% (e.g., a value 802a). For example, a project share of the second element on the Day 6 in the first project may be determined by dividing the seventh inflation corrected array 716c (e.g., $2,231.30 which is shown in FIG. 7) by the sixth total updated element expenditure amount 746 (e.g., $10,246.66 which is shown in FIG. 7), wherein the project share of the second element in the first project on the Day 6 may be about 21.78% (e.g., a value 804a). For example, a project share of the third element on the Day 6 in the first project may be determined by dividing the eighth inflation corrected array 720a (e.g., $5,748.80 which is shown in FIG. 7) by the sixth total updated element expenditure amount 746 (e.g., $10,246.66 which is shown in FIG. 7), wherein the project share of the third element in the first project on the Day 6 may be about 56.10% (e.g., a value 806a).

FIG. 9 illustrates a data structure 900 indicating element shares of the investors 302 in the plurality of elements 402 at the times 404 of the plurality of expenditures 412 in the first project, in accordance with some embodiments. In some examples, the data structure 900 may comprise element first shares 902 of the investors 302 in the plurality of elements 402, wherein the element first shares 902 of the investors 302 may be shares of the investors 302 in the plurality of elements 402 before transferring (e.g., selling) shares of one or more investors of the investors 302 to one or more other investors and/or before considering the market information 226. In some examples, the data structure 900 indicates element second shares 904 of the investors 302 in the plurality of elements 402, wherein the element second shares 904 of the investors 302 may be shares of the investors 302 in the plurality of elements 402 after the transferring shares of the one or more investors of the investors 302 to the one or more other investors and/or before considering the market information 226. In some examples, each element share of the element shares of the investors 302 in the plurality of elements 402 may change after the transferring. For example, before the transferring, an first element share of the first investor (e.g., Tom) in the first element is about 33.33% (e.g., a value 902a) and a second element share of the first investor in the second element is about 77.78% (e.g., a value 902b). After formation of the first element and the second element, the first investor may transfer a percentage (e.g., 50%) of his ownership share on the Day 4 (e.g., on 4 Feb. 2010) of the first project to a fourth investor (e.g., Sam). Alternatively and/or additionally, upon transferring 50% of the ownership share, (i) the first element share of the first investor in the first element may decrease from about 33.33% to about 16.66% (e.g., a value 904a) and (ii) the second element share of the first investor in the second element may decrease from about 77.78% to about 38.89% (e.g., a value 904b). Alternatively and/or additionally, upon transferring 50% of the ownership share, (i) a first element share of the fourth investor in the first element may increase from about 0% (e.g., a value 902d) to about 16.66% (e.g., a value 904d) and (ii) a second element share of the fourth investor in the second element may increase from about 0% (e.g., a value 902e) to about 38.89% (e.g., a value 904e).

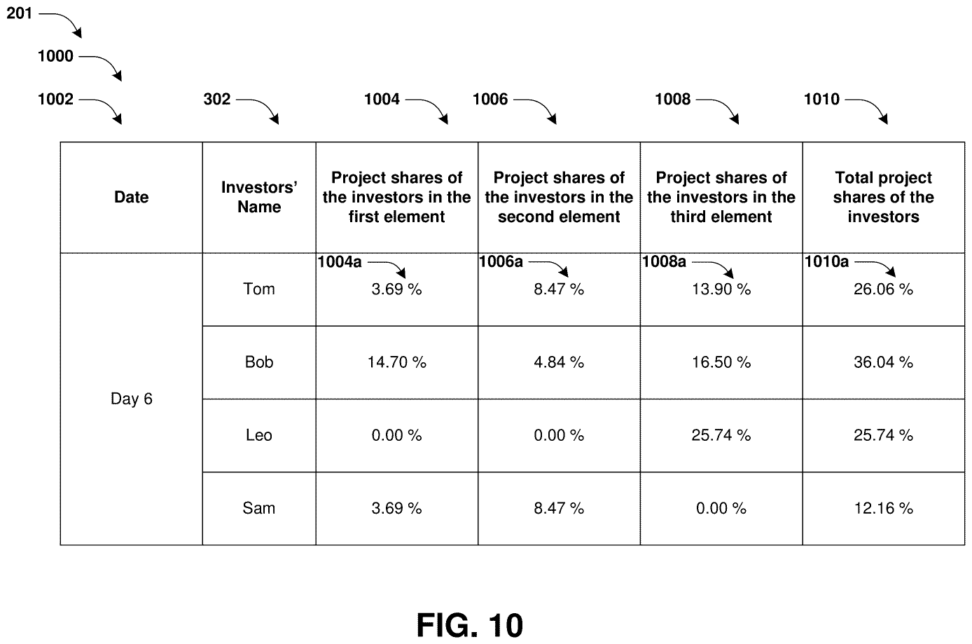

FIG. 10 illustrates a data structure 1000 indicating time(s) 1002 (e.g., current day, the Day 6, etc.) of the first project, the investors 302 of the first project, first project shares 1004 of the investors 302 in the first element (which are determined based upon respective contribution of the investors 302 in the first element, for example), second project shares 1006 of the investors 302 in the second element (which are determined based upon respective contribution of the investors 302 in the second element, for example), third project shares 1008 of the investors in the third element (which are determined based upon respective contribution of the investors 302 in the third element, for example), and/or total project shares 1010 of the investors 302 in the first project, in accordance with some embodiments. In some examples, each investor of the investors 302 may have one or more project shares in one or more elements of the plurality of elements 402 in the first project based upon a respective contribution in each element of the one or more elements. For example, on the Day 6 of the first project, the first investor (e.g., Tom) may have (i) a first project share 1004a (e.g., 3.69%) in the first element based upon 16.66% (e.g., the value 904a) of respective contribution of the first investor in the first element, (ii) a second project share 1006a (e.g., 8.47%) in the second element based upon 38.89% (e.g., the value 904b) of respective contribution of the first investor in the second element and (iii) a third project share 1008a (e.g., 13.90%) in the third element based upon 24.77% (e.g., a value 904c) of respective contribution of the first investor in the third element. In some examples, total project share of each investor in the first project may be determined by aggregating one or more project shares of each investor in the one or more elements of the first project, wherein the one or more project shares may be determined based upon contribution of each investor in the one or more elements of the plurality of elements 402. For example, a total project share 1010a (e.g., 26.06%) of the first investor may be determined by aggregating (e.g., summing) the first project share 1004a (e.g., 3.69%), the second project share 1006a (e.g., 8.47%) and the third project share 1008a (e.g., 13.90%). The first project share 1004a may be determined by multiplying the value 904a by the value 802a. For example, the value 904a may be about 16.66% and the value 802a may be about 22.12%, resulting in the first project share 1004a of 3.69%. The second project share 1006a may be determined by multiplying the value 904b by the value 804a. For example, the value 904b may be about 38.89% and the value 804a may be about 21.78%, resulting in the second project share 1006a of 8.47%. The third project share 1008a may be determined by multiplying the value 904c by the value 806a. For example, the value 904c may be about 24.77% and the value 806a may be about 56.10%, resulting in the third project share 1008a of 13.90%. Although FIG. 10 illustrates determination of project shares of the investors 302 on the Day 6 of the first project, determination of project shares of the investors 302 in other days of the first project are contemplated in the present disclosure.

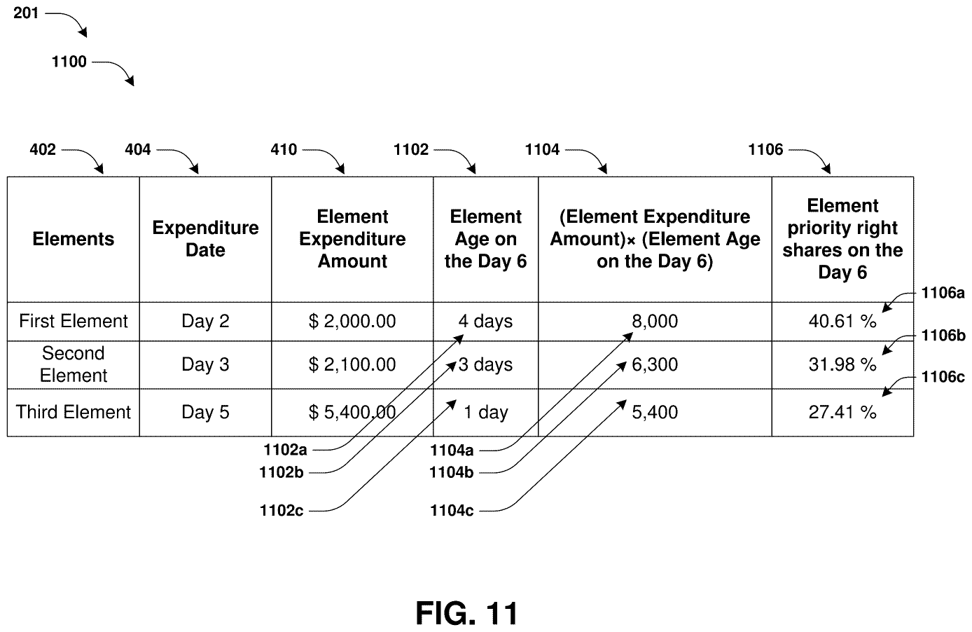

FIG. 11 illustrates a data structure 1100 indicating the plurality of elements 402, the times 404 of the plurality of expenditures 412, the plurality of element expenditure amounts 410, a plurality of element ages 1102 on the Day 6 of the first project, a plurality of values 1104 and/or element priority right shares 1106 on the Day 6 of the first project, in accordance with some embodiments. The plurality of values 1104 may comprise (i) a first value 1104a associated with the first element, (ii) a second value 1104b associated with the second element and (iii) a third value 1104c associated with the third element. In some examples, the plurality of values 1104 may be determined by multiplying the plurality of element ages 1102 by the plurality of element expenditure amounts 410. For example, the first value 1104a (e.g., 8,000) may be determined by multiplying the first element expenditure amount (e.g., $2,000.00) by a first age 1102a (e.g., 4 days) associated with the first element on the Day 6. The second value 1104b (e.g., 6,300) may be determined by multiplying the second element expenditure amount (e.g., $2,100.00) by a second age 1102b (e.g., 3 days) associated with the second element on the Day 6. For example, the third value 1104c (e.g., 5,400) may be determined by multiplying the third element expenditure amount (e.g., $5,400.00) by a third age 1102c (e.g., 1 day) associated with the third element on the Day 6. In some examples, the data structure 1100 may comprise the element priority right shares 1106 associated with the plurality of elements 402 on the Day 6 of the first project. In some examples, the element priority right shares 1106 may comprise (i) a first element priority right share 1106a (e.g., 40.61%) associated with the first element on the Day 6 of the first project, (ii) a second element priority right share 1106b (e.g., 31.98%) associated with the second element on the Day 6 of the first project and (iii) a third element priority right share 1106c (e.g., 27.41%) associated with the third element on the Day 6 of the first project. In some examples, the element priority right shares 1106 may be determined by dividing each value of the plurality of values 1104 by total value (e.g., 19,700) of the plurality of values 1104. For example, the first element priority right share 1106a (e.g., 40.61%) associated with the first element on the Day 6 of the first project may be determined by dividing the first value 1104a (e.g., 8,000) by the total value of the plurality of values 1104. The second element priority right share 1106b (e.g., 31.98%) associated with the second element on the Day 6 of the first project may be determined by dividing the second value 1104b (e.g., 6,300) by the total value of the plurality of values 1104. The third element priority right share 1106c (e.g., 27.41%) associated with the third element on the Day 6 of the first project may be determined by dividing the third value 1104c (e.g., 5,400) by the total value of the plurality of values 1104. The total value of the plurality of values 1104 may be a value (e.g., 19,700) that may be determined by summing (e.g., aggregating) the first value 1104a (e.g., 8,000), the second value 1104b (e.g., 6,300) and the third value 1104c (e.g., 5,400). Although FIG. 11 illustrates determination of the element priority right shares 1106 on the Day 6 of the first project, determination of the element priority right shares 1106 in other days of the first project are contemplated in the present disclosure.

In some examples, an investment application may be provided that allows users to view and/or track investment information and/or initiate transfers. The investment application may be instantiated on one or more client devices as a mobile application (installed on the one or more client devices, for example), a web-based application accessible via a browser of the one or more client devices, and/or a desktop software module (installed on the one or more client devices, for example). The investment application may comprise a computing application executed on one or more servers. One or more operations of the investment application may be performed by the one or more servers, and/or one or more operations of the investment application may be performed by one or more client devices.

In some examples, a set of priority right shares may be allocated (by the investment application, for example), to the investors 302 associated with the plurality of deposits based upon times associated with the plurality of deposits. In some examples, a message indicative of one or more of the set of priority right shares associated with the investors 302 may be provided (by the investment application, for example) to a device (e.g., the client device 1500 shown in FIG. 15A) for display. In some examples, the set of priority right shares may comprise a first priority right share associated with a user of the client device 1500 (e.g., the first investor in the first project). In some examples, the set of priority right shares may be a set of project priority right shares associated with the investors 302. In some examples, the investment application may receive a transfer request to transfer an amount of the first priority right share from the user (e.g., the first investor, Tom) to a second investor (e.g., the fourth investor, Sam). In some examples, in response to the transfer request, the investment application may transfer the amount of the first priority right share from the user to the second investor, wherein the amount of the first priority right share may comprise at least a portion of the first priority right share.

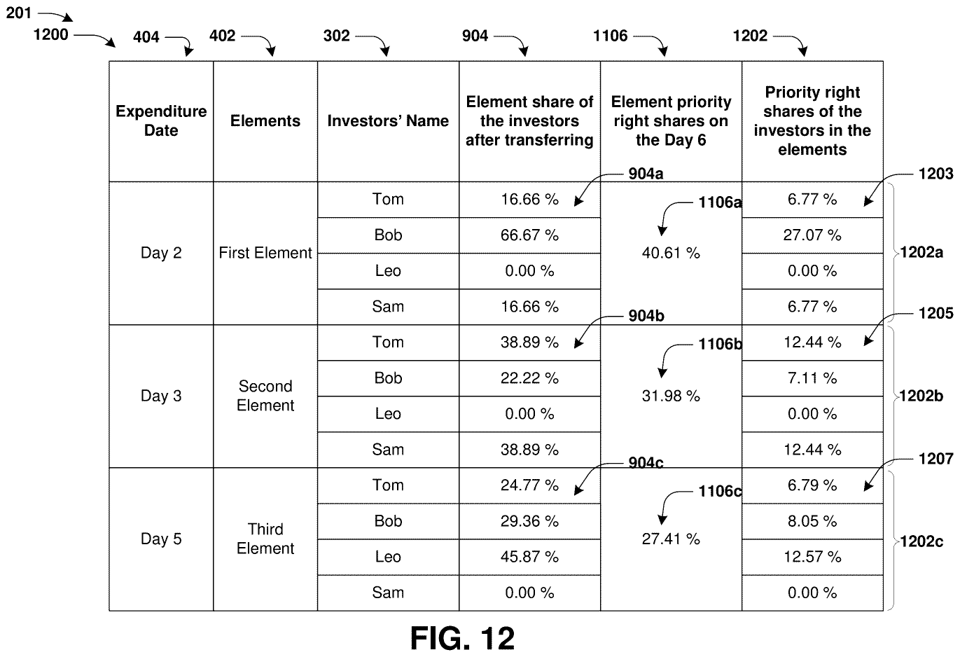

FIG. 12 illustrates a data structure 1200 indicating the times 404 of the plurality of expenditures 412, the plurality of elements 402, the investors 302, the element second shares 904 of the investors 302 in the plurality of elements 402 (e.g., shares of the investors 302 in the plurality of elements 402 after transferring to other investors), the element priority right shares 1106 associated with the plurality of elements 402 on the Day 6 of the first project and priority right shares 1202 of the investors 302 in the plurality of elements 402, in accordance with some embodiments. In some examples, the priority right shares 1202 of the investors 302 in the plurality of elements 402 may comprise first priority right shares 1202a, second priority right shares 1202b and third priority right shares 1202c.

In some examples, the first priority right shares 1202a may be determined based upon respective contribution of the investors 302 in the first element. In some examples, the second priority right shares 1202a may be determined based upon respective contribution of the investors 302 in the second element. In some examples, the third priority right shares 1202a may be determined based upon respective contribution of the investors 302 in the third element. In some examples, each investor of the investors 302 may have one or more priority right shares in the first project based upon respective contribution in the plurality of elements 402. For example, the first investor (e.g., Tom) may have (i) a first priority right share 1203 (e.g., 6.77%) in the first project within the first element, (ii) a second priority right share 1205 (e.g., 12.44%) in the first project within the second element and (iii) a third priority right share 1207 (e.g., 6.79%) in the first project within the third element.

In some examples, the priority right shares 1202 of the investors 302 in the first project may be determined by multiplying the element second shares 904 of the investors 302 in the plurality of elements 402 by the element priority right shares 1106 associated with the plurality of elements 402 on the Day 6 of the first project. For example, the first priority right share 1203 of the first investor may be determined by multiplying the value 904a (e.g., 16.66%) by the first element priority right share 1106a (e.g., 40.61%) associated with the first element on the Day 6 of the first project. The second priority right share 1205 of the first investor may be determined by multiplying the value 904b (e.g., 38.89%) by the second element priority right share 1106b (e.g., 31.98%) associated with the second element on the Day 6 of the first project. The third priority right share 1207 of the first investor may be determined by multiplying the value 904c (e.g., 24.77%) by the third element priority right share 1106c (e.g., 27.41%) associated with the third element on the Day 6 of the first project.

In some examples, total priority right share of each investor of the investors 302 in the first project may be determined by summing (e.g., aggregating) the one or more priority right shares of the investors 302 in the first project. For example, total priority right share (e.g., 25.99%) of the first investor (e.g., Tom) may be determined by summing (e.g., aggregating) (i) the first priority right share 1203 (e.g., 6.77%) in the first project within the first element (ii) the second priority right share 1205 (e.g., 12.44%) in the first project within the second element and (iii) the third priority right share 1207 (e.g., 6.79%) in the first project within the third element. Although FIG. 12 illustrates determination of the priority right shares 1202 of the investors 302 in the first project within the plurality of elements 402 on the Day 6 of the first project, determination of the priority right shares 1202 of the investors 302 in the first project within the plurality of elements 402 in other days of the first project are contemplated in the present disclosure.

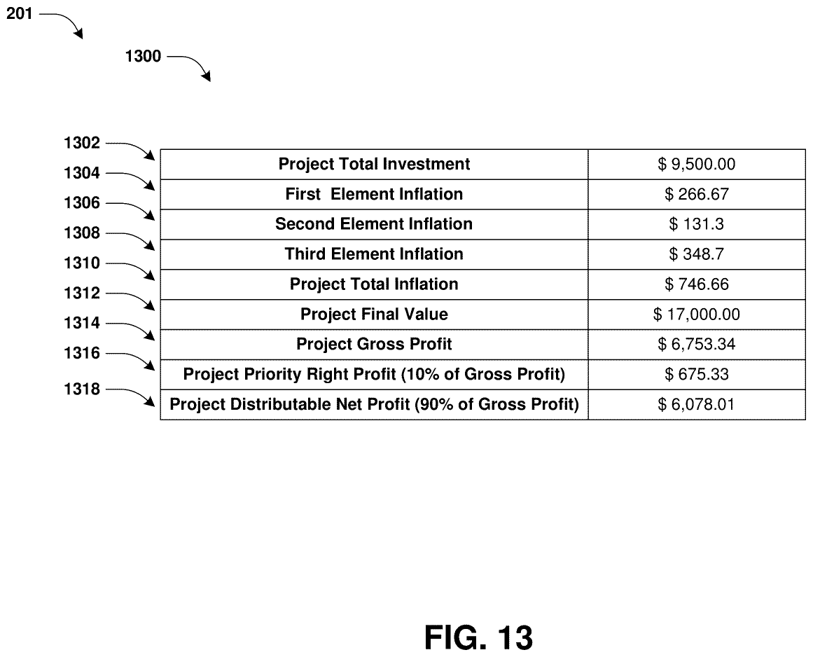

FIG. 13 illustrates a data structure 1300 indicating a total investment 1302 (e.g., $9,500.00) in the first project up to the Day 6 (e.g., the final day, the completion day), a first element inflation 1304 (e.g., $266.67) applied to the first element expenditure amount 410a (e.g., $2,000.00) up to the Day 6, a second element inflation 1306 (e.g., $131.3) applied to the second element expenditure amount 410b (e.g., $2,100.00) up to the Day 6, a third element inflation 1308 (e.g., $347.7) applied to the third element expenditure amount 410c (e.g., $5,400.00) up to the Day 6, a total inflation 1310 (e.g., $746.66) applied to the total investment 1302 (e.g., sum of the first element expenditure amount 410a, the second element expenditure amount 410b, and the third element expenditure amount 410c) in the first project up to the Day 6, a final value 1312 (e.g., the value of the table) of the first project on the Day 6, a gross profit 1314 (e.g., $6,753.34) of the first project earned on the Day 6, a priority right profit 1316 (e.g., $675.33) and/or a distributable net profit 1318 (e.g., $6,078.01) of the first project. In some examples, the priority right profit 1316 of the first project may be a percentage (e.g., 10%) of the gross profit 1314 of the first profit. In some examples, each priority right profit of a project may be a percentage of a gross profit of the project. In some examples, each priority right profit of the project may be determined by a manager of the project and/or may be presented to investors of the project at a time (e.g., a time before starting the project). The investors of the project may agree with the determined priority right profit.

In some examples, the distributable net profit 1318 of the first project may be a second percentage (e.g., 90%) of the gross profit 1314 of the first project. In some examples, each distributable net profit of the project may be a second percentage of the gross profit of the project. In some examples, each distributable net profit of the project may be determined by the manager of the project and/or may be presented to investors of the project at the time (e.g., the time before starting the project). The investors of the project may agree with the determined distributable net profit. In some examples, the total investment 1302 of the first project may be indicative of total expenditure amounts (e.g., sum of the expenditure amounts 408) or total element expenditure amounts (e.g., sum of the plurality of element expenditure amounts 410) of the first project. In some examples, the total inflation 1310 of the first project may be indicative of the sixth total updated element expenditure amount 746 (shown in FIG. 7). In some examples, the total inflation 1310 of the first project may be determined by aggregating (e.g., summing) the first element inflation 1304, the second element inflation 1306 and the third element inflation 1308. In some examples, the final value 1312 of the first project may be the sixth price (e.g., $17,000.00) for the table on the Day 6 (e.g., the sixth day) of the first project (shown in FIG. 5). In some examples, the gross profit 1314 (e.g., $6,753.34) of the first project may be determined (e.g., obtained) by subtracting the final value 1312 from sum of the total investment 1302 and the total inflation 1310. In some examples, the first element inflation 1304 up to the Day 6 may be determined by subtracting the fourth inflation corrected array 714d (e.g., $2,266.67 that is shown in FIG. 7) from the expenditure amount 714 (e.g., $2,000.00). In some examples, the second element inflation 1306 up to the Day 6 may be determined by subtracting the seventh inflation corrected array 716c (e.g., $2,231.30 that is shown in FIG. 7) from the expenditure amount 716 (e.g., $2,100.00). In some examples, the third element inflation 1308 up to the Day 6 may be determined by subtracting the eighth inflation corrected array 720a (e.g., $5,748.80 that is shown in FIG. 7) from the expenditure amount 720 (e.g., $5,400.00). Although FIG. 13 illustrates determination of the total investment 1302, the first element inflation 1304 applied to the first element expenditure amount 410a, the second element inflation 1306 applied to the second element expenditure amount 410b, the third element inflation 1308 applied to the third element expenditure amount 410c, the total inflation 1310 applied to the total investment 1302, the final value 1312, the gross profit 1314, the priority right profit 1316 and/or the distributable net profit 1318 of the first project on the Day 6 of the first project, determination of the total investment 1302, the first element inflation 1304 applied to the first element expenditure amount 410a, the second element inflation 1306 applied to the second element expenditure amount 410b, the third element inflation 1308 applied to the third element expenditure amount 410c, the total inflation 1310 applied to the total investment 1302, the final value 1312, the gross profit 1314, the priority right profit 1316 and/or the distributable net profit 1318 of the first project in other days of the first project are contemplated in the present disclosure.

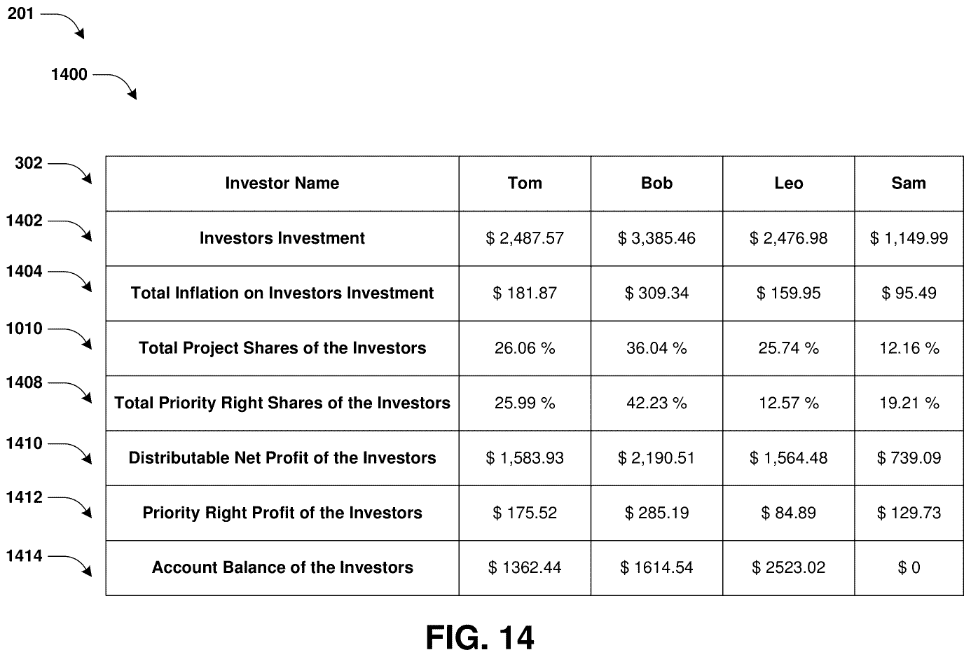

FIG. 14 illustrates a representation 1400 indicating the investors 302, a plurality of investments 1402 associated with the investors 302 up to the Day 6 in the first project, a plurality of total inflations 1404 applied to the plurality of investments 1402 associated with the investors 302, the total project shares 1010 of the investors 302 in the first project, total priority right shares 1408 of the investors 302 in the first project, a plurality of distributable net profits 1410 of the investors 302 in the first project, a plurality of priority right profits 1412 of the investors 302 in the first project and a plurality of account balances 1414 (e.g., a plurality of balances) of the investors 302 in the first project, in accordance with some embodiments. In some examples, the representation 1400 may be an output of the inflation-corrected share determination module 216 on the Day 6 (e.g., the final day) of the first project. In some examples, the plurality of investments 1402 may indicate amount of investment of each investor of the investors 302 in the first project. For example, amount of investment associated with the first investor (e.g., Tom) in the first project is about $2,487.57 which is a portion of the total investment 1302 (e.g., $9,500.00) in the first project. In some examples, the plurality of total inflations 1404 applied to the plurality of investments 1402 may be indicative of inflations applied to the plurality of investments 1402 up to the Day 6 of the project. For example, an inflation applied to the amount of investment of the first investor is about $181.87 that is a portion of the total inflation 1310. In some examples, to determine the plurality of total inflations 1404, each element share of the element second shares 904 of the investors 302 may be multiplied by each element inflation of a plurality of element inflations and the resulting value for each investor may then be aggregated (e.g., summed). For example, the inflation (e.g., $181.87) applied to the amount of investment of the first investor may be determined by aggregating (i) a first inflation applied to a first ownership share of the first investor in the first element, (ii) a second inflation applied to a second ownership share of the first investor in the second element and (iii) a third inflation applied to a third ownership share of the first investor in the third element. The first inflation applied to the first ownership share of the first investor in the first element may be determined by multiplying the first element share (e.g., the value 904a, 16.66%) of the first investor in the first element (after the transferring from the first investor to the fourth investor, for example) by the first element inflation 1304 (e.g., $266.67), resulting in the first inflation of about $44.43. The second inflation applied to the second ownership share of the first investor in the second element may be determined by multiplying the second element share (e.g., the value 904b, 38.89%) of the first investor in the second element share (after the transferring from the first investor to the fourth investor, for example) by the second element inflation 1306 (e.g., $131.3), resulting in the second inflation of about $51.06. The third inflation applied to the third ownership share of the first investor in the third element may be determined by multiplying the third element share (e.g., the value 904c, 24.77%) of the first investor by the third element inflation 1308 (e.g., $348.7), resulting in the third inflation of about $86.37.

In some examples, the total priority right shares 1408 of the investors 302 in the first project may comprise (i) a total priority right share (e.g., 25.99%) of the first investor (e.g., Tom), (ii) a total priority right share (e.g., 42.23%) of the second investor (e.g., Bob), (iii) a total priority right share (e.g., 25.99%) of the third investor (e.g., Leo) and/or (iv) a total priority right share (e.g., 25.99%) of the fourth investor (e.g., Sam). In some examples, the plurality of priority right profits 1412 of the investors 302 in the first project, may comprise (i) a first priority right profit (e.g., $175.52) associated with the first investor, (ii) a second priority right profit (e.g., $285.19) associated with the second investor, (iii) a third priority right profit (e.g., $84.89) associated with the third investor and (iv) a fourth priority right profit (e.g., $129.73) associated with the fourth investor. In some examples, priority right profit of each investor in a project may be determined by multiplying total priority right share of each investor by priority right profit of the project. For example, the first priority right profit (e.g., $175.52) of the first investor may be determined by multiplying the total priority right share (e.g., 25.99%) of the first investor by the priority right profit 1316 (e.g., $675.33) of the first project. The second priority right profit (e.g., $285.19) of the second investor may be determined by multiplying the total priority right share (e.g., 42.23%) of the second investor by the priority right profit 1316 (e.g., $675.33) of the first project. The third priority right profit (e.g., $84.89) of the third investor may be determined by multiplying the total priority right share (e.g., 12.57%) of the third investor by the priority right profit 1316 (e.g., $675.33) of the first project. The fourth priority right profit (e.g., $129.73) of the fourth investor may be determined by multiplying the total priority right share (e.g., 19.21%) of the fourth investor by the priority right profit 1316 (e.g., $675.33) of the first project.

In some examples, the plurality of distributable net profits 1410 of the investors 302 in the first project, may comprise (i) a first distributable net profit (e.g., $1,583.93) associated with the first investor, (ii) a second distributable net profit (e.g., $2,190.51) associated with the second investor, (iii) a third distributable net profit (e.g., $1,564.48) associated with the third investor and (iv) a fourth distributable net profit (e.g., $739.09) associated with the fourth investor. In some examples, distributable net profit of each investor in a project may be determined by multiplying total project share of each investor by distributable net profit of the project. For example, the first distributable net profit (e.g., $1,583.93) associated with the first investor may be determined by multiplying the total project share 1010a (e.g., 26.06%) of the first investor in the first project by the distributable net profit 1318 (e.g., $6,078.01) of the first project. The second distributable net profit (e.g., $2,190.51) associated with the second investor may be determined by multiplying a total project share (e.g., 36.04%) of the second investor in the first project by the distributable net profit 1318 (e.g., $6,078.01) of the first project. The third distributable net profit (e.g., $1,564.48) associated with the third investor may be determined by multiplying a total project share (e.g., 25.74%) of the third investor in the first project by the distributable net profit 1318 (e.g., $6,078.01) of the first project. The fourth distributable net profit (e.g., $739.09) associated with the fourth investor may be determined by multiplying a total project share (e.g., 12.16%) of the fourth investor in the first project by the distributable net profit 1318 (e.g., $6,078.01) of the first project.

In some examples, the plurality of account balances 1414 of the investors 302 in the first project, may comprise (i) a first account balance (e.g., $1362.44) associated with the first investor on the Day 6 of the first project, (ii) a second account balance (e.g., $1614.54) associated with the second investor on the Day 6 of the first project, (iii) a third account balance (e.g., $2523.02) associated with the third investor on the Day 6 of the first project and (iv) a fourth account balance (e.g., $0.00) associated with the fourth investor on the Day 6 of the first project. In some examples, each account balance of the plurality of account balances 1414 associated with each investor of the investors 302, may be determined by subtracting deposits of each investor from investment of each investor in a project. For example, the first account balance (e.g., $1362.44) associated with the first investor may be determined by subtracting deposits (e.g., sum of Deposit 1, Deposit 3 and Deposit 5 of the plurality of deposits 310) of the first investor from the amount of investment associated with the first investor. As shown in FIG. 3, (i) Deposit 1 may be made on the Day 1 of the first project and may be about $1,000.00, (ii) Deposit 3 may be made on the Day 2 of the first project and may be about $2,000.00 and Deposit 5 may be made on the Day 4 of the first project and may be about $2,000.00.

In some examples, account balance information 256 (shown in FIG. 2C) associated with investor accounts (e.g., a first investor account of the first investor, a second investor account of the second investor, a third investor account of the third investor, a fourth investor account of the fourth investor, etc.) of the investors 302 may be determined (by the investment application, for example), wherein the account balance information 256 may be indicative of historical account balances of the investor accounts. In some examples, the account balance information 256 may be determined using an account balance determination module 254 (shown in FIG. 2C). FIG. 2C illustrates determination of the account balance information 256, in accordance with some embodiments. In some examples, the deposit information 206 and/or the expenditure information 210 may be input information of the account balance determination module 254. In some examples, the account balance information 256 may be output information of the account balance determination module 254. In some examples, the account balance information 256 may comprise an account balance data structure comprising the plurality of account balances 1414 associated with the investors 302. In some examples, the element information 230 comprises the account balance data structure, the data structure 300 and/or the data structure 400. In some examples, interest share information 260 (shown in FIG. 2C) associated with the investor accounts of the investors 302 may be determined (by the investment application, for example), wherein the account balance information 256 may be indicative of historical account balances of the investor accounts. In some examples, the interest share information 260 may be determined using an interest share information module 258 (shown in FIG. 2C). FIG. 2C illustrates determination of the interest share information 260, in accordance with some embodiments. In some examples, the account balance information 256 may be input information of the interest share information module 258. In some examples, the interest share information 260 may be output information of the interest share information module 258. In some examples, the interest share information 260 may comprise an interest share data structure comprising a plurality of interest shares associated with the investors 302. In some examples, the interest share information 260 comprises the interest share data structure. In some examples, the plurality of interest shares (e.g., interest, bank interest) may be allocated (by the investment application) to the investor accounts.

In some examples, the inflation-corrected shares 218 may comprise a first inflation-corrected share associated with the first investor, a second inflation-corrected share associated with the second investor, a third inflation-corrected share associated with the third investor, a fourth inflation-corrected share associated with the fourth investor. In some examples, a first message indicative of the first inflation-corrected share may be provided (by the investment application, for example) to a first device associated with the first investor. In some examples, a second message indicative of the second inflation-corrected share may be provided to a second device associated with the second investor. In some examples, a third message indicative of the third inflation-corrected share may be provided to a third device associated with the third investor. In some examples, a fourth message indicative of the fourth inflation-corrected share may be provided to a fourth device associated with the second fourth.

In some examples, the first investor (e.g., Tom) may be associated with a user (e.g., a first user) of a first client device 1500 (shown in FIG. 15A). In some examples, the first investor may (i) join one or more projects such as the first project, (ii) make deposits for the first project, and/or (iii) view account information associated with the first investor and/or the first project using an investor interface displayed via the first client device 1500. FIG. 15A illustrates the first client device 1500 displaying a project selection interface 1504 of the investor interface, in accordance with some embodiments. The project selection interface 1504 may comprise a selectable input 1506 for selecting the first project (e.g., the TB1 construction project), a selectable input 1508 for selecting a second project, a selectable input 1510 for selecting a third project, a selectable input 1215 for selecting a fourth project, a selectable input 1514 for selecting a fifth project, a selectable input 1516 for selecting a sixth project and/or a time indicator 1518 indicating a time (e.g., a start time, the Day 1 of the first project, 1 Feb. 2010) when the first investor may join the first project. Although FIG. 15A illustrates six selectable inputs and/or projects, any number of selectable inputs and/or projects are contemplated in the present disclosure.

In some examples, in response to a selection of the selectable input 1506 associated with the first project, the investor interface may display a project information interface 1530 (shown in FIG. 15B). FIG. 15B illustrates the first client device 1500 displaying the project information interface 1530, in accordance with some embodiments. The project information interface 1530 may be indicative of a start date 1530a (e.g., the Day 1, 1 Feb. 2010) associated with the first project, an estimated completion date 1530b (e.g., the Day 6, 6 Feb. 2010) associated with the first project, a needed total budget 1530c (e.g., an estimated budget, $10,000.00) associated with the first project, raised funds 1530d (e.g., $0.00) associated with the first project at a time (shown in the time indicator 1518, for example) at which the first investor may join the first project, an interest rate 1530e (e.g., a bank interest rate, 10% per year) considered for balances (at a time at which the balances are unused in the first project, for example) of the investors 302 associated with the first project, priority right percentage 1530f (e.g., 10% of the gross profit 1314 of the first project) associated with the first project and/or estimated value 1530g (e.g., estimated price of the table on the Day 6, $17,000.00) associated with the first project. The project selection interface 1530 may comprise a selectable input 1532 for joining the first project and/or investing in the first project. In some examples, in response to a selection of the selectable input 1532 associated with the first project, the investor interface may display a profile interface 1550 (shown in FIG. 15C). FIG. 15C illustrates the first client device 1500 displaying the profile interface 1550, in accordance with some embodiments. The profile interface 1550 may be indicative of information (e.g., name, address, photo, email and/or etc.) about the user (e.g., the first investor, Tom). The profile interface 1550 may comprise a deposit selectable input 1552 for investing (e.g., making a deposit) in the first project. In response to a selection of the deposit selectable input 1552 associated with the first project, the investor interface may display an investment interface 1551 (shown in FIG. 15D) associated with the user (e.g., the first investor). FIG. 15D illustrates the first client device 1500 displaying the investment interface 1551, in accordance with some embodiments. The investment interface 1551 may comprise a fund information menu 1560, elements information menu 1562, an inflation index information menu 1564 and/or a general information menu 1566.

For example, the fund information menu 1560 is indicative of deposit amounts (e.g., the deposit amounts 306 shown in FIG. 3) of one or more deposits (e.g., the plurality of deposits 310 shown in FIG. 3), expenditure amounts (e.g., the expenditure amounts 410 shown in FIG. 4) of one or more expenditures (e.g., the plurality of expenditures 412) and/or element expenditure amounts (e.g., the plurality of element expenditure amounts 410) of one or more element expenditures at a first time (e.g., the time shown in the time indicator 1518, the start day of the first project, the Day 1, 1 Feb. 2010) in a project. The fund information menu 1560 may comprise an indication 1568 of a project account balance (e.g., $3,000.00) at the first time of the project. The fund information menu 1560 may comprise an indication 1570 of a user account balance (e.g., $1,000.00) associated with the user (e.g., the first user, the first investor) at the first time in the project. The fund information menu 1560 may comprise an indication 1572 of a user share (e.g., 33.33%) of the user in next element (e.g., the first element of the first project) and/or at the first time of the project. In an example, at the first time of the project, the indication 1572 may be determined by dividing a value of the indication 1570 by a value of the indication 1568. The fund information menu 1560 may comprise an indication 1574 of an interest (e.g., a bank interest) for user account balance (at a time at which the user account balance is unused in the first project, for example) associated with the user. A value (e.g., $0.00) of the indication 1574 may represent that the user account balance may have no interest at the first time of the project. In some examples, the fund information menu 1560 may comprise a selectable input 1576 for performing a deposit, a selectable input 1580 for making a withdrawal and/or a selectable input 1578 for accessing supplemental information associated with fund information of the project.

In some examples, in response to a selection of the selectable input 1578 associated with the fund information menu 1560 of the project, the investor interface may display an interface 1551a (shown in FIG. 15E). FIG. 15E illustrates the first client device 1500 displaying the interface 1551a, in accordance with some embodiments. The interface 1551a may comprise a fund information details submenu 1578a (e.g., a submenu of the fund information menu 1560) corresponding to the fund information at the first time of the project. The fund information details submenu 1578a may be indicative of the supplemental information associated with the fund information of the project. The supplemental information associated with the fund information may comprise one or more deposits associated with the user (e.g., the first investor, Tom) and/or other users (e.g., other investors) in the project, date (e.g., the first time, the Day 1, 1 Feb. 2010) of the one or more deposits, user account balance associated with the user and/or project account balance associated with the first project. The fund information details submenu 1578a may comprise an indication 1578b of the user account balance (e.g., $1,000.00) associated with the first user, the project account balance (e.g., $1,000.00) associated with the first project, a value (e.g., $1,000.00) of a deposit (e.g., a first deposit) associated with the user at the first time of the project and/or a value (e.g., $2,000.00) of deposit(s) associated with the other users (e.g., the second investor, Bob) at the first time of the project.

For example, the elements information menu 1562 is indicative of information of one or more elements associated with one or more expenditures made at the first time in the first project. Upon not making an expenditure and/or not forming (e.g., creating) an element at the first time in the first project, the element information menu 1562 may have no information.

For example, the inflation index information menu 1564 is indicative of prices (e.g., the prices 504 shown in FIG. 5) of each inflation index associated with one or more inflation indexes (e.g., the plurality of inflation indexes 510 shown in FIG. 5) associated with the first project at a first time (e.g., the time show in the time indicator 1518, the start day of the first project, the Day 1, 1 Feb. 2010) and/or at another time (e.g., one day before the first time, 31 Jan. 2010). The inflation index information menu 1564 may comprise an indication 1564a of a description (e.g., price of a new table) of an inflation index on the day before the first time, price (e.g., $15,000.00) of the inflation index on the day before the first time and/or date (e.g., the day before the first time). The inflation index information menu 1564 may comprise an indication 1564b of a description (e.g., price of a new table) of an inflation index at the first time, price (e.g., $15,000.00) of the inflation index at the first time and/or date (e.g., the first time). The price (e.g., a value, $15,000.00) in the indication 1564a may represent that price of inflation index (e.g., price of a new table) is about $15,000.00 on the day before the first time of the first project. The price (e.g., a value, $15,000.00) in the indication 1564b may represent that price of inflation index (e.g., price of a new table) is about $15,000.00 at the first time of the project.

For example, the general information menu 1566 is indicative of investment values associated with the user and the first project at the first time, inflations on the investment values at the first time, a share of the user in the first project at the first time and/or number of elements associated with the user at the first time. The general information menu 1566 may comprise an indication 1582 of a project investment value (e.g., $0.00) at the first time of the project. The fund information menu 1566 may comprise an indication 1584 of an inflation (e.g., $0.00) on the project investment value at the first time of the project. The general information menu 1566 may comprise an indication 1586 of a user investment value (e.g., $0.00) for the user at the first time of the project. The general information menu 1566 may comprise an indication 1588 of an inflation (e.g., $0.00) on the user investment value for the user at the first time of the project. The general information menu 1566 may comprise an indication 1590 of a user share (e.g., 0.00%) in the project, for the user at the first time. The general information menu 1566 may comprise an indication 1592 of a user priority right share (e.g., $0.00) in the project, for the user at the first time. The general information menu 1566 may comprise an indication 1594 of number (e.g., zero) of elements (in which the user is involved, for example) for the user at the first time of the project. In some examples, the user share may be a total share associated with the user in the project. In some examples, the user priority right share may be a total priority right share associated with the user in the project. In some examples, the general information menu 1566 may comprise a selectable input 1596 for selling an ownership share, a selectable input 1599 for buying an ownership share and/or a selectable input 1598 for accessing supplemental information associated with general information of the project.

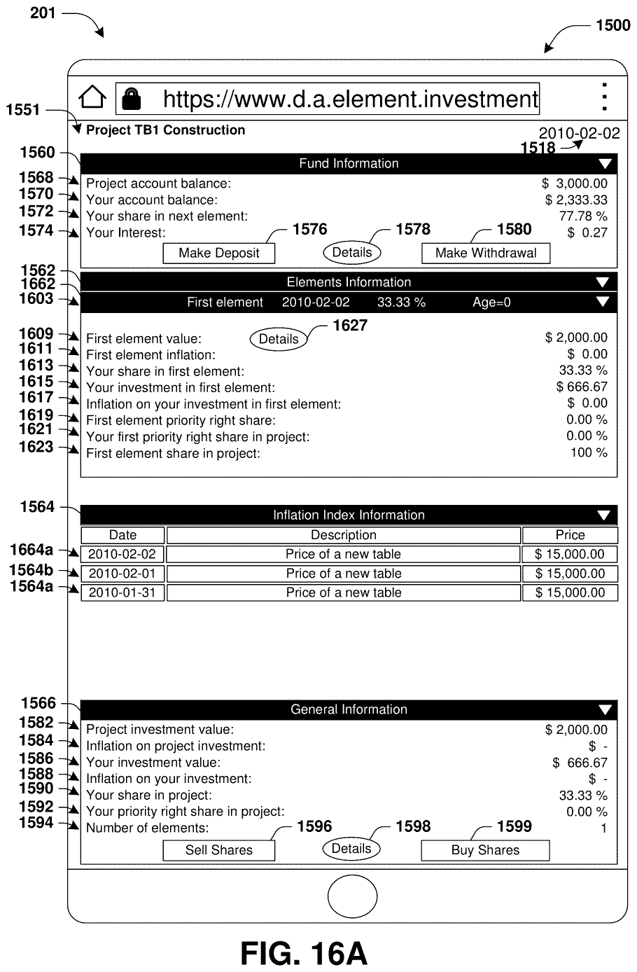

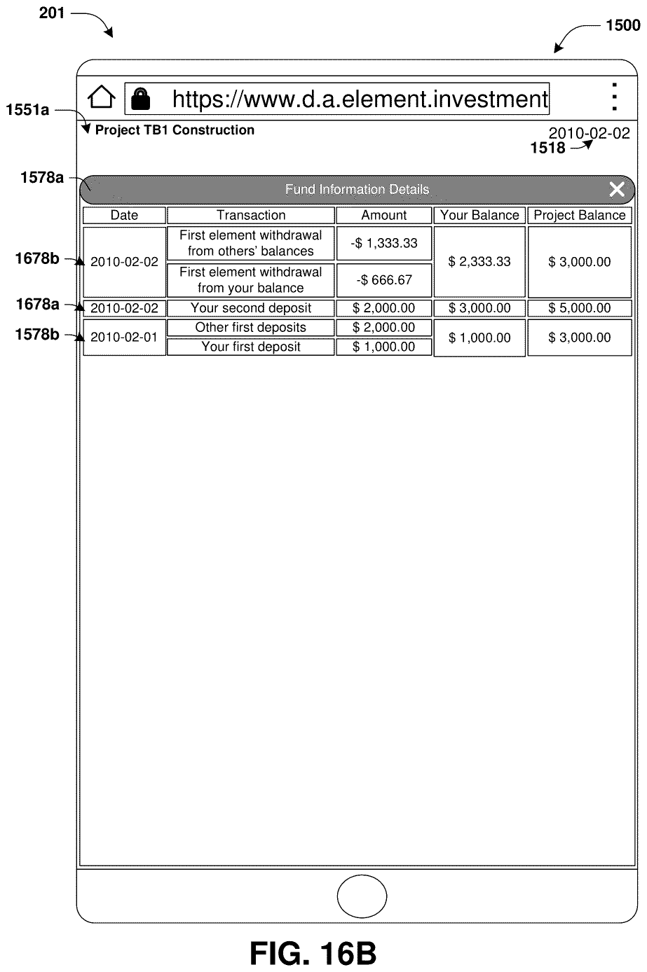

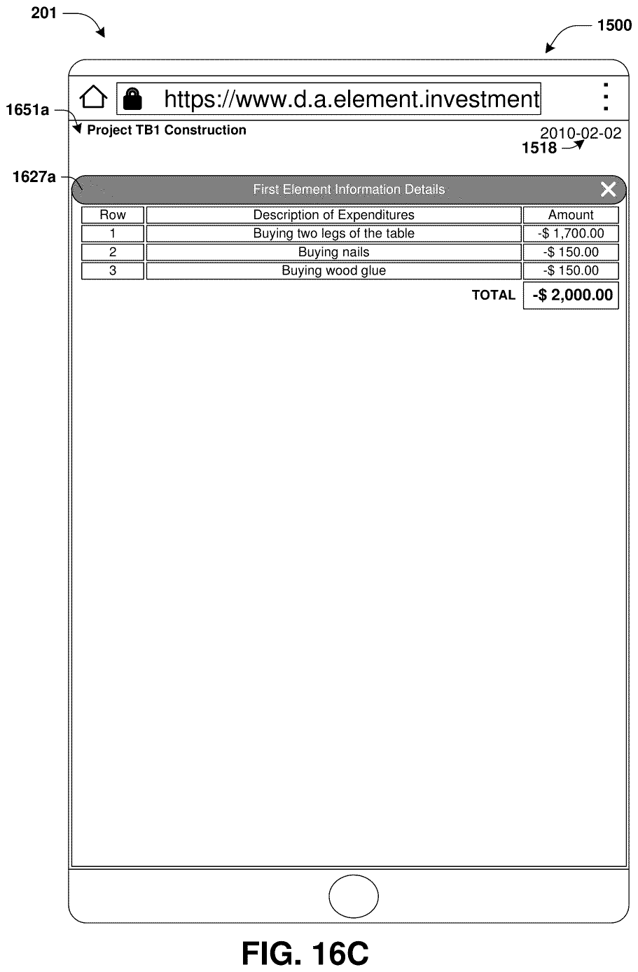

FIG. 16A illustrates the first client device 1500 displaying the investment interface 1551 at a second time (e.g., the Day 2, 2 Feb. 2010) after the first time (e.g., the Day 1, 1 Feb. 2010), in accordance with some embodiments. The fund information menu 1560 of the investment interface 1551 may display updated information. For example, the fund information menu 1560 may be indicative of an updated value of the project account balance (e.g., $3,000.00), an updated value of the user account balance (e.g., $2,333.33), an updated value of the user share (e.g., 77.78%) of the user in next element (e.g., the second element of the first project) and/or an updated value of the interest (e.g., $0.27) for the user account balance at the second time. The time indicator 1518 may indicate the second time of the project. FIG. 16B illustrates the first client device 1500 displaying the interface 1551a at the second time of the project, in accordance with some embodiments. The fund information details submenu 1578a may display updated information corresponding to the fund information at the second time of the project. The fund information details submenu 1578a may comprise an indication 1678a of an updated value of the user account balance (e.g., $3,000.00) associated with the first user, an updated value of the project account balance (e.g., $5,000.00) associated with the project at the second time (before making expenditures and/or formation of the first element, for example), a value (e.g., $2,000.00) of a deposit (e.g., a second deposit) associated with the user at the second time of the project. The fund information details submenu 1578a may comprise an indication 1678b of an amount (e.g., −$666.67) of first withdrawal (associated with the first element expenditure(s) of the first project, for example) from the user account balance, an amount (e.g., −$1,333.33) of first withdrawal from other users account balances (associated with the first element expenditure(s) of the first project, for example), an updated value of the user account balance (e.g., $2,333.33) associated with the first user, an updated value of the project account balance (e.g., $3,000.00) associated with the project at the second time (after making expenditures and/or formation of the first element, for example). In some examples, when each investor (e.g., the first investor) makes a deposit to increase the user account balance on a specific time (e.g., the second time of the first project), the updated user account balance may be considered and/or used for generating next elements. For example, the second deposit (which is simultaneous with formation of the first element, for example) of the user may be utilized in generating the next element (e.g., the second element of the first project). The amount (e.g., −$666.67) of withdrawal from the user account balance associated with the first element may be a first investment of the user and the amount (e.g., −$1,333.33) of withdrawal from other users account balances associated with the first element may be first investments of the other users.

The elements information menu 1562 of the investment interface 1551 may display updated information. The elements information menu 1562 may comprise a first element information submenu 1662. The first element information submenu 1662 may comprise a submenu bar 1603, wherein the submenu bar 1603 may be indicative of name of element (e.g., first element), time of formation of the element (e.g., the second time, the Day 2, 2 Feb. 2010), a first share (e.g., 33.33%) of the user in the project (e.g., the first project) based upon having a share in the first element, and/or age (e.g., zero days) of the first element. The first element information submenu 1662 may comprise an indication 1609 of a first element value (e.g., $2,000.00) at the second time of the project. The first element information submenu 1662 may comprise an indication 1611 of an inflation (e.g., $0.00) on the first element at the second time of the project. The first element information submenu 1662 may comprise an indication 1613 of a user share (e.g., 33.33%) of the user (e.g., the first investor) in the first element at the second time of the project. The first element information submenu 1662 may comprise an indication 1615 of a user investment value (e.g., $666.67) of the user (e.g., the first investor) in the first element at the second time of the project. The first element information submenu 1662 may comprise an indication 1617 of an inflation (e.g., $0.00) on the user investment value (e.g., $666.67) of the user in the first element at the second time of the project. The first element information submenu 1662 may comprise an indication 1619 of a priority right share (e.g., 0.00%) associated with the first element in the project at the second time of the project. The first element information submenu 1662 may comprise an indication 1621 of a first priority right share (e.g., 0.00%) of the user in the project (based upon having a share in the first element, for example) at the second time of the project. The first element information submenu 1662 may comprise an indication 1623 of a share (e.g., 100%) of the first element in the project at the second time of the project.

In some examples, the elements information menu 1562 may comprise a selectable input 1627 for accessing supplemental information associated with elements information of the project. In some examples, in response to a selection of the selectable input 1627 associated with the elements information menu 1562 of the project, the investor interface may display an interface 1651a (shown in FIG. 16C). FIG. 16C illustrates the first client device 1500 displaying the interface 1651a, in accordance with some embodiments. The interface 1651a may comprise a first element information details submenu 1627a (e.g., a submenu of the elements information menu 1562) corresponding to the element information at the second time of the project. The first element information details submenu 1627a may be indicative of the supplemental information associated with the element information of the project. The supplemental information associated with the elements information may comprise one or more expenditures (e.g., one or more purchases, the expenditure 1, the expenditure 2 and/or the expenditure 3 shown in FIG. 4) associated with the first element, wherein the one or more expenditures may be made at the second time of the project.

The inflation index information menu 1564 of the investment interface 1551 may display updated information. For example, the inflation index information menu 1564 may comprise an indication 1664a of a description (e.g., price of a new table) of an inflation index at the second time, price (e.g., $15,000.00) of the inflation index at the second time and/or date (e.g., the second time).

The general information menu 1566 of the investment interface 1551 may display updated information. For example, the general information menu 1566 may be indicative of an updated value of the project investment value (e.g., $2,000) at the second time of the project, an updated value of the inflation (e.g., $0.00) on the project investment value at the second time of the project, an updated value of the user investment value (e.g., $666.67) for the user at the second time of the project, an updated value of the inflation (e.g., $0.00) on the user investment value for the user at the second time of the project, an updated value of the user share (e.g., 33.33%) in the project, an updated value of user priority right share (e.g., 0.00%) in the project and/or an updated value of number of elements (e.g., one element) for the user at the second time of the project.

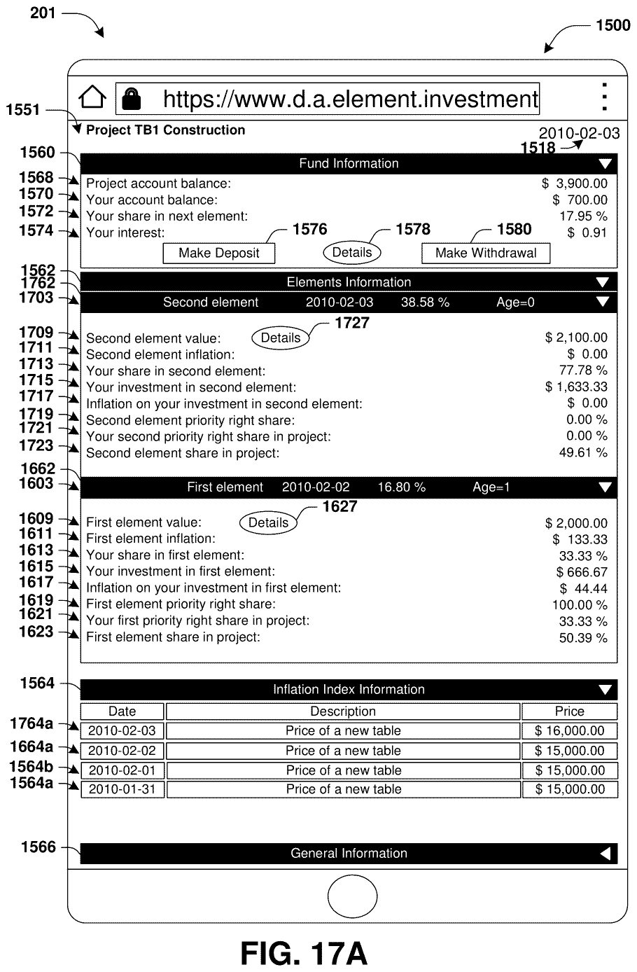

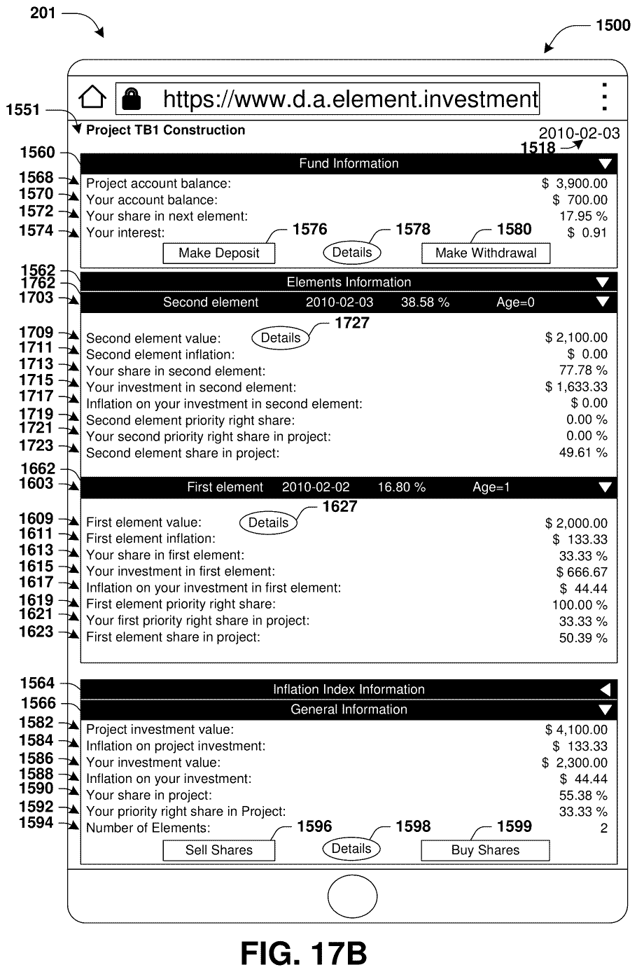

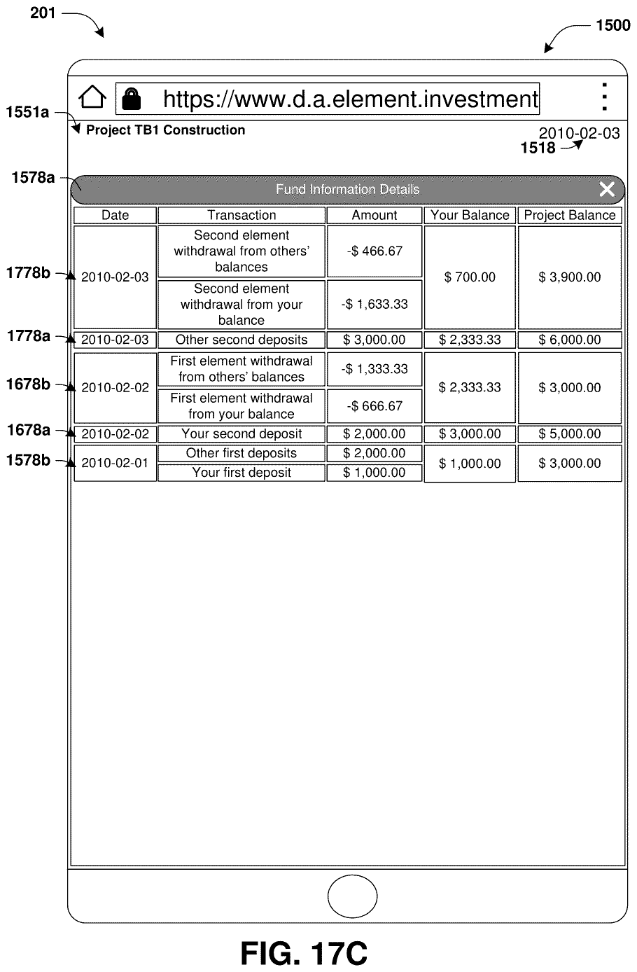

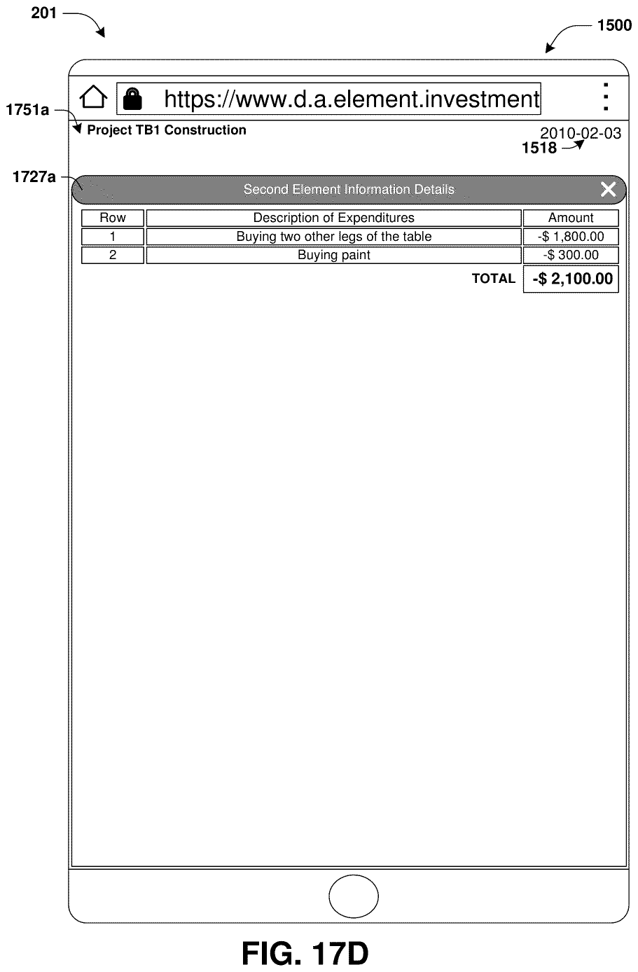

FIGS. 17A-17B illustrate the first client device 1500 displaying the investment interface 1551 at a third time (e.g., the Day 3, 3 Feb. 2010) after the second time (e.g., the Day 2, 2 Feb. 2010), in accordance with some embodiments. The fund information menu 1560 of the investment interface 1551 may display updated information at the third time of the project. For example, the fund information menu 1560 may be indicative of a second updated value of the project account balance (e.g., $3,900.00), a second updated value of the user account balance (e.g., $700.00), a second updated value of user share (e.g., 17.95%) of the user in next element (e.g., the third element of the first project) and/or a second updated value of the interest (e.g., $0.91) for the user account balance at the third time. The time indicator 1518 may indicate the third time of the project. FIG. 17C illustrates the first client device 1500 displaying the interface 1551a at the third time of the project, in accordance with some embodiments. The fund information details submenu 1578a may display updated information corresponding to the fund information at the third time of the project. The fund information details submenu 1578a may comprise an indication 1778a of the user account balance (e.g., $2,333.33) associated with the first user, the project account balance (e.g., $6,000.00) associated with the first project, and/or a value (e.g., $3,000.00) of a second deposit(s) associated with the other users (e.g., the second investor, Bob) at the third time of the project. The fund information details submenu 1578a may comprise an indication 1778b of an amount (e.g., −$1,633.33) of second withdrawal (associated with the second element expenditure(s) of the first project, for example) from the user account balance, an amount (e.g., −$466.67) of second withdrawal from other users account balances (associated with the second element expenditure(s) of the first project, for example), an updated value of the user account balance (e.g., $700.00) associated with the first user, an updated value of the project account balance (e.g., $3,900.00) associated with the project at the third time (after making expenditures and/or formation of the second element, for example).

The elements information menu 1562 of the investment interface 1551 may display updated information corresponding to the elements information at the third time of the project. The elements information menu 1562 may comprise a second element information submenu 1762. The second element information submenu 1762 may comprise a submenu bar 1703, wherein the submenu bar 1703 may be indicative of name of element (e.g., second element), time of formation of the element (e.g., the third time, the Day 3, 3 Feb. 2010), a second share (e.g., 38.58%) of the user in the project (e.g., the first project) based upon having a share in the second element, and/or age (e.g., zero days) of the second element. The second element information submenu 1762 may comprise an indication 1709 of a second element value (e.g., $2,100.00) at the third time of the project. The second element information submenu 1762 may comprise an indication 1711 of an inflation (e.g., $0.00) on the second element at the third time of the project. The second element information submenu 1762 may comprise an indication 1713 of a user share (e.g., 77.78%) of the user (e.g., the first investor) in the second element at the third time of the project. The second element information submenu 1762 may comprise an indication 1715 of a user investment value (e.g., $1,633.33) of the user (e.g., the first investor) in the second element at the third time of the project. The second element information submenu 1762 may comprise an indication 1717 of an inflation (e.g., $0.00) on the user investment value (e.g., $1,633.33) of the user in the second element at the third time of the project. The second element information submenu 1762 may comprise an indication 1719 of a priority right share (e.g., 0.00%) associated with the second element in the project at the third time of the project. The second element information submenu 1762 may comprise an indication 1721 of a second priority right share (e.g., 0.00%) of the user in the project (based upon having a share in the second element, for example) at the third time of the project. The second element information submenu 1762 may comprise an indication 1723 of a share (e.g., 49.61%) of the second element in the project at the third time of the project.

The first element information submenu 1662 of the elements information menu 1562 of the investment interface 1551 may display updated information corresponding to the first element information at the third time of the project. For example, the first element information submenu 1662 may be indicative of (i) the first element value (e.g., $2,000.00), (ii) an updated value of the inflation (e.g., $133.33) on the first element at the third time of the project, (iii) the user share (e.g., 33.33%) of the user (e.g., the first investor) in the first element at the third time of the project, (iv) the user investment value (e.g., $666.67) of the user (e.g., the first investor) in the first element at the third time of the project, (v) an updated value of the inflation (e.g., $44.44) on the user investment value (e.g., $666.67) of the user in the first element at the third time of the project, (vi) an updated value of the priority right share (e.g., 100%) associated with the first element in the project at the third time of the project, (vii) an updated value of the first priority right share (e.g., 33.33%) of the user in the project (based upon having the share in the first element, for example) at the third time of the project, and/or (viii) an updated value of the share (e.g., 50.39%) of the first element in the project at the third time of the project. The submenu bar 1603 may be indicative of (i) the name of the element (e.g., first element), (ii) the time of formation of the element (e.g., the second time, the Day 2, 2 Feb. 2010), (iii) an updated value of the first share (e.g., 16.80%) of the user in the project based upon having a share in the first element, and/or (iv) an updated value of the age (e.g., one day) of the first element at the third time of the project.

In some examples, the elements information menu 1562 may comprise a selectable input 1727 for accessing supplemental information associated with elements information of the project. In some examples, in response to a selection of the selectable input 1727 associated with the elements information menu 1562 of the project, the investor interface may display an interface 1751a (shown in FIG. 17D). FIG. 17D illustrates the first client device 1500 displaying the interface 1751a. The interface 1751a may comprise a second element information details submenu 1727a (e.g., a submenu of the elements information menu 1562) corresponding to the element information at the third time of the project, in accordance with some embodiments. The second element information details submenu 1727a may be indicative of the supplemental information associated with the element information of the project. The supplemental information associated with the elements information may comprise one or more expenditures (e.g., one or more purchases, the expenditure 4, and/or the expenditure 5 shown in FIG. 4) associated with the second element, wherein the one or more expenditures may be made at the third time of the project.

The inflation index information menu 1564 of the investment interface 1551 may display updated information corresponding to the inflation index information at the third time of the project. For example, the inflation index information menu 1564 may comprise an indication 1764a (shown in FIG. 17A) of a description (e.g., price of a new table) of an inflation index at the third time, price (e.g., $16,000.00) of the inflation index at the third time and/or date (e.g., the third time).

As shown in FIG. 17B, the general information menu 1566 of the investment interface 1551 may display updated information corresponding to the general information at the third time of the project. For example, the general information menu 1566 may be indicative of an updated value of the project investment value (e.g., $4,100.00) at the third time of the project, an updated value of the inflation (e.g., $133.33) on the project investment value at the third time of the project, an updated value of the user investment value (e.g., $2,300.00) for the user at the third time of the project, an updated value of the inflation (e.g., $44.44) on the user investment value for the user at the third time of the project, an updated value of the user share (e.g., 55.38%) in the project, an updated value of user priority right share (e.g., 33.33%) in the project and/or an updated value of number of elements (e.g., two elements) for the user at the third time of the project.

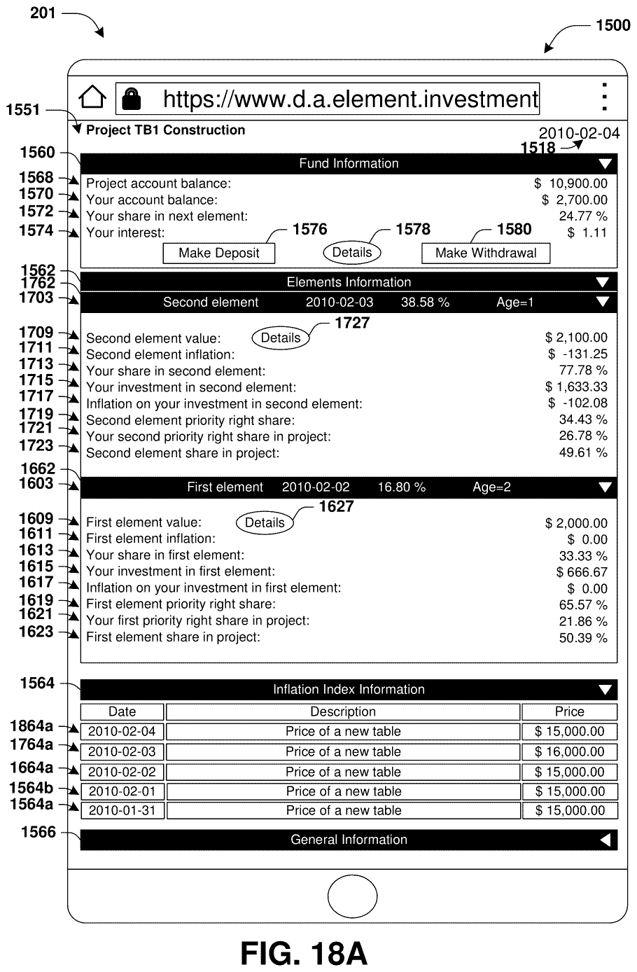

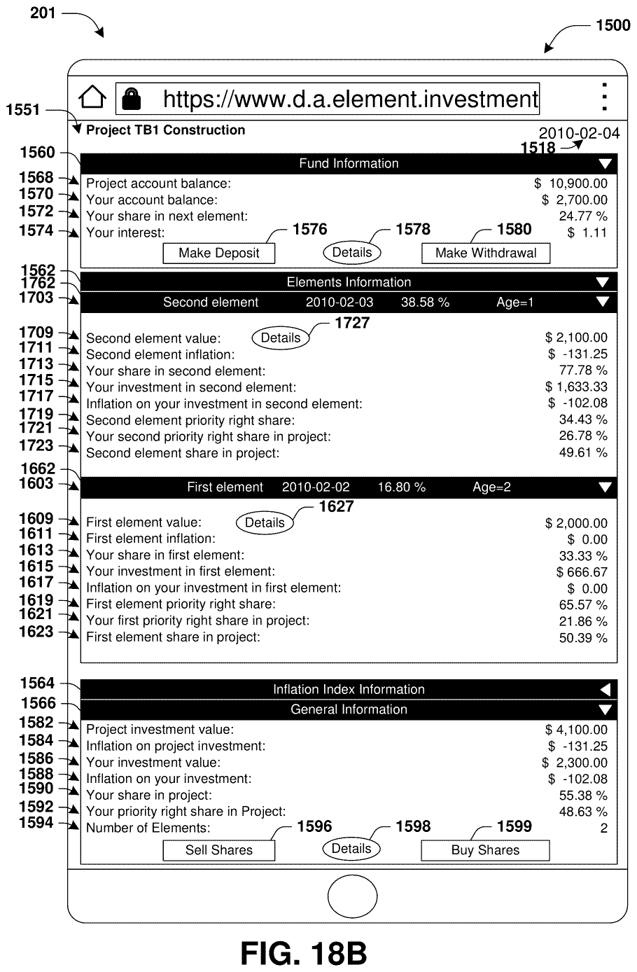

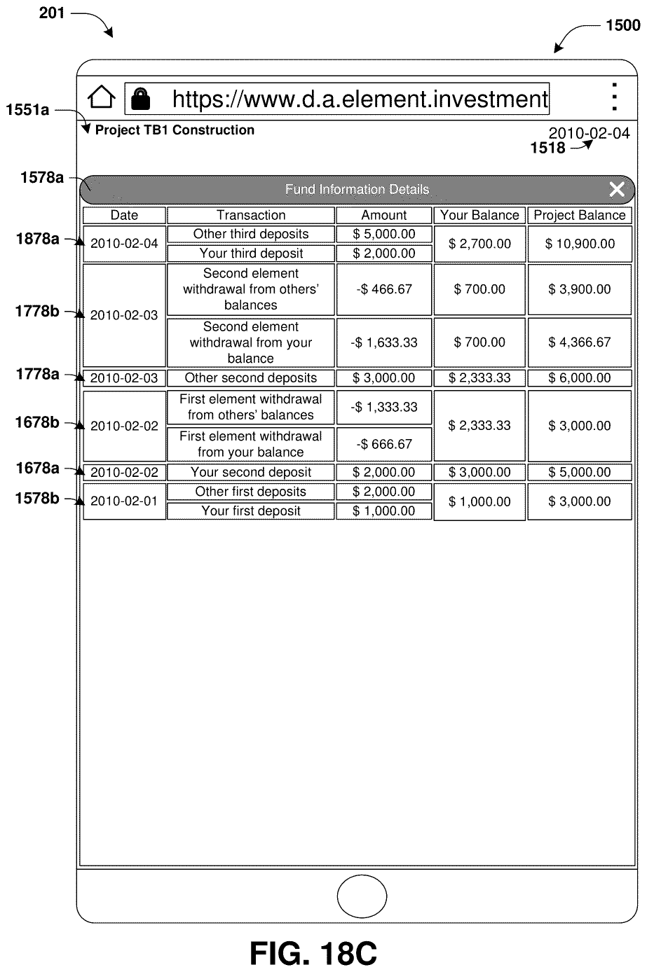

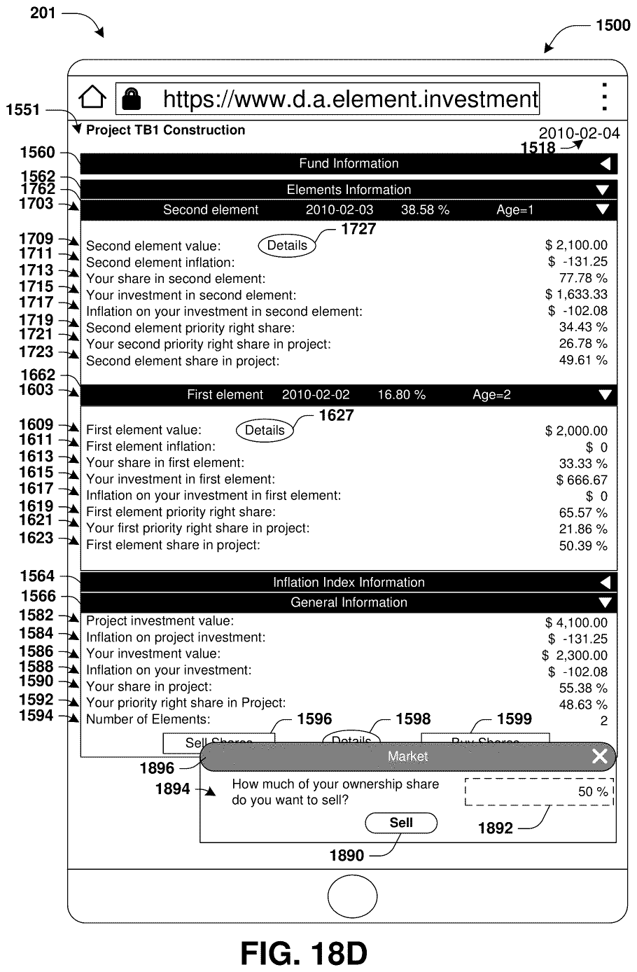

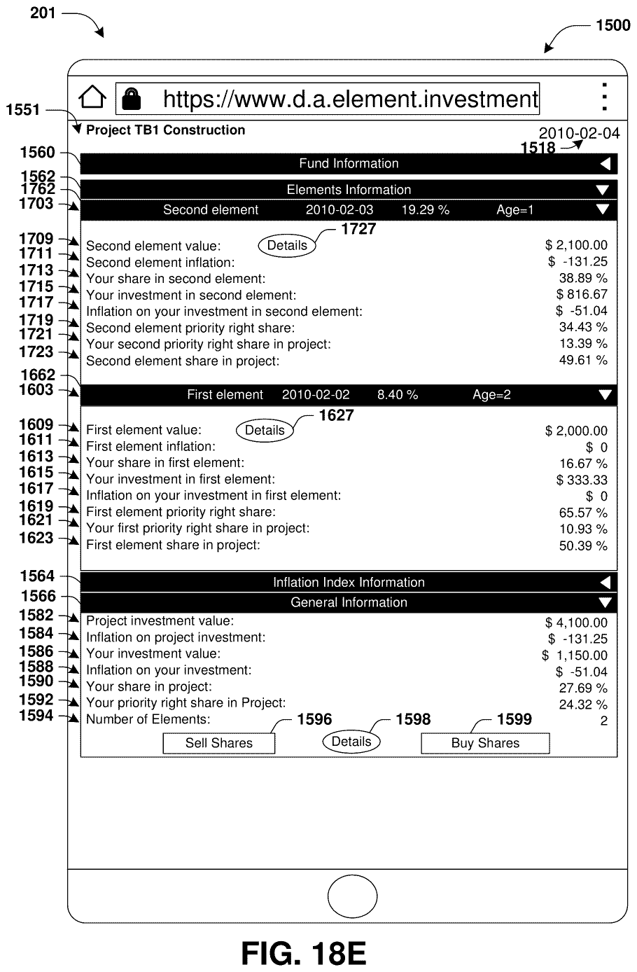

FIGS. 18A-18B illustrate the first client device 1500 displaying the investment interface 1551 at a fourth time (e.g., the Day 4, 4 Feb. 2010) after the third time (e.g., the Day 3, 3 Feb. 2010), in accordance with some embodiments. The fund information menu 1560 of the investment interface 1551 may display updated information at the fourth time of the project. For example, the fund information menu 1560 may be indicative of a third updated value of the project account balance (e.g., $10,900.00), a third updated value of the user account balance (e.g., $2,700.00), a third updated value of user share (e.g., 24.77%) of the user in next element and/or a third updated value of the interest (e.g., $1.11) for the user account balance at the fourth time. The time indicator 1518 may indicate the fourth time of the project. FIG. 18C illustrates the first client device 1500 displaying the interface 1551a at the fourth time of the project, in accordance with some embodiments. The fund information details submenu 1578a may display updated information corresponding to the fund information at the fourth time of the project. The fund information details submenu 1578a may comprise an indication 1878a of the user account balance (e.g., $2,700.00) associated with the first user, the project account balance (e.g., $10,900.00) associated with the first project, a value (e.g., $2,000.00) of a third deposit associated with the user (e.g., the first investor, Tom) at the fourth time of the project, and/or a value (e.g., $5,000.00) of third deposit(s) associated with the other users (e.g., the third investor, Leo).

In some examples, updated account balances may be allocated (by the investment application, for example) to the investor accounts associated with the investors 302 based upon the determined deposit information 206, the determined expenditure information 210 and/or the determined inflation indexes 214, wherein the account balances may comprise a first account balance allocated to a first investor account associated with the user (e.g., the first investor, Tom). In some examples, in the investment application, (i) a withdrawal request, associated with the first investor, to withdraw a first amount of funds from the first investor account may be received, and (ii) an authorization for the withdrawal request based upon the first amount of funds and the first account balance, may be determined. In some examples, in the investment application, the withdrawal request may be authorized based upon the first amount of funds being at most the first account balance. In some examples, in response to authorizing the withdrawal request, the first amount of funds may be transferred to at least one of an account associated with the first investor or an account indicated by the withdrawal request.

The elements information menu 1562 of the investment interface 1551 may display updated information corresponding to the elements information at the fourth time of the project. The first element information submenu 1662 of the elements information menu 1562 of the investment interface 1551 may display updated information corresponding to the first element information at the fourth time of the project. For example, the first element information submenu 1662 may be indicative of (i) the first element value (e.g., $2,000.00), (ii) an updated value of the inflation (e.g., $0.00) on the first element at the fourth time of the project, (iii) the user share (e.g., 33.33%) of the user (e.g., the first investor) in the first element at the fourth time of the project, (iv) the user investment value (e.g., $666.67) of the user (e.g., the first investor) in the first element at the fourth time of the project, (v) an updated value of the inflation (e.g., $0.00) on the user investment value (e.g., $666.67) of the user in the first element at the fourth time of the project, (vi) an updated value of the priority right share (e.g., 65.57%) associated with the first element in the project at the fourth time of the project, (vii) an updated value of the first priority right share (e.g., 21.86%) of the user in the project (based upon having the share in the first element, for example) at the fourth time of the project, and/or (viii) an updated value of the share (e.g., 50.39%) of the first element in the project at the fourth time of the project. The submenu bar 1603 may be indicative of (i) the name of the element (e.g., first element), (ii) the time of formation of the element (e.g., the second time, the Day 2, 2 Feb. 2010), (iii) an updated value of the first share (e.g., 16.80%) of the user in the project based upon having a share in the first element, and/or (iv) an updated value of the age (e.g., two days) of the first element at the fourth time of the project.

The second element information submenu 1762 of the elements information menu 1562 of the investment interface 1551 may display updated information corresponding to the second element information at the fourth time of the project. For example, the second element information submenu 1762 may be indicative of (i) the second element value (e.g., $2,100.00), (ii) an updated value of the inflation (e.g., $−131.25) on the second element at the fourth time of the project, (iii) the user share (e.g., 77.78%) of the user (e.g., the first investor) in the second element at the fourth time of the project, (iv) the user investment value (e.g., $1,633.33) of the user (e.g., the first investor) in the second element at the fourth time of the project, (v) an updated value of the inflation (e.g., $−102.08) on the user investment value (e.g., $1,633.33) of the user in the second element at the fourth time of the project, (vi) an updated value of the priority right share (e.g., 34.43%) associated with the second element in the project at the fourth time of the project, (vii) an updated value of the second priority right share (e.g., 26.78%) of the user in the project (based upon having the share in the second element, for example) at the fourth time of the project, and/or (viii) an updated value of the share (e.g., 49.61%) of the second element in the project at the fourth time of the project. The submenu bar 1703 may be indicative of (i) the name of the element (e.g., second element), (ii) the time of formation of the element (e.g., the third time, the Day 3, 3 Feb. 2010), (iii) an updated value of the second share (e.g., 38.58%) of the user in the project based upon having a share in the second element, and/or (iv) an updated value of the age (e.g., one day) of the second element at the fourth time of the project.

The inflation index information menu 1564 of the investment interface 1551 may display updated information corresponding to the inflation index information at the fourth time of the project. For example, the inflation index information menu 1564 may comprise an indication 1864a (shown in FIG. 18A) of a description (e.g., price of a new table) of an inflation index at the fourth time, price (e.g., $15,000.00) of the inflation index at the fourth time and/or date (e.g., the fourth time).

As shown in FIG. 18B, the general information menu 1566 of the investment interface 1551 may display updated information corresponding to the general information at the fourth time of the project. For example, the general information menu 1566 may be indicative of an updated value of the project investment value (e.g., $4,100.00) at the fourth time of the project, an updated value of the inflation (e.g., $−131.25) on the project investment value at the fourth time of the project, an updated value of the user investment value (e.g., $2,300.00) for the user at the fourth time of the project, an updated value of the inflation (e.g., $−102.08) on the user investment value for the user at the fourth time of the project, an updated value of the user share (e.g., 55.38%) in the project, an updated value of user priority right share (e.g., 48.63%) in the project and/or an updated value of number of elements (e.g., two elements) for the user at the fourth time of the project. In some examples, in response to a selection of the selectable input 1596 associated with the general information menu 1566 of the project, the investor interface may display a market submenu 1896 (e.g., a drop-down submenu) of the general information menu 1566 (shown in FIG. 18D).

In some examples, the inflation-corrected shares 218 may comprise a first inflation-corrected share associated with the user (e.g., the first investor) at a time (e.g., the fourth time, the Day 4) of the project. In an example, the investment application may receive a transfer request to transfer an amount (e.g., 50%) of the first inflation-corrected share (e.g., the user share and/or the user priority right share) from the user (e.g., the first investor, Tom) to a second user (e.g., the fourth investor, Sam). In some examples, in response to the transfer request, the investment application may transfer the amount of the first inflation-corrected share from the user to the second user, wherein the amount of the first inflation-corrected share comprises at least a portion of the first inflation-corrected share.

FIG. 18D illustrates the first client device 1500 displaying the interface 1551 comprising the market submenu 1896, in accordance with some embodiments. In an example, the market submenu 1896 may comprise an indication 1894 of a question (e.g., “How much of your ownership share do you want to sell?”), a box 1892 (e.g., a dashed line box) and/or a selectable input 1890 (to confirm a sale by the user, for example). For example, after receiving the question, the user may insert (e.g., wright) a percentage (e.g., 50%) in the box 1892 to sell (i) 50% of the user share (e.g., 55.38%) in the project, and/or (ii) 50% of the user priority right share (e.g., 18.63%) in the project. Alternatively and/or additionally, in response to a selection of the selectable input 1890, the investment interface 1551 may display updated information (shown in FIG. 18E) corresponding to market information (e.g., the first element information, the second element information, the general information, etc.) at the fourth time of the project after selling and/or transferring the user share and/or the user priority right share. FIG. 18E illustrates the first client device 1500 displaying the investment interface 1551 at the fourth time after selling (e.g., transferring) an ownership share from the user to another user (after the user (e.g., Tom) sold 50% of his ownership share to the fourth investor (e.g., Sam), for example), in accordance with some embodiments.

As shown in FIG. 18E, the general information menu 1566 of the investment interface 1551 may display updated information corresponding to the general information at the fourth time after the transferring the ownership share in the project. For example, the general information menu 1566 may be indicative of, an updated value of the user investment value (e.g., $1,150.00) for the user at the fourth time after the transferring the ownership share in the project, an updated value of the inflation (e.g., $−51.04) on the user investment value for the user at the fourth time after the transferring the ownership share in the project, an updated value of the user share (e.g., 27.69%) in the project, and/or an updated value of user priority right share (e.g., 24.32%) at the fourth time after the transferring the ownership share in the project.

The first element information submenu 1662 of the elements information menu 1562 of the investment interface 1551 may display updated information corresponding to the first element information at the fourth time after the transferring the ownership share in the project. For example, the first element information submenu 1662 may be indicative of an updated value of the user share (e.g., 16.67%) of the user (e.g., the first investor) in the first element at the fourth time after the transferring the ownership share in the project, an updated value of the user investment value (e.g., $333.33) of the user (e.g., the first investor) in the first element at the fourth time after the transferring the ownership share in the project, an updated value of the inflation (e.g., $0.00) on the first element at the fourth time after the transferring the ownership share in the project and/or an updated value of the first priority right share (e.g., 10.93%) of the user in the project (based upon having a new share in the first element, for example) at the fourth time after the transferring the ownership share in the project. The submenu bar 1603 may be indicative an updated value of the first share (e.g., 8.40%) of the user in the project based upon having the new share in the first element at the fourth time after the transferring the ownership share in the project.

The second element information submenu 1762 of the elements information menu 1562 of the investment interface 1551 may display updated information corresponding to the second element information at the fourth time after the transferring the ownership share in the project. For example, the second element information submenu 1762 may be indicative of an updated value of the user share (e.g., 38.89%) of the user (e.g., the first investor) in the second element at the fourth time after the transferring the ownership share in the project, an updated value of the user investment value (e.g., $816.67) of the user (e.g., the first investor) in the second element at the fourth time after the transferring the ownership share in the project, an updated value of the inflation (e.g., $−51.04) on the second element at the fourth time after the transferring the ownership share in the project, and/or an updated value of the second priority right share (e.g., 13.39%) of the user in the project (based upon having a new share in the second element, for example) at the fourth time after the transferring the ownership share in the project. The submenu bar 1703 may be indicative an updated value of the second share (e.g., 19.29%) of the user in the project based upon having the new share in the second element at the fourth time after the transferring the ownership share in the project.

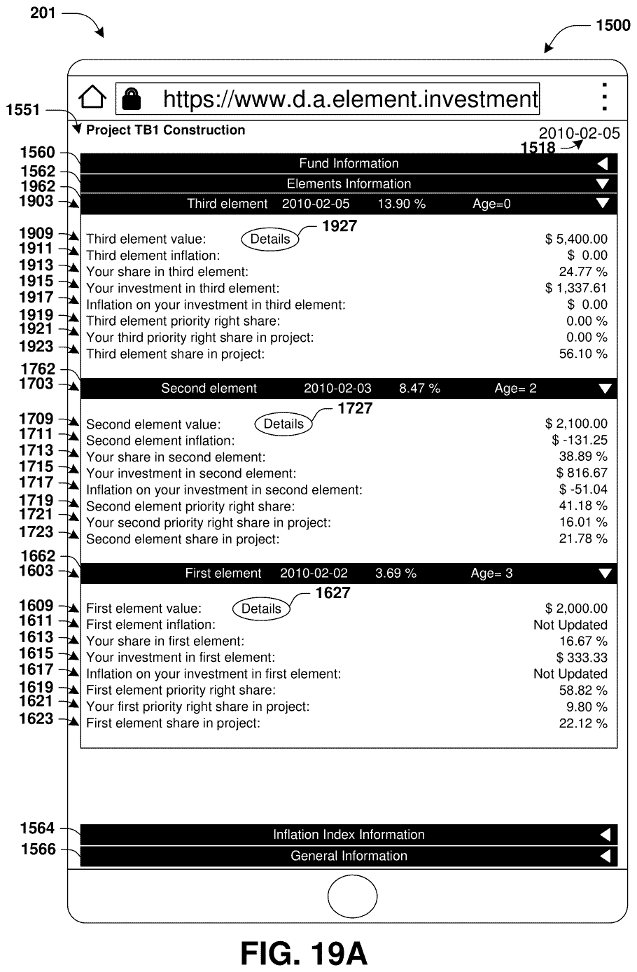

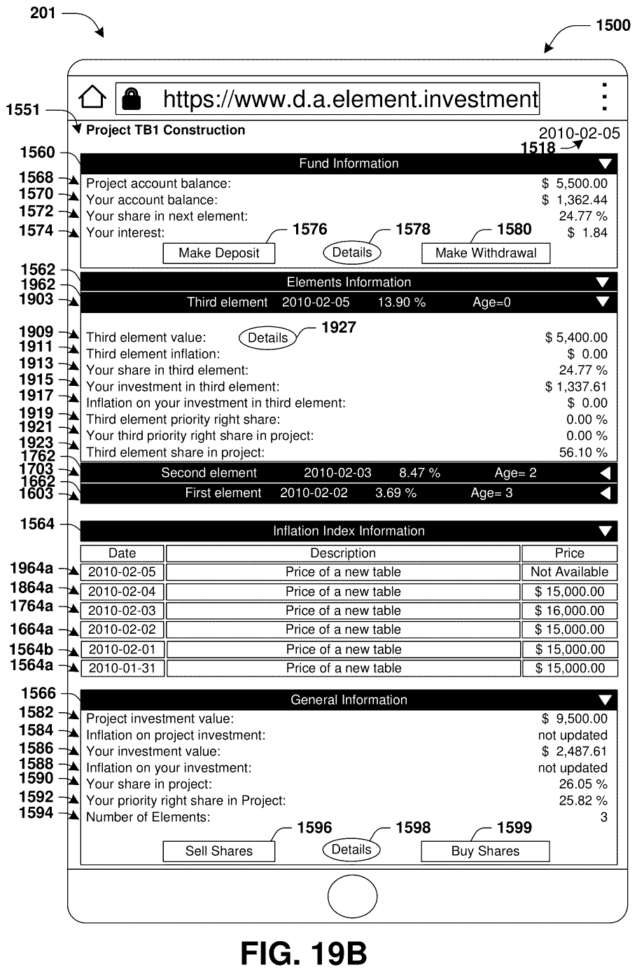

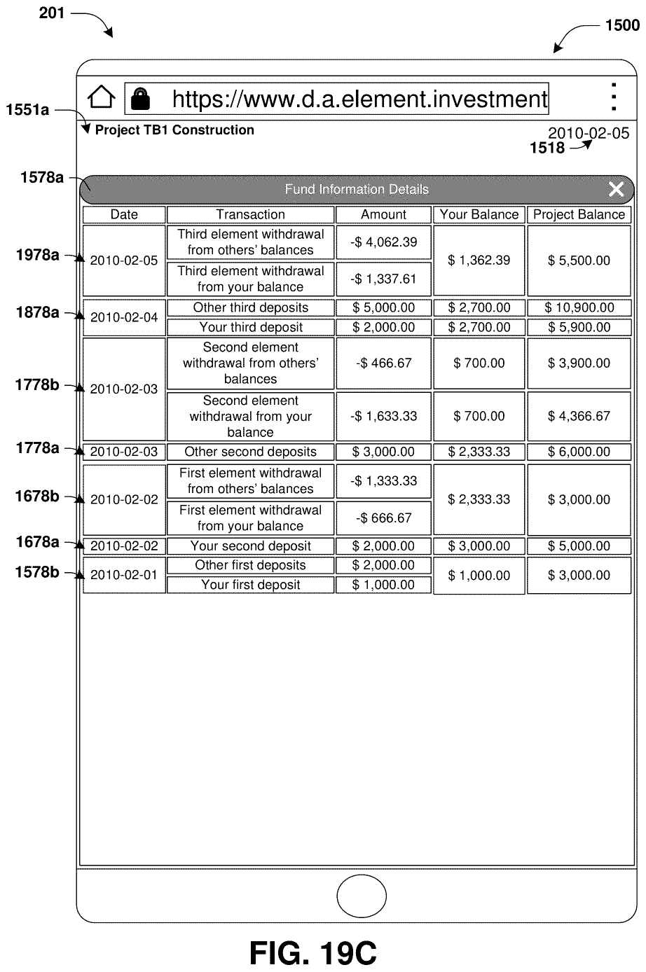

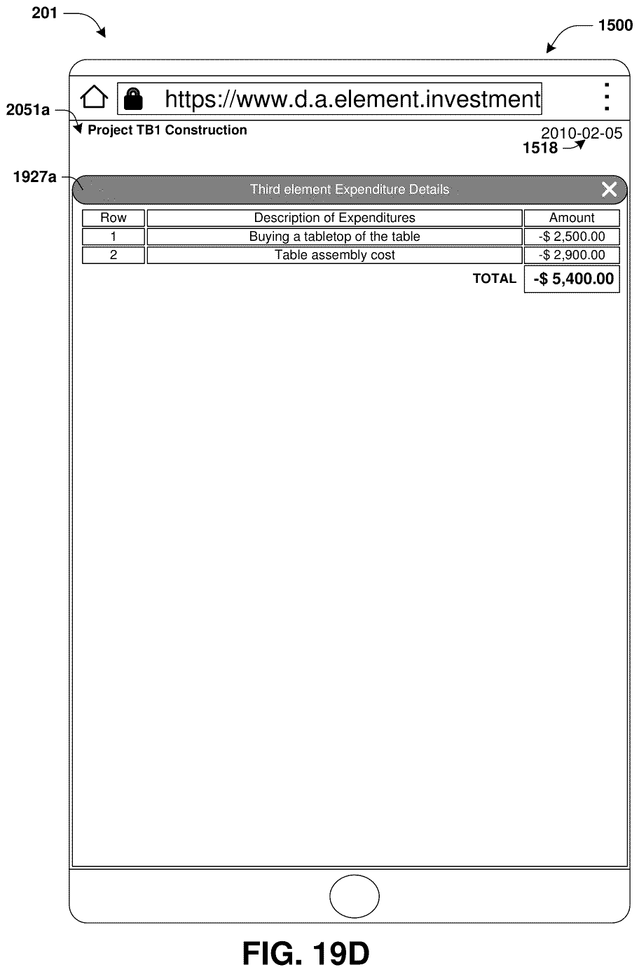

FIGS. 19A-19B illustrate the first client device 1500 displaying the investment interface 1551 at a fifth time (e.g., the Day 5, 5 Feb. 2010) after the fourth time (e.g., the Day 4, 4 Feb. 2010), in accordance with some embodiments. The fund information menu 1560 of the investment interface 1551 may display updated information at the fifth time of the project. For example, the fund information menu 1560 (shown in FIG. 19B) may be indicative of a fourth updated value of the project account balance (e.g., $5,500.00), a fourth updated value of the user account balance (e.g., $1,362.39), a fourth updated value of user share (e.g., 24.77%) of the user in next element and/or a fourth updated value of the interest (e.g., $1.84) for the user account balance at the fifth time. The time indicator 1518 may indicate the fifth time of the project. FIG. 19C illustrates the first client device 1500 displaying the interface 1551a at the fifth time of the project, in accordance with some embodiments. The fund information details submenu 1578a may display updated information corresponding to the fund information at the fifth time of the project. The fund information details submenu 1578a may comprise an indication 1978a of the user account balance (e.g., $1,362.39) associated with the first user, the project account balance (e.g., $5,500.00) associated with the first project, an amount (e.g., −$1,337.61) of third withdrawal (associated with the third element expenditure(s) of the first project, for example) from the user account balance, and/or an amount (e.g., −$4,062.39) of third withdrawal from other users account balances (associated with the third element expenditure(s) of the first project, for example).

The elements information menu 1562 of the investment interface 1551 may display updated information corresponding to the elements information at the fifth time of the project. The elements information menu 1562 may comprise a third element information submenu 1962. The third element information submenu 1962 may comprise a submenu bar 1903, wherein the submenu bar 1903 may be indicative of name of element (e.g., third element), time of formation of the element (e.g., the fifth time, the Day 5, 5 Feb. 2010), a third share (e.g., 13.90%) of the user in the project (e.g., the first project) based upon having a share in the third element, and/or age (e.g., zero days) of the third element. The third element information submenu 1962 may comprise an indication 1909 of a third element value (e.g., $5,400.00) at the fifth time of the project. The third element information submenu 1962 may comprise an indication 1911 of an inflation (e.g., $0.00) on the third element at the fifth time of the project. The third element information submenu 1962 may comprise an indication 1913 of a user share (e.g., 24.77%) of the user (e.g., the first investor) in the third element at the fifth time of the project. The third element information submenu 1962 may comprise an indication 1915 of a user investment value (e.g., $1,337.61) of the user (e.g., the first investor) in the third element at the fifth time of the project. The third element information submenu 1962 may comprise an indication 1917 of an inflation (e.g., $0.00) on the user investment value (e.g., $1,337.61) of the user in the third element at the fifth time of the project. The third element information submenu 1962 may comprise an indication 1919 of a priority right share (e.g., 0.00%) associated with the third element in the project at the fifth time of the project. The third element information submenu 1962 may comprise an indication 1921 of a third priority right share (e.g., 0.00%) of the user in the project (based upon having a share in the third element, for example) at the fifth time of the project. The third element information submenu 1962 may comprise an indication 1923 of a share (e.g., 56.10%) of the third element in the project at the fifth time of the project.

In some examples, the elements information menu 1562 may comprise a selectable input 1927 for accessing supplemental information associated with elements information of the project. In some examples, in response to a selection of the selectable input 1927 associated with the elements information menu 1562 of the project, the investor interface may display an interface 1951a (shown in FIG. 19D). FIG. 19D illustrates the first client device 1500 displaying the interface 1951a, in accordance with some embodiments. The interface 1951a may comprise a third element information details submenu 1927a (e.g., a submenu of the elements information menu 1562) corresponding to the element information at the fifth time of the project. The third element information details submenu 1927a may be indicative of the supplemental information associated with the element information of the project. The supplemental information associated with the elements information may comprise one or more expenditures (e.g., one or more purchases, the expenditure 6, and/or the expenditure 7 shown in FIG. 4) associated with the third element, wherein the one or more expenditures may be made at the fifth time of the project.

The elements information menu 1562 of the investment interface 1551 may display updated information (and/or not updated information) corresponding to the elements information at the fifth time of the project. The first element information submenu 1662 of the elements information menu 1562 of the investment interface 1551 may display updated information (and/or not updated information) corresponding to the first element information at the fifth time of the project. For example, the first element information submenu 1662 may be indicative of (i) the first element value (e.g., $2,000.00), (ii) a not updated value (which is shown using a text “not updated”, for example) of the inflation on the first element at the fifth time of the project, (iii) the user share (e.g., 16.67%) of the user (e.g., the first investor) in the first element at the fifth time of the project, (iv) the user investment value (e.g., $333.33) of the user (e.g., the first investor) in the first element at the fifth time of the project, (v) a not updated value (which is shown using the text “not updated”, for example) of the inflation on the user investment value (e.g., $333.33) of the user in the first element at the fifth time of the project, (vi) an updated value of the priority right share (e.g., 58.82%) associated with the first element in the project at the fifth time of the project, (vii) an updated value of the first priority right share (e.g., 9.80%) of the user in the project (based upon having the new share in the first element, for example) at the fifth time of the project, and/or (viii) an updated value of the share (e.g., 22.12%) of the first element in the project at the fifth time of the project. The submenu bar 1603 may be indicative of (i) the name of the element (e.g., first element), (ii) the time of formation of the element (e.g., the second time, the Day 2, 2 Feb. 2010), (iii) an updated value of the first share (e.g., 3.69%) of the user in the project based upon having the new share in the first element, and/or (iv) an updated value of the age (e.g., three days) of the first element at the fifth time of the project.

The second element information submenu 1762 of the elements information menu 1562 of the investment interface 1551 may display updated information (and/or not updated information) corresponding to the second element information at the fifth time of the project. For example, the second element information submenu 1762 may be indicative of (i) the second element value (e.g., $2,100.00), (ii) an updated value of the inflation (e.g., $−131.25) on the second element at the fifth time of the project, (iii) the user share (e.g., $38.89) of the user (e.g., the first investor) in the second element at the fifth time of the project, (iv) the user investment value (e.g., $816.67) of the user (e.g., the first investor) in the second element at the fifth time of the project, (v) an updated value of the inflation (e.g., $−51.04) on the user investment value (e.g., $816.67) of the user in the second element at the fifth time of the project, (vi) an updated value of the priority right share (e.g., 41.18%) associated with the second element in the project at the fifth time of the project, (vii) an updated value of the second priority right share (e.g., 16.01%) of the user in the project (based upon having the new share in the second element, for example) at the fifth time of the project, and/or (viii) an updated value of the share (e.g., 21.78%) of the second element in the project at the fifth time of the project. The submenu bar 1703 may be indicative of (i) the name of the element (e.g., second element), (ii) the time of formation of the element (e.g., the third time, the Day 3, 3 Feb. 2010), (iii) an updated value of the second share (e.g., 8.47%) of the user in the project based upon having the new share in the second element, and/or (iv) an updated value of the age (e.g., two days) of the second element at the fifth time of the project.

The inflation index information menu 1564 of the investment interface 1551 may display updated information corresponding to the inflation index information at the fifth time of the project. For example, the inflation index information menu 1564 may comprise an indication 1964a (shown in FIG. 19B) of a description (e.g., price of a new table) of an inflation index at the fifth time, price (e.g., not available price) of the inflation index at the fifth time and/or date (e.g., the fifth time).

As shown in FIG. 19B, the general information menu 1566 of the investment interface 1551 may display updated information and/or not updated information corresponding to the general information at the fifth time of the project. For example, the general information menu 1566 may be indicative of an updated value of the project investment value (e.g., $9,500.00) at the fifth time of the project, a not updated value of the inflation on the project investment value at the fifth time of the project, an updated value of the user investment value (e.g., $2,487.61) for the user at the fifth time of the project, a not updated value of the inflation on the user investment value for the user at the fifth time of the project, an updated value of the user share (e.g., 26.05%) in the project, an updated value of user priority right share (e.g., 25.82%) in the project and/or an updated value of number of elements (e.g., three elements) for the user at the fifth time of the project.

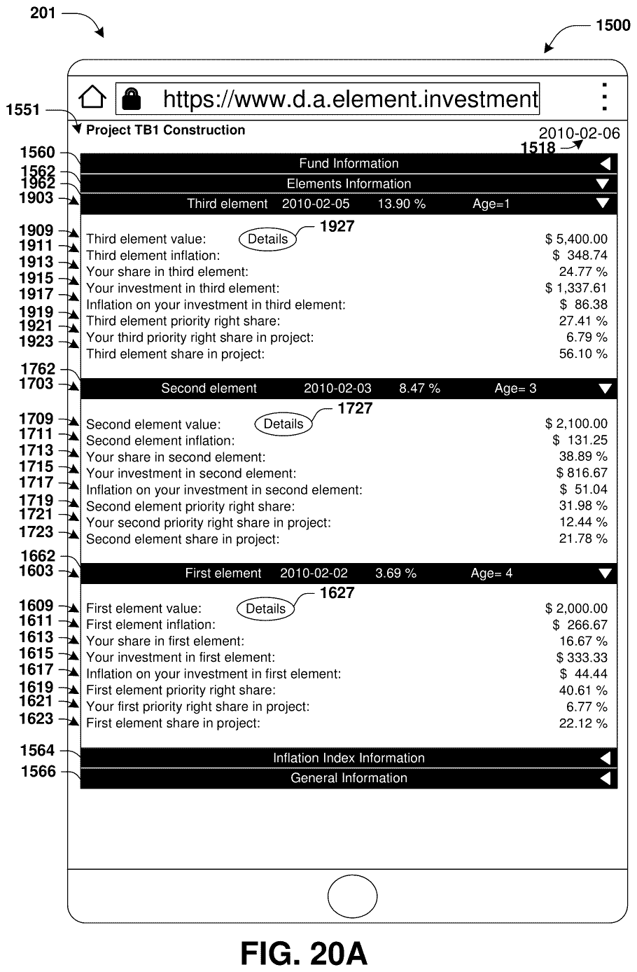

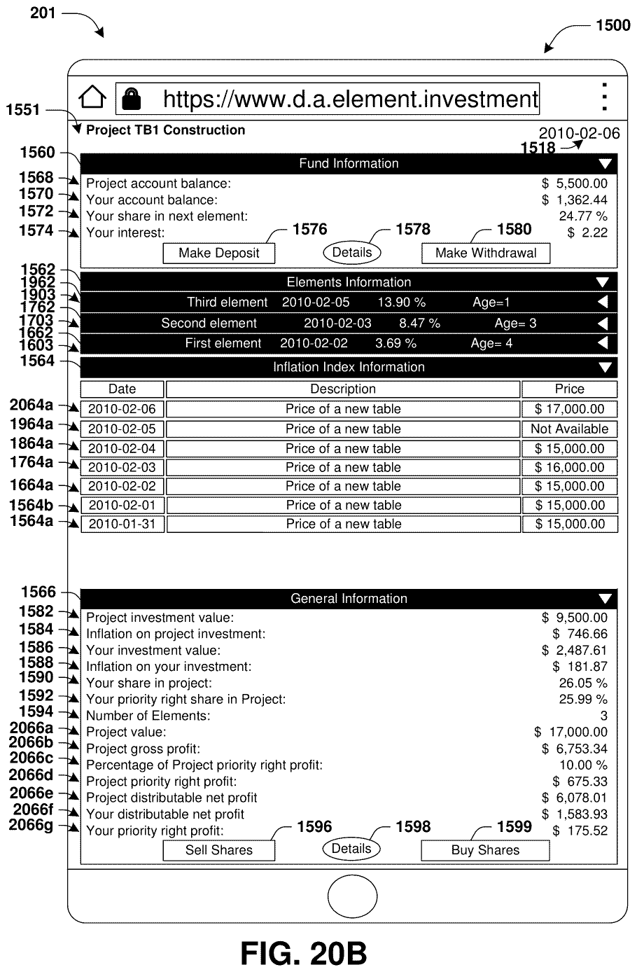

FIGS. 20A-20B illustrate the first client device 1500 displaying the investment interface 1551 at a sixth time (e.g., the Day 6, 6 Feb. 2010) after the fifth time (e.g., the Day 5, 5 Feb. 2010), in accordance with some embodiments. The fund information menu 1560 of the investment interface 1551 may display updated information at the sixth time of the project. For example, the fund information menu 1560 (shown in FIG. 20B) may be indicative of the fourth updated value of the project account balance (e.g., $5,500.00), the fourth updated value of the user account balance (e.g., $1,362.39), the fourth updated value of user share (e.g., 24.77%) of the user in next element and/or a fifth updated value of the interest (e.g., $2.22) for the user account balance at the fifth time. The time indicator 1518 may indicate the sixth time of the project.

The elements information menu 1562 of the investment interface 1551 may display updated information corresponding to the elements information at the sixth time of the project. The first element information submenu 1662 of the elements information menu 1562 (shown in FIG. 20A) of the investment interface 1551 may display updated information corresponding to the first element information at the sixth time of the project. For example, the first element information submenu 1662 may be indicative of (i) the first element value (e.g., $2,000.00), (ii) an updated value of the inflation (e.g., $266.67) on the first element at the sixth time of the project, (iii) the user share (e.g., 16.67%) of the user (e.g., the first investor) in the first element at the sixth time of the project, (iv) the user investment value (e.g., $333.33) of the user (e.g., the first investor) in the first element at the sixth time of the project, (v) an updated value of the inflation (e.g., $44.44) on the user investment value (e.g., $333.33) of the user in the first element at the sixth time of the project, (vi) an updated value of the priority right share (e.g., 40.61%) associated with the first element in the project at the sixth time of the project, (vii) an updated value of the first priority right share (e.g., 6.77%) of the user in the project (based upon having the new share in the first element, for example) at the sixth time of the project, and/or (viii) an updated value of the share (e.g., 22.12%) of the first element in the project at the sixth time of the project. The submenu bar 1603 may be indicative of (i) the name of the element (e.g., first element), (ii) the time of formation of the element (e.g., the second time, the Day 2, 2 Feb. 2010), (iii) an updated value of the first share (e.g., 3.69%) of the user in the project based upon having the new share in the first element, and/or (iv) an updated value of the age (e.g., four days) of the first element at the sixth time of the project.

The second element information submenu 1762 of the elements information menu 1562 (shown in FIG. 20A) of the investment interface 1551 may display updated information corresponding to the second element information at the sixth time of the project. For example, the second element information submenu 1762 may be indicative of (i) the second element value (e.g., $2,100.00), (ii) an updated value of the inflation (e.g., $131.25) on the second element at the sixth time of the project, (iii) the user share (e.g., 38.89%) of the user (e.g., the first investor) in the second element at the sixth time of the project, (iv) the user investment value (e.g., $816.67) of the user (e.g., the first investor) in the second element at the sixth time of the project, (v) an updated value of the inflation (e.g., $51.04) on the user investment value (e.g., $816.67) of the user in the second element at the sixth time of the project, (vi) an updated value of the priority right share (e.g., 31.98%) associated with the second element in the project at the sixth time of the project, (vii) an updated value of the second priority right share (e.g., 12.44%) of the user in the project (based upon having the new share in the second element, for example) at the sixth time of the project, and/or (viii) an updated value of the share (e.g., 21.78%) of the second element in the project at the sixth time of the project. The submenu bar 1703 may be indicative of (i) the name of the element (e.g., second element), (ii) the time of formation of the element (e.g., the third time, the Day 3, 3 Feb. 2010), (iii) an updated value of the second share (e.g., 8.47%) of the user in the project based upon having the new share in the second element, and/or (iv) an updated value of the age (e.g., three days) of the second element at the sixth time of the project.

The third element information submenu 1762 of the elements information menu 1962 (shown in FIG. 20A) of the investment interface 1551 may display updated information corresponding to the third element information at the sixth time of the project. For example, the third element information submenu 1962 may be indicative of (i) the third element value (e.g., $5,400.00), (ii) an updated value of the inflation (e.g., $348.74) on the third element at the sixth time of the project, (iii) the user share (e.g., 24.77%) of the user (e.g., the first investor) in the third element at the sixth time of the project, (iv) the user investment value (e.g., $1,337.61) of the user (e.g., the first investor) in the third element at the sixth time of the project, (v) an updated value of the inflation (e.g., $86.38) on the user investment value (e.g., $1,337.61) of the user in the third element at the sixth time of the project, (vi) an updated value of the priority right share (e.g., 27.41%) associated with the third element in the project at the sixth time of the project, (vii) an updated value of the third priority right share (e.g., 6.79%) of the user in the project (based upon having the new share in the third element, for example) at the sixth time of the project, and/or (viii) an updated value of the share (e.g., 56.10%) of the third element in the project at the sixth time of the project. The submenu bar 1903 may be indicative of (i) the name of the element (e.g., third element), (ii) the time of formation of the element (e.g., the fifth time, the Day 5, 5 Feb. 2010), (iii) an updated value of the third share (e.g., 13.90%) of the user in the project based upon having the new share in the third element, and/or (iv) an updated value of the age (e.g., one day) of the third element at the sixth time of the project.

The inflation index information menu 1564 of the investment interface 1551 may display updated information corresponding to the inflation index information at the sixth time of the project. For example, the inflation index information menu 1564 may comprise an indication 2064a (shown in FIG. 20B) of a description (e.g., price of a new table) of an inflation index at the sixth time, price (e.g., $17,000.00) of the inflation index at the sixth time and/or date (e.g., the sixth time).

As shown in FIG. 20B, the general information menu 1566 of the investment interface 1551 may display updated information corresponding to the general information at the sixth time of the project. For example, the general information menu 1566 may be indicative of an updated value of the project investment value (e.g., $9,500.00) at the sixth time of the project, an updated value of the inflation (e.g., $746.66) on the project investment value at the sixth time of the project, an updated value of the user investment value (e.g., $2,487.61) for the user at the sixth time of the project, an updated value of the inflation (e.g., $181.87) on the user investment value for the user at the sixth time of the project, an updated value of the user share (e.g., 26.05%) in the project, an updated value of user priority right share (e.g., 25.99%) in the project and/or an updated value of number of elements (e.g., three elements) for the user at the fifth time of the project. In some examples, at completion time (e.g., the sixth time) of the project, the general information menu 1566 of the investment interface 1551 may comprise additional information such as an indication 2066a of a project value (e.g., $17,000.00), an indication 2066b of a project gross profit (e.g., $6,753.34), an indication 2066c of a percentage (e.g., 10.00%) of a project priority right profit, an indication 2066d of a project priority right profit (e.g., $675.33), an indication 2066e of a project distributable net profit (e.g., $6,078.01), an indication 2066f of a distributable net profit (e.g., $1,583.93) associated with the user (e.g., the first investor, Tom) and/or an indication 2066g of a priority right profit (e.g., $175.52) associated with the user. In some examples, the project value may be price (e.g., $17,000.00) of the table constructed in the first project.

In some examples, a message indicative of one or more of the inflation-corrected shares 218 may be provided (by the investment application, for example) to a device (e.g., the client device 1500) for display at any time of the project.

In some examples, the deposit information determination module 204, the expenditure information determination module 208, the inflation index determination module 212, the inflation-corrected share determination module 216, the market information determination module 224, the element information determination module 228, the account balance determination module 254, the interest determination module 258, and/or the CDGR determination module may be implemented by the investment application (e.g., a mobile application, a web application, etc.), which may be installed on and/or accessible to the client device 1500. The inflation-corrected shares 218 may be provided (by the inflation-corrected share determination module 216 of the investment application, for example) to the client device 1500 for display on the client device 1500. In some examples, the investment application may control and/or display the interface 1504, the interface 1530, the interface 1550, the investment interface 1551, the fund information menu 1560, the elements information menu 1562, the inflation index information menu 1564, the general information menu 1566, the fund information details submenu 1578a, the interface 1551a, the interface 1651a, the interface 1751a, the first element information submenu 1662, the second element information submenu 1762, the third element information submenu 1962, the first element information details submenu 1627a, the second element information details submenu 1727a, and/or the third element information details submenu 1927a on the client device 1500 to provide a user of the client device 1500 with investment-related information, such as the inflation-corrected shares 218 and/or other information determined using the provisions herein.

In some examples, in each day of the project (e.g., the first project) during the progress of the project, one or more parts of the project (e.g., the first project) may be sold to one or more people other than the investors 302. Alternatively and/or additionally, after selling the one or more parts of the project to the one or more people, a profit may be generated from the sale in the project and/or may be distributed among the investors 302 (who are engaged in the project up to date of the sale, for example) based on their percentage of participation in the project. Alternatively and/or additionally, after the distributing the profit among the investors 302, share of investors in elements, share of elements in the project and/or share of investors in the project may be updated. Alternatively and/or additionally, after the updating, updated investors investments, updated total inflation on investors investments, updated total project shares of the investors 302, updated total priority right shares of the investors 302 and/or updated distributable net profit of the investors 302 may be determined. In some examples, after the selling the one or more parts of the project to the one or more people in each day of the project, an updated value of one or more elements formed up to a day of the sale of the one or more parts of the project may be reduced in proportion to a value of the one or more parts of the project relative to a total value of the project. For example, after the sale of a part of the first project (which may be worth about 20% of the total project value, for example) on the Day 4 of the first project, (i) an updated value of the first element on the Day 4 (the second inflation corrected array 714b that is about $2,000.00, for example) may be reduced by 20% and/or may be about $1,600.00, and (ii) an updated value of the second element on the Day 4 (the sixth inflation corrected array 716b that is about $1,968.80, for example) may be reduced by 20% and/or may be about $1,575.04.

In some examples, the present disclosure provides computer-implemented systems and/or methods that improve the functioning of investment-management computing platforms by enabling automated, real-time, inflation-adjusted calculation of investor shares in collaborative investment projects. The disclosed technology may implement specialized server-side processing components and/or time-stamped contribution ledgers that continuously and/or periodically compute and/or report each participant's proportional ownership using current inflation metrics, contribution timing, and/or project-specific financial events.

In some examples, the system may comprise one or more backend servers executing investment-management logic, including an inflation index retrieval module of the inflation index determination module 212, a share calculation module of the inflation-corrected share determination module 216, and/or one or more synchronization services that propagate updated share values to user devices. The backend servers may maintain a contribution ledger that records each investor transaction with timestamps, currency type, inflation index value at the time of deposit, and/or project-level cash-flow indicators. When a user initiates a deposit, withdrawal, or transfer request via a client device displaying an interface of the investment application, the client device transmits a structured request to an API layer of the investment application executing on the server. The API layer may normalize the request, queue the request for processing, and/or trigger the inflation index retrieval module and/or the share calculation module to update one or more shares based upon the request.

In some examples, in response to receiving the request, the inflation index retrieval module may automatically query one or more remote inflation-data sources (e.g., a government CPI service, market-based inflation indicators, or a locally stored inflation-metric cache) using authenticated and/or logged network calls to retrieve an inflation value. The retrieved inflation value is paired with the investment event associated with the request and stored within a multi-column data structure used by the share calculation module. The share calculation module may compute an inflation-corrected value for each investor by performing machine-implemented operations that adjust the nominal contribution amount to its present-value equivalent based on contribution time and/or intervening inflation changes.

The disclosed system improves conventional computer-implemented investment-management platforms by providing real-time calculations, automated data ingestion from third-party economic sources, and/or specialized data structures optimized for incremental computation, thereby reducing the need for manual calculation, eliminating reliance on static spreadsheets or periodic batch jobs, and/or ensuring consistency of share data across multiple client devices. The technical improvements include (i) an automated and continuous recalculation pipeline triggered by specific backend events; (ii) a dynamic inference of investor priority or rights based on inflation-indexed values computed by the temporal-weighting engine; (iii) reduced processing latency through incremental recomputation techniques; and/or (iv) automated synchronization of economically accurate share values across client devices without requiring manual user updates. As a result, the disclosed systems and methods may provide a technological solution to the technological problem of reliably computing and/or distributing inflation-corrected investment shares within distributed digital investment platforms.

In some examples, the disclosed systems and methods improve the accuracy of information transmitted between backend servers and client devices by ensuring that transmitted share values, contribution records, and/or project-level financial metrics are inflation-adjusted and current at the time of transmission, thereby reducing the likelihood of propagating stale, inconsistent, and/or partially processed investment information across distributed devices. In some examples, a communication layer of the investment application that transmits inflation-corrected shares and/or other information to a client device may implement structured payload formats, versioned data packets, and/or verification functions (e.g., checksum verification, hash-based verification, etc.) so that the receiving client device can confirm that the transmitted data reflects an accurately computed state of an investor-share ledger, thereby reducing transmission errors, avoiding client-side miscalculations caused by outdated local caches, and/or ensuring that each participant receives a consistent, verified view of their inflation-corrected investment position in real time, thereby improving overall data reliability within the distributed investment-management system.

In some examples, a method is provided. The method includes (i) determining deposit information associated with a plurality of deposits associated with a first project, wherein the deposit information is indicative of deposit amounts of the plurality of deposits, investors associated with the plurality of deposits, and times of the plurality of deposits, (ii) determining expenditure information associated with a plurality of expenditures associated with the first project, wherein the expenditure information is indicative of expenditure amounts of the plurality of expenditures and times of the plurality of expenditures, (iii) determining inflation indexes associated with periods of time within a window of time beginning at a starting time associated with the first project, (iv) determining inflation-corrected shares associated with the investors based upon the deposit information, the expenditure information, and the inflation indexes, and (v) providing a message indicative of one or more of the inflation-corrected shares to a device for display.

In some examples, the inflation-corrected shares include a first inflation-corrected share associated with a first investor. In some examples, the method includes (i) receiving a transfer request to transfer an amount of the first inflation-corrected share in the first project from the first investor to a second investor, and (ii) in response to the transfer request, transferring the amount of the first inflation-corrected share from the first investor to the second investor, wherein the amount of the first inflation-corrected share comprises at least a portion of the first inflation-corrected share.

In some examples, the method includes (i) allocating account balances to investor accounts associated with the investors based upon at least one of the determined deposit information, the determined expenditure information or the determined inflation indexes, wherein the account balances comprise a first account balance allocated to a first investor account associated with a first investor, (ii) receiving a withdrawal request, associated with the first investor, to withdraw a first amount of funds from the first investor account, and (iii) determining whether to authorize the withdrawal request based upon the first amount of funds and the first account balance.

In some examples, the method includes (i) authorizing the withdrawal request based upon the first amount of funds being at most the first account balance, and in response to authorizing the withdrawal request, transferring the first amount of funds to at least one of an account associated with the first investor or an account indicated by the withdrawal request.

In some examples, the method includes allocating a set of priority right shares to the investors associated with the plurality of deposits based upon times associated with the plurality of deposits.

In some examples, the method includes providing a message indicative of one or more of the set of priority right shares associated with the investors to the device for display.

In some examples, the set of priority right shares comprise a first priority right share associated with the first investor; and

In some examples, the method includes (i) receiving a transfer request to transfer an amount of the first priority right share from the first investor to a second investor, and (ii) in response to the transfer request, transferring the amount of the first priority right share from the first investor to the second investor, wherein the amount of the first priority right share comprises at least a portion of the first priority right share.

In some examples, the method includes (i) determining account balance information associated with a first investor account of a first investor of the investors, wherein the account balance information is indicative of historical account balances of the first investor account, (ii) determining an interest based upon the account balance information, and (iii) allocating the interest to the first investor account.

In some examples, the inflation-corrected shares include (i) a first inflation-corrected share associated with a first investor, and (ii) a second inflation-corrected share associated with a second investor.

In some examples, the method includes (i) providing a first message indicative of the first inflation-corrected share to a first device associated with the first investor, and (ii) providing a second message indicative of the second inflation-corrected share to a second device associated with the second investor.

In some examples, the method includes generating a first project data structure, associated with the first project, comprising a plurality of profiles associated with a plurality of periods of time during the window of time, wherein (i) the plurality of profiles comprises a first profile associated with a first period of time and a second profile associated with a second period of time, (ii) the first profile comprises a first expenditure associated with the first period of time, and (iii) the second profile comprises a second expenditure associated with the second period of time.

In some examples, the first profile comprises a first share of the investors associated with the first period of time. In some examples, the second profile comprises a second share of the investors associated with the second period of time.

In some examples, the first period of time corresponds to a first period of about 24 hours. In some examples, the second period of time corresponds to a second period of about 24 hours.

In some examples, a non-transitory computer-readable medium having stored thereon processor-executable instructions that when executed cause performance of operations is provided. In some examples, the operations include (i) determining deposit information associated with a plurality of deposits associated with a first project, wherein the deposit information is indicative of deposit amounts of the plurality of deposits, investors associated with the plurality of deposits, and times of the plurality of deposits, (ii) determining expenditure information associated with a plurality of expenditures associated with the first project, wherein the expenditure information is indicative of expenditure amounts of the plurality of expenditures and times of the plurality of expenditures, (iii) determining inflation indexes associated with periods of time within a window of time beginning at a starting time associated with the first project, and (iv) determining inflation-corrected shares associated with the investors based upon the deposit information, the expenditure information, and the inflation indexes.

In some examples, the inflation-corrected shares include a first inflation-corrected share associated with a first investor. In some examples, the operations include (i) receiving a transfer request to transfer an amount of the first inflation-corrected share in the first project from the first investor to a second investor, and (ii) in response to the transfer request, transferring the amount of the first inflation-corrected share from the first investor to the second investor, wherein the amount of the first inflation-corrected share comprises at least a portion of the first inflation-corrected share.

In some examples, the operations include (i) allocating account balances to investor accounts associated with the investors based upon at least one of the determined deposit information, the determined expenditure information or the determined inflation indexes, wherein the account balances comprise a first account balance allocated to a first investor account associated with a first investor, (ii) receiving a withdrawal request, associated with the first investor, to withdraw a first amount of funds from the first investor account, and (iii) determining whether to authorize the withdrawal request based upon the first amount of funds and the first account balance.

In some examples, the operations include (i) authorizing the withdrawal request based upon the first amount of funds being at most the first account balance, and (ii) in response to authorizing the withdrawal request, transferring the first amount of funds to at least one of an account associated with the first investor or an account indicated by the withdrawal request.

In some examples, the operations include (i) allocating a set of priority right shares to the investors associated with the plurality of deposits based upon times associated with the plurality of deposits, and (ii) providing a message indicative of one or more of the set of priority right shares associated with the investors to the device for display.

In some examples, a computer is provided. In some examples, the computer includes a processor configured to execute processor-executable instructions that when executed cause performance of operations. In some examples, the operations include (i) determining deposit information associated with a plurality of deposits associated with a first project, wherein the deposit information is indicative of deposit amounts of the plurality of deposits, investors associated with the plurality of deposits, and times of the plurality of deposits, (ii) determining expenditure information associated with a plurality of expenditures associated with the first project, wherein the expenditure information is indicative of expenditure amounts of the plurality of expenditures and times of the plurality of expenditures, (iii) determining inflation indexes associated with periods of time within a window of time beginning at a starting time associated with the first project, and (iv) determining inflation-corrected shares associated with the investors based upon the deposit information, the expenditure information, and the inflation indexes.

In some examples, the inflation-corrected shares comprise a first inflation-corrected share associated with a first investor. In some examples, the operations include (i) receiving a transfer request to transfer an amount of the first inflation-corrected share in the first project from the first investor to a second investor, and (ii) in response to the transfer request, transferring the amount of the first inflation-corrected share from the first investor to the second investor, wherein the amount of the first inflation-corrected share comprises at least a portion of the first inflation-corrected share.

In some examples, the operations include (i) allocating account balances to investor accounts associated with the investors based upon at least one of the determined deposit information, the determined expenditure information or the determined inflation indexes, wherein the account balances comprise a first account balance allocated to a first investor account associated with a first investor, (ii) receiving a withdrawal request, associated with the first investor, to withdraw a first amount of funds from the first investor account, (iii) determining whether to authorize the withdrawal request based upon the first amount of funds and the first account balance, (iv) authorizing the withdrawal request based upon the first amount of funds being at most the first account balance, and (v) in response to authorizing the withdrawal request, transferring the first amount of funds to at least one of an account associated with the first investor or an account indicated by the withdrawal request.

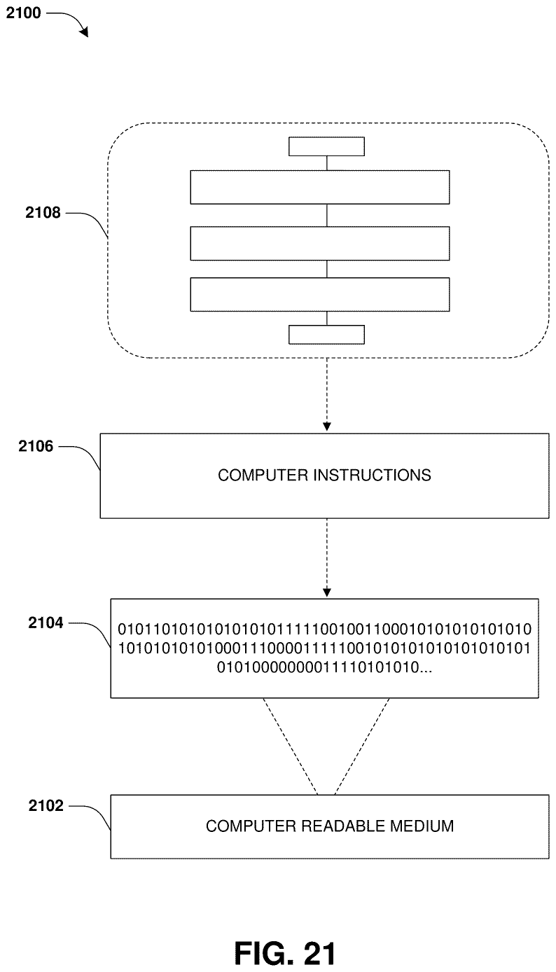

Another embodiment involves a computer-readable medium comprising processor-executable instructions. The processor-executable instructions may be configured to implement one or more of the techniques presented herein. An exemplary computer-readable medium that may be devised in these ways is illustrated in FIG. 21. An implementation 2100 may comprise a computer-readable medium 2102 (e.g., a CD, DVD, or at least a portion of a hard disk drive), which may comprise encoded computer-readable data 2104. The computer-readable data 2104 comprises a set of computer instructions 2106 configured to operate according to one or more of the principles set forth herein. In one such embodiment 2100, the processor-executable computer instructions 2106 may be configured to perform a method 2108, such as at least some of the example method 100 of FIG. 1, for example. In another such embodiment, the processor-executable instructions 2106 may be configured to implement a system, such as at least some of the system 201 of FIGS. 2-12, for example. Many such computer-readable media 2102 may be devised by those of ordinary skill in the art that are configured to operate in accordance with the techniques presented herein.

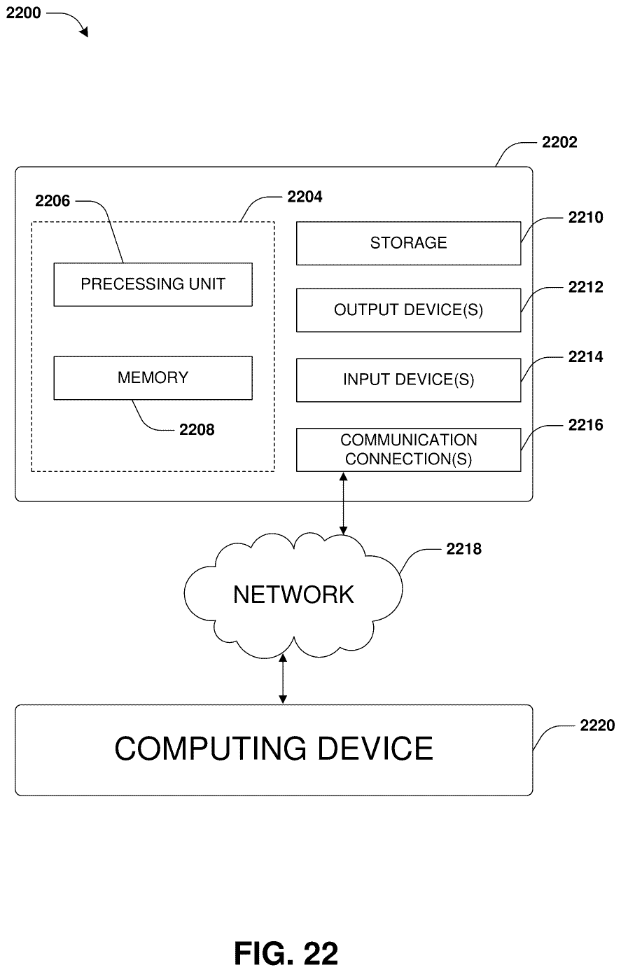

FIG. 22 and the following discussion provide a description of a suitable computing environment to implement embodiments of one or more of the provisions set forth herein. The operating environment of FIG. 22 is just one example of a suitable operating environment and is not intended to indicate any limitation as to the scope of use or functionality of the operating environment. Example computing devices include, but are not limited to, server computers, mainframe computers, personal computers, hand-held or laptop devices, mobile devices (such as mobile phones, Personal Digital Assistants (PDAs), media players, and the like), consumer electronics, multiprocessor systems, mini computers, distributed computing environments that include any of the above systems or devices, and the like.

Although not required, embodiments are described in the general context of “computer readable instructions” being executed by one or more computing devices. Computer readable instructions may be distributed using computer readable media (discussed below). Computer readable instructions may be implemented as programs and/or program modules, such as functions, objects, Application Programming Interfaces (APIs), data structures, and the like, that execute particular tasks or implement particular abstract data types. Typically, the functionality of the computer readable instructions may be combined or distributed (e.g., as desired) in various environments.

FIG. 22 illustrates an example of a system 2200 comprising a (e.g., computing) device 2202. Device 2202 may be configured to implement one or more embodiments provided herein. In an exemplary configuration, device 2202 includes at least one processing unit 2206 and at least one memory 2208. Depending on the configuration and type of computing device, memory 2208 may be volatile (such as RAM, for example), non-volatile (such as ROM, flash memory, etc., for example), or some combination of volatile and non-volatile. This configuration is illustrated in FIG. 22 by dashed line 2204.

In other embodiments, device 2202 may include additional features and/or functionality. For example, device 2202 may further include additional storage (e.g., removable and/or non-removable) including, but not limited to, magnetic storage, optical storage, and the like. Such additional storage is illustrated in FIG. 22 by storage 2210. In one embodiment, computer readable instructions to implement one or more embodiments provided herein may be in storage 2210. Storage 2210 may further store other computer readable instructions to implement an application program, an operating system, and the like. Computer readable instructions may be loaded in memory 2208 for execution by processing unit 2206, for example.

The term “computer readable media” as used herein includes computer storage media. Computer storage media includes volatile and/or nonvolatile, removable and/or non-removable media implemented in any method or technology for storage of information such as computer readable instructions or other data. Memory 2208 and storage 2210 are examples of computer storage media. Computer storage media may include, but is not limited to including, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store desired information and can be accessed by device 2202. Any such computer storage media may be part of device 2202.

Device 2202 may further include communication connection(s) 2216 that allows device 2202 to communicate with other devices. Communication connection(s) 2216 may include, but is not limited to including, a modem, a radio frequency transmitter/receiver, an integrated network interface, a Network Interface Card (NIC), a USB connection, an infrared port, or other interfaces for connecting device 2202 to other computing devices. Communication connection(s) 2216 may include a wireless connection and/or a wired connection. Communication connection(s) 2216 may transmit and/or receive communication media.

The term “computer readable media” may include, but is not limited to including, communication media. Communication media typically embodies computer readable instructions and/or other data in a “modulated data signal” such as a carrier wave or other transport mechanism and includes any information delivery media. The term “modulated data signal” may correspond to a signal that has one or more of its characteristics set or changed in such a manner as to encode information in the signal.

Device 2202 may include input device(s) 2214 such as mouse, keyboard, voice input device, pen, infrared cameras, touch input device, video input devices, and/or any other input device. Output device(s) 2212 such as one or more displays, speakers, printers, and/or any other output device may also be included in device 2202. Input device(s) 2214 and output device(s) 2212 may be connected to device 2202 using a wireless connection, wired connection, or any combination thereof. In one embodiment, an input device or an output device from another computing device may be used as input device(s) 2214 or output device(s) 2212 for device 2202.

Components of device 2202 may be connected by various interconnects (e.g., such as a bus). Such interconnects may include a Peripheral Component Interconnect (PCI), such as a Universal Serial Bus (USB), PCI Express, an optical bus structure, firewire (IEEE 1394), and the like. In another embodiment, components of device 2202 may be interconnected by a network. In an example, memory 2208 may be comprised of multiple (e.g., physical) memory units located in different physical locations interconnected by a network.

Storage devices utilized to store computer readable instructions may be distributed across a network. For example, a computing device 2220 accessible using a network 2218 may store computer readable instructions to implement one or more embodiments provided herein. Device 2202 may access computing device 2220 and download a part or all of the computer readable instructions for execution. Alternatively, device 2202 may download pieces of the computer readable instructions, as needed, or some instructions may be executed at device 2202 and some at computing device 2220.

Various operations of embodiments are provided herein. In one embodiment, one or more of the operations described may comprise computer readable instructions stored on one or more computer readable media, which if executed by a computing device, will cause the computing device to perform the operations described. The order in which some or all of the operations are described should not be construed as to imply that these operations are order dependent. Alternative ordering will be appreciated by one skilled in the art having the benefit of this description. Further, it will be understood that not all operations are present in each embodiment provided herein.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

As used in this application, the terms “system”, “component,” “interface”, “module,” and the like are generally intended to refer to a computer-related entity, either hardware, software, a combination of hardware and software, or software in execution. For example, a component may be, but is not limited to being, an object, a process running on a processor, a processor, a program, an executable, a thread of execution, and/or a computer. By way of illustration, an application running on a controller and the controller can be a component. One or more components may reside within a thread of execution and/or process and a component may be distributed between two or more computers and/or localized on one computer.

Furthermore, the claimed subject matter may be implemented as an apparatus, method, and/or article of manufacture using standard programming and/or engineering techniques to produce hardware, firmware, software, or any combination thereof to control a computer that may implement the disclosed subject matter. The term “article of manufacture” as used herein is intended to encompass a computer program (e.g., accessible from any computer-readable device, carrier, or media). Of course, those skilled in the art will recognize many modifications may be made to this configuration without departing from the scope or spirit of the claimed subject matter.

Moreover, the word “exemplary” is used herein to mean serving as an example, illustration, or instance. Any design or aspect described herein as “exemplary” is not necessarily to be construed as advantageous over other designs or aspects. Rather, use of the word “exemplary” is intended to present concepts in a concrete fashion. As used in this application, the word “or” is intended to mean an inclusive “or” (e.g., rather than an exclusive “or”). That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the words “a” and “an” as used in this application and the appended claims may generally be construed to mean “one or more” (e.g., unless specified otherwise or clear from context to be directed to a singular form). Also, at least one of A or B or the like generally means A or B or both A and B. Furthermore, to the extent that the terms “includes”, “having”, “has”, “with”, or variants thereof are used in either the detailed description or the claims, such terms are intended to be inclusive in a manner similar to the term “comprising.”

Although the disclosure has been shown and described with respect to one or more implementations, modifications and alterations will occur to others skilled in the art based (e.g., at least in part) upon a reading of this specification and the annexed drawings. The disclosure includes all such modifications and alterations. The disclosure is limited only by the scope of the following claims. In regard to the various functions performed by the above described components (e.g., resources, elements, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. Additionally, while a particular feature of the disclosure may have been disclosed with respect to only one of several implementations, the particular feature may be combined with one or more other features of the other implementations as may be desired and/or advantageous for any given or particular application.

What is claimed is:

1. A method comprising:
determining deposit information associated with a plurality of deposits associated with a first project, wherein the deposit information is indicative of deposit amounts of the plurality of deposits, investors associated with the plurality of deposits, and times of the plurality of deposits;
determining expenditure information associated with a plurality of expenditures associated with the first project, wherein the expenditure information is indicative of expenditure amounts of the plurality of expenditures and times of the plurality of expenditures;
determining inflation indexes associated with periods of time within a window of time beginning at a starting time associated with the first project;
determining inflation-corrected shares associated with the investors based upon the deposit information, the expenditure information, and the inflation indexes; and
providing a message indicative of one or more of the inflation-corrected shares to a device for display.

2. The method of claim 1, wherein:
the inflation-corrected shares comprise a first inflation-corrected share associated with a first investor; and
the method comprises:
receiving a transfer request to transfer an amount of the first inflation-corrected share in the first project from the first investor to a second investor; and
in response to the transfer request, transferring the amount of the first inflation-corrected share from the first investor to the second investor, wherein the amount of the first inflation-corrected share comprises at least a portion of the first inflation-corrected share.

3. The method of claim 1, comprising:
allocating account balances to investor accounts associated with the investors based upon at least one of the determined deposit information, the determined expenditure information or the determined inflation indexes, wherein the account balances comprise a first account balance allocated to a first investor account associated with a first investor;
receiving a withdrawal request, associated with the first investor, to withdraw a first amount of funds from the first investor account; and
determining whether to authorize the withdrawal request based upon the first amount of funds and the first account balance.

4. The method of claim 3, comprising:
authorizing the withdrawal request based upon the first amount of funds being at most the first account balance; and
in response to authorizing the withdrawal request, transferring the first amount of funds to at least one of an account associated with the first investor or an account indicated by the withdrawal request.

5. The method of claim 1, comprising allocating a set of priority right shares to the investors associated with the plurality of deposits based upon times associated with the plurality of deposits.

6. The method of claim 5, comprising providing a message indicative of one or more of the set of priority right shares associated with the investors to the device for display.

7. The method of claim 5, wherein:
the set of priority right shares comprise a first priority right share associated with the first investor; and
the method comprises:
receiving a transfer request to transfer an amount of the first priority right share from the first investor to a second investor; and
in response to the transfer request, transferring the amount of the first priority right share from the first investor to the second investor, wherein the amount of the first priority right share comprises at least a portion of the first priority right share.

8. The method of claim 1, comprising:
determining account balance information associated with a first investor account of a first investor of the investors, wherein the account balance information is indicative of historical account balances of the first investor account;
determining an interest based upon the account balance information; and
allocating the interest to the first investor account.

9. The method of claim 1, wherein:
the inflation-corrected shares comprise:
a first inflation-corrected share associated with a first investor; and
a second inflation-corrected share associated with a second investor; and
the method comprises:
providing a first message indicative of the first inflation-corrected share to a first device associated with the first investor; and
providing a second message indicative of the second inflation-corrected share to a second device associated with the second investor.

10. The method of claim 1, comprising:
generating a first project data structure, associated with the first project, comprising a plurality of profiles associated with a plurality of periods of time during the window of time, wherein:
the plurality of profiles comprises a first profile associated with a first period of time and a second profile associated with a second period of time;
the first profile comprises a first expenditure associated with the first period of time; and
the second profile comprises a second expenditure associated with the second period of time.

11. The method of claim 10, wherein:
the first profile comprises a first share of the investors associated with the first period of time; and
the second profile comprises a second share of the investors associated with the second period of time.

12. The method of claim 10, wherein:
the first period of time corresponds to a first period of about 24 hours; and
the second period of time corresponds to a second period of about 24 hours.

13. A non-transitory computer-readable medium having stored thereon processor-executable instructions that when executed cause performance of operations, the operations comprising:
determining deposit information associated with a plurality of deposits associated with a first project, wherein the deposit information is indicative of deposit amounts of the plurality of deposits, investors associated with the plurality of deposits, and times of the plurality of deposits;
determining expenditure information associated with a plurality of expenditures associated with the first project, wherein the expenditure information is indicative of expenditure amounts of the plurality of expenditures and times of the plurality of expenditures;
determining inflation indexes associated with periods of time within a window of time beginning at a starting time associated with the first project; and
determining inflation-corrected shares associated with the investors based upon the deposit information, the expenditure information, and the inflation indexes.

14. The non-transitory computer-readable medium claim 13, wherein:
the inflation-corrected shares comprise a first inflation-corrected share associated with a first investor; and
the operations comprise:
receiving a transfer request to transfer an amount of the first inflation-corrected share in the first project from the first investor to a second investor; and
in response to the transfer request, transferring the amount of the first inflation-corrected share from the first investor to the second investor, wherein the amount of the first inflation-corrected share comprises at least a portion of the first inflation-corrected share.

15. The non-transitory computer-readable medium of claim 13, the operations comprising:
allocating account balances to investor accounts associated with the investors based upon at least one of the determined deposit information, the determined expenditure information or the determined inflation indexes, wherein the account balances comprise a first account balance allocated to a first investor account associated with a first investor;
receiving a withdrawal request, associated with the first investor, to withdraw a first amount of funds from the first investor account; and
determining whether to authorize the withdrawal request based upon the first amount of funds and the first account balance.

16. The non-transitory computer-readable medium of claim 13, the operations comprising:
authorizing the withdrawal request based upon the first amount of funds being at most the first account balance; and
in response to authorizing the withdrawal request, transferring the first amount of funds to at least one of an account associated with the first investor or an account indicated by the withdrawal request.

17. The non-transitory computer-readable medium of claim 13, the operations comprising:
allocating a set of priority right shares to the investors associated with the plurality of deposits based upon times associated with the plurality of deposits; and
providing a message indicative of one or more of the set of priority right shares associated with the investors to the device for display.

18. A computer comprising a processor configured to execute processor-executable instructions that when executed cause performance of operations comprising:
determining deposit information associated with a plurality of deposits associated with a first project, wherein the deposit information is indicative of deposit amounts of the plurality of deposits, investors associated with the plurality of deposits, and times of the plurality of deposits;
determining expenditure information associated with a plurality of expenditures associated with the first project, wherein the expenditure information is indicative of expenditure amounts of the plurality of expenditures and times of the plurality of expenditures;
determining inflation indexes associated with periods of time within a window of time beginning at a starting time associated with the first project; and
determining inflation-corrected shares associated with the investors based upon the deposit information, the expenditure information, and the inflation indexes.

19. The computer of claim 18, wherein:
the inflation-corrected shares comprise a first inflation-corrected share associated with a first investor; and
the operations comprise:
receiving a transfer request to transfer an amount of the first inflation-corrected share in the first project from the first investor to a second investor; and
in response to the transfer request, transferring the amount of the first inflation-corrected share from the first investor to the second investor, wherein the amount of the first inflation-corrected share comprises at least a portion of the first inflation-corrected share.

20. The computer of claim 18, the operations comprising:
allocating account balances to investor accounts associated with the investors based upon at least one of the determined deposit information, the determined expenditure information or the determined inflation indexes, wherein the account balances comprise a first account balance allocated to a first investor account associated with a first investor;
receiving a withdrawal request, associated with the first investor, to withdraw a first amount of funds from the first investor account;
determining whether to authorize the withdrawal request based upon the first amount of funds and the first account balance;
authorizing the withdrawal request based upon the first amount of funds being at most the first account balance; and
in response to authorizing the withdrawal request, transferring the first amount of funds to at least one of an account associated with the first investor or an account indicated by the withdrawal request.
